(19) United States
(12) Patent Application Publication
(10) Pub. No.: US 2021/0133722 A1
(43) Pub. Date: May 6, 2021

(54) System And Method For On-Line Financial Transactions

(71) Applicant: Ned Hoffman, Sebastopol, CA (US)

(72) Inventor: Ned Hoffman, Sebastopol, CA (US)

(73) Assignee: Nexus Payments, LLC, Reno, NV (US)

(21) Appl. No.: 15/985,225

(22) Filed: May 21, 2018

Related U.S. Application Data
(63) Continuation of application No. 11/502,472, filed on Aug. 9, 2006, now abandoned.
Application No. 11/502,472 is a continuation-in-part of application No. 11/394,417, filed on Mar. 31, 2006, now abandoned.
Application No. 11/394,417 is a continuation-in-part of application No. 11/305,448, filed on Dec. 15, 2005, now abandoned.

(51) Int. Cl. G06Q 20/32; G06K 19/07; G06K 19/077; G06Q 20/10

(52) U.S. Cl. CPC G06Q 20/321; G06Q 20/3278; G06Q 20/102; G06K 19/07762; G06K 19/0709

(57) ABSTRACT

The invention describes a method and system for on-line financial transactions, comprising: a) registering a user, wherein a rule-module is registered to a user within a rule-module nexus, said registered rule-module further comprising a pattern data associated with an execution command; b) data-storing in a nexus access token, wherein a unique user code of the user is stored in a nexus access token, wherein the nexus access token is a contactless proximity transponder; c) processing an on-line financial transaction, using a user interface apparatus conjoined with a transaction terminal and located remotely from the rule-module nexus, comprising: (i) verifying a user, wherein a user's authority to access the rule-module nexus is verified on-line by a verification platform using verification data provided via the user interface apparatus, said verification data comprising: a bid unique user code scanned directly from the nexus access token, and; a bid personal verification code provided directly by the user, and; (ii) accessing financial accounts, wherein upon the verification platform verifying the user is authorized to access the rule-module nexus, the rule-module nexus provides the user on-line access to a plurality of proprietary financial accounts from which the user can select for completing the on-line financial transaction; whereby, a nexus access token and a rule-module nexus provide an authorized user access to a plurality of proprietary financial accounts for processing an on-line financial transaction.

### CROSS-REFERENCE TO RELATED APPLICATIONS

This utility patent application is a continuation of utility patent application Ser. No. 11/502,472, filed on Aug. 9, 2016, which claims the benefit of provisional patent application Ser. No. 60/708,979, filed on Aug. 16, 2005, and is a continuation-in-part of utility patent application Ser. No. 11/394,417, filed on Mar. 31, 2006, which claims the benefit of provisional patent application Ser. No. 60/669,941, filed on Apr. 9, 2005, which is a continuation-in-part of utility patent application Ser. No. 11/305,448, filed on Dec. 15, 2005, which claims the benefit of provisional patent application Ser. No. 60/650,367, filed on Feb. 2, 2005, all of which are incorporated herein by reference.

### FIELD OF THE INVENTION

The invention relates generally to computer methods and systems to electronically process on-line financial transactions. More specifically, this invention relates to processing on-line financial transactions using: a wireless proximity token capable of short range contactless communications; a user interface apparatus conjoined with a transaction terminal, and; a remotely located Rule-Module Nexus.

### BACKGROUND OF THE INVENTION

Electronic financial transaction systems have become a popular part of merchant point of sale and internet commerce. Currently, over $3 trillion in commercial exchanges occur in the United States annually using electronic financial transaction systems, including transactions involving credit, debit, stored value, electronic check, electronic benefits transfer, scrip, and reward incentives.

Currently, financial transaction systems primarily rely on two types of token-based systems. First, most systems now use magnetic stripe cards, which can accommodate a user's on-line transactions with only one predetermined bank account for a debit or credit transaction. In this case, the bank logo or bank name on the front of the card usually denotes the designated bank or credit account with which the card can communicate as a function of the data stored on the card's magnetic stripe. During a financial transaction, these magnetic stripe cards communicate on-line with the bank's remote platforms to determine available resources in the user's card-designated financial account, and to adjust the user's financial account as a function of the financial transaction being conducted.

The known problems with these magnetic stripe cards are largely two-fold: first, since each card can only communicate with one predetermined financial account of the user, the user is required to carry and use multiple cards, which is both expensive and cumbersome. The expense, due to the high costs of card manufacture, distribution, replacement and related security procedures, is borne by banks, and ultimately by merchants and consumers. Meanwhile, the cumbersome requirement to carry and manage multiple cards is familiar to every user who relies upon them. The average user has over 5 cards, and tens of millions of consumers have 10 or more.

The technology inherent in magnetic stripe cards has other costly and cumbersome limitations which are known to consumers, merchants, and banks alike. The additional cost is due to several factors: the magnetic stripe on the card can easily be de-magnetized or simply wear out, requiring a costly replacement; also, the magnetic stripe card readers themselves usually fail within less than 5 years from the repeated wear of reading the card magnetic stripes which are swiped through the reader, requiring expensive replacements. Further, the cumbersome process of using a magnetic stripe card during a financial transaction can be time-consuming and irritating: the user must first select and locate the card from amongst the several they usually carry; then, swiping the card through the reader can require repetition since the magnetic stripe may not be read the first or second time. Sometimes, users or merchant personnel wipe the card on clothing, or wrap it in the thin plastic of a disposable bag to enhance the readability of the magnetic stripe. This delay also has real costs for merchants, which can lose the sale or delay processing other Users in line, slowing the “through-put” of selling products.

Beyond the magnetic stripe card, the second token-based system used in financial transactions is the smart card, which is embedded with a memory chip. In this instance, most of the financial account data is stored within the card itself, and the financial transaction is processed off-line, with communications being confined directly between the user's smart card and the smart card reader into which is has been inserted. Here, no long distance computer- or tele-communications networks are used. Almost uniformly, prior art disclosing smart card financial transaction systems focus on ever-more complex smart cards to broaden applications of off-line transactions, or increasing the anti-fraud components of a token. Reasons cited in such teachings for using smart card transactions range from attempts to further limit transaction communications costs, increase transaction speed, and diminish dependence on potentially unreliable or insecure computer networks.

However, the problems with smart cards are also now known, and their adoption as a result has been limited. First, the significantly higher costs of smart card manufacture, distribution, replacement and related security procedures have made this token about 2 to 3 times more expensive than the magnetic stripe card. Second, the smart card's integrated circuit chip security has proven ineffective, as evidenced by experiments wherein 2 smart cards exchanged data with each other after simply being placed in a standard kitchen microwave oven. Third, with the plummeting costs of on-line telecommunications and computer networks, and the vast advances in on-line infrastructure stability, security and reliability, the off-line transaction no longer provides a material cost, time, or security advantage over on-line financial transactions. For these reasons, on-line transactions have remained the dominant and growing modality, with expanding capabilities in centralized and scalable improvements for broad-based, on-line financial transaction processing.

New tokens employing contactless proximity communications, including dedicated short-range radio frequency identification and infrared beams, have emerged as a new technology which has advantages beyond the traditional smart cards and magnetic stripe cards. However, most contactless proximity communications tokens are dedicated to basic inventory tracking. In rare instances, a contactless proximity communications token has been used to perform a very limited single-payment function, such as a contactless proximity communications key fob permitting the user to buy only one brand of gas using a credit account proprietary to that branded gas company.

In view of the foregoing, there has long been a need for a new financial transaction system wherein one single token possesses the capabilities for on-line access to a remotely located processing center which can aggregate the accessibility, and optionally the management of, all of the financial accounts of a user. Further, there is a need for a new system that ensures user convenience by relieving the user of the cumbersome dependence on multiple tokens, all of which the user would otherwise be required to possess, carry, and manage in order to access any account at any particular time from any location. There is also a need for a new financial transaction system which dispenses with the functional limitations, and costly security and technologic vulnerabilities of, a system depending on off-line smart cards which otherwise would be needed for aggregating on-line access to a plurality of financial accounts via a single token.

There is further a need for a new on-line financial transactions system to uniquely capitalize on low-cost, durable, extended-use, energy-efficient tokens which provide simple, reliable, fast, and convenient contactless proximity communications capabilities, such as radio frequency identification (RFID), infrared beams, and similarly beneficial, dedicated short-range transmittal technologies which consume minimal energy to emit frequencies detectable within a near-field of the token. Further still, there is a need for a new system: a) that can use only one token to enable on-line access to a plurality of financial accounts, so that a user can access most if not any financial account from any place at any time, and; b) that requires a user's active assent for authorizing each financial transaction by way of submitting a personal verification code.

There is further a need for a new on-line financial transactions system which does not depend wholly on biometrics, as a biometric once damaged, or fraudulently captured and duplicated, can thereby become permanently compromised, since a biometric cannot be replaced or re-programmed. By contrast, a token-based system holds the inherent advantage that any compromised, damaged or lost token can indeed simply be replaced or re-programmed. Further, a new token device, embedded in a ubiquitous token like a wrist watch, cell phone or personal digital assistant, offers the added convenience of being part of a device that one would normally carry in most activities anyway.

In addition, there is a need for a financial transaction system that can accommodate a user's on-line access to the user's financial accounts for a limited basis wherein the user's token may be rendered inactive or functionally comprised.

Lastly, such a system should be affordable and flexible enough to be operatively compatible with existing networks having a variety of electronic transaction devices and on-line financial system configurations.

### Objectives and Advantages of the Invention

Accordingly, it is the objective of the present invention to provide a new system and method of token-based financial transactions which address the above needs and provide benefits to user and account issuers alike.

Preferably, it is an objective of the present invention to compliment, not contravene, the already-existing interchange fee, discount rate, or settlement process of the user's selected financial account and its associated Account Issuer(s). Alternatively put, the invention herein is preferably designed not to universally “stand-in” for an existing account issuer, nor to cause all financial transactions of the invention herein to bypass, divert or switch an already-existing interchange fee, discount rate, or settlement process which would otherwise be applied by the Account Issuer(s) of the user's selected financial account and its associated transaction processing.

As such, the objectives of this invention are to provide a new on-line electronic financial transaction method and system comprising advantages that include:

a) One portable token possessing the capability for authorizing on-line access to a remotely located Rule-Module Nexus anytime and anywhere, said Rule-Module Nexus centrally aggregating accessibility to most if not all of the financial accounts of a user. Optionally, the Rule-Module Nexus can provide further functions comprising any of the following: administering, managing, and modifying financial accounts of a user;
b) The token having contactless proximity capabilities for dedicated short-range transmissions which are faster, more reliable and more durable than contact tokens, like smart cards and magnetic stripe cards.
c) The token being “thin-client”, wherein it is not required to store any data which can directly identify or directly access a specific on-line financial account of a user.
d) The security advances of increased reliability and cost reductions in on-line networks for computer and communication networks, capabilities for electronically distributing downloadable upgrades to transaction hardware in the field;
e) The user being of the cumbersome dependence on multiple tokens, all of which the user would otherwise be required to possess, carry, and manage in order to access any account at any particular time from any location;
f) The user being freed from the functional limitations, and costly security and technologic vulnerabilities of, a system depending on off-line smart cards which otherwise would be needed for aggregating on-line access to a plurality of financial accounts via a single token;
g) Capitalizing on advances in low-cost, durable, extended-use, energy-efficient tokens which provide simple, reliable, fast, and convenient communications capabilities—namely, portable tokens using contactless proximity communications, also known as wireless near-field or wireless short-range communications. Examples include radio frequency identification (RFID), infrared beams, sound waves, and similarly beneficial, short-range transmittal technologies which consume minimal energy to emit frequencies detectable within a short range of the token. This low cost token can have long-lasting power storage as a stand alone unit, or can be conjoined with a portable token having other functions, such as a cell phone, house key, or wrist watch;
h) Requiring the user's active assent for authorizing each financial transaction by way of submitting a personal verification code, so that inadvertent or fraudulent financial transactions are avoided, and any security lapse can be rapidly adjusted with a simple change to the personal verification code;
i) The user retaining on-line financial account access even during a limited basis wherein the user's token may be rendered inactive or functionally comprised;
j) The system being affordable and flexible enough to be operatively compatible with existing networks having a variety of electronic transaction devices and financial system configurations, which are convenient, secure and cost-effective;
k) Functioning at the merchant point of sale and over the internet;
l) Being conjoined in a simple and cost-effective manner to existing transaction terminals currently installed at points of sale and used over the internet.

Further, the invention is designed to be cost-effectively integrated with existing electronic data systems currently installed in corporate intranets and over the Internet.

Still further objectives and advantages of this invention will become apparent from a consideration of the ensuing description and drawings.

### SUMMARY OF THE INVENTION

The present invention satisfies these needs by providing an improved system and method for real-time processing of on-line financial transactions using a nexus access token and a remotely located rule-module nexus.

The invention describes a method for on-line financial transactions, comprising the steps of: a) registering a user, wherein a rule-module is registered to a user within a rule-module nexus, said registered rule-module further comprising a pattern data associated with an execution command; b) data-storing in a nexus access token, wherein a unique user code of the user is stored in a nexus access token, wherein the nexus access token is a contactless proximity transponder; c) processing an on-line financial transaction, using a user interface apparatus conjoined with a transaction terminal and located remotely from the rule-module nexus, comprising: (i) verifying a user, wherein a user's authority to access the rule-module nexus is verified on-line by a verification platform using verification data provided via the user interface apparatus, said verification data comprising: a bid unique user code scanned directly from the nexus access token, and; a bid personal verification code provided directly by the user, and; (ii) accessing financial accounts, wherein upon the verification platform verifying the user is authorized to access the rule-module nexus, the rule-module nexus provides the user on-line access to a plurality of proprietary financial accounts from which the user can select for completing the on-line financial transaction; whereby, a nexus access token and a rule-module nexus provide an authorized user access to a plurality of proprietary financial accounts for processing an on-line financial transaction.

In a preferred embodiment of the method of the invention, the unique user code comprises: no data directly accessing a specific on-line financial account of the user; no data directly identifying a specific on-line financial account of the user, and; a network routing instruction for processing the on-line financial transaction via the rule-module nexus.

In an exemplary embodiment of the method of the invention, the pattern data comprises: the personal verification code; the unique user code, and; the plurality of proprietary financial accounts.

In an exemplary embodiment of the method of the invention, the user interface apparatus is fully integrated with the transaction terminal.

In an exemplary embodiment of the method of the invention, completing the on-line financial transaction comprises the rule-module nexus preserving a processing preference of an account issuer.

In an exemplary embodiment of the method of the invention, selecting the financial account further comprises: data-entering by the user via a touch-screen; data-entering by the user via a key pad; data-entering by the user via an audio receiver.

In an exemplary embodiment of the method of the invention, preserving the processing preference of the account issuer comprises: invoking criteria predetermined by the account issuer for declining the on-line financial transaction; invoking criteria predetermined by the account issuer for approving the on-line financial transaction, and; invoking criteria predetermined by the account issuer for settlement of the on-line financial transaction.

In an exemplary embodiment of the method of the invention, criteria predetermined by the account issuer for settlement of the financial transaction comprises: invoking a proprietary network; invoking a discount rate; invoking an interchange fee; invoking a settlement protocol; invoking a surcharge; invoking a processing partner, and; invoking a time period for settlement.

In an exemplary embodiment of the method of the invention, processing an on-line financial transaction further comprises: precluding a global execution command from requiring all on-line financial transactions of all users to bypass a processing preference of an account issuer; precluding a global execution command from requiring all on-line financial transactions of all users to invoke a specific processing preference of a specific account issuer; precluding a global execution command from requiring all on-line financial transactions of all users to use a specific merchant service, and; precluding a global execution command from requiring all on-line financial transactions of all users to use a specific merchant product.

In an exemplary embodiment of the method of the invention, a code is identified as compromised based on an occurance comprising: unusual usage of the code; loss of the code; inaccessibility of the code due to nexus access token damage; fraudulent duplication of the code; unauthorized access to the code, and; coersion of the user.

In an exemplary embodiment of the method of the invention, the compromised code comprises: a unique user code; a personal verification code; a verification approval code; a user account registry code, and; an account issuer verification code, and; a user interface apparatus hardware verification code.

In an exemplary embodiment of the method of the invention, resolving the compromised code comprises: deactivating the compromised code and activating a replacement code, and; verifying the user further comprising providing dual personal verification codes.

In an exemplary embodiment of the method of the invention, activating the replacement code comprises: data-storing a replacement unique user code in the nexus access token of the user to replace a compromised unique user code stored therein, and; data-storing a replacement unique user code in a new nexus access token of the user, the new nexus access token replacing a nexus access token of the user storing a compromised unique user code.

In an exemplary embodiment of the method of the invention, the plurality comprises two or more.

In an exemplary embodiment of the method of the invention, proprietary financial accounts comprise: an account issuer of a first financial account being distinct from an account issuer of a second financial account.

In an exemplary embodiment of the method of the invention, verifying the user further comprises the verification platform electronically comparing the user's bid unique user code and the user's bid personal verification code with a user's registered unique user code and a user's registered personal verification code, and making a matching determination for verifying the user's authority to access the rule-module nexus, said matching determination comprising: making a positive matching determination verifying that the user is authorized to access the rule-module nexus, and; failing to make a positive matching determination, wherein making a negative matching determination is automatic, verifying that the user is not authorized to access the rule-module nexus.

In an exemplary embodiment of the method of the invention, upon a positive matching determination, the verification platform issues a verification approval code invoking a rule-module of the user in the rule-module nexus.

In an exemplary embodiment of the method of the invention, the verification approval code invokes a user account registry code identifying a user account registry, said user account registry code comprising: no data directly identifying a specific financial account of the user, and; no data identifying a primary financial account of the user for all on-line financial transactions of the user.

In an exemplary embodiment of the method of the invention, the user account registry comprises a plurality of proprietary financial accounts of the user.

In an exemplary embodiment of the method of the invention, the verification approval code is the same as the user account registry code identifying the user account registry.

In an exemplary embodiment of the method of the invention, a rule-module of the user is modified by parties authorized by the rule-module nexus, said parties comprising: the user; the rule-module nexus; an account issuer; and a third-party with predetermined authorization.

In an exemplary embodiment of the method of the invention, modifying a rule-module further comprises: registering, deleting, adding pattern data; registering, deleting, adding execution commands, and; registering, deleting, adding associations between pattern data and execution commands.

In an exemplary embodiment of the method of the invention, the pattern data comprises: personal legal name; a private code; a driver's license number; a unique user code; a personal verification code; a secondary personal verification code; an emergency code; a plurality of proprietary financial accounts; demographic information; an email address; social security number; a mother's maiden name; a biometric sample; a facial photograph; an Internet browsing pattern; a telephone number; a mailing address; a purchasing pattern; an authorized subordinated user; electronic data usage patterns;

employee status; job title; data on user behavior patterns; a credit score; a digital certificate; a network credential; an Internet protocol address; a digital signature; an encryption key; an instant messaging address; personal medical records; an electronic audible signature, and; an electronic visible signature.

In an exemplary embodiment of the method of the invention, the execution command comprises invoking at least one of the following: accessing the rule-module nexus; accessing a financial account; authorizing a subordinated user to access a financial account of the user; presenting a financial account of the user; completing the on-line financial transaction; authorizing settlement of the on-line transaction; presenting the pattern data; presenting the execution command; presenting the rule-module; notifying an emergency authority upon rule-module nexus receiving an emergency code of the user; accessing a third-party database, and; accessing an account issuer.

In an exemplary embodiment of the method of the invention, invoking the rule-module comprises: accessing a plurality of rule-modules in the rule-module nexus; accessing a plurality of proprietary financial accounts; authorizing a subordinated account user authority; accessing a third-party computer via the rule-module nexus.

In an exemplary embodiment of the method of the invention, the unique user code comprises: a dynamic code which changes periodically based on predetermined criteria synchronized with the verification platform, and; a static code which remains constant based on a predetermined code synchronized with the verification platform.

In an exemplary embodiment of the method of the invention, the personal verification code comprises: an alpha-numeric sequence selected by the user; an alpha-numeric sequence selected by the rule-module nexus; an alpha-numeric sequence selected by an account issuer, and; a biometric sample selected by the user.

In an exemplary embodiment of the method of the invention, verifying the user further comprises detecting rule-module nexus fraud, wherein criteria predetermined by a fraud prevention platform are invoked for detecting fraud by the user involving the rule-module nexus, said criteria comprising: unusual usage of bid verification data; unusual modifying of a rule-module, and; unusual accessing of a financial account.

In an exemplary embodiment of the method of the invention, upon a determination by the rule-module nexus that the user has committed fraud involving the rule-module nexus, data of the user is registered with a fraud prevention platform, said data comprising: a pattern data; an execution command, and; a rule-module.

In an exemplary embodiment of the method of the invention, the private code, registered to the user, distinct from a personal verification code and not used in verifying the user, is presented to the user via the rule-module nexus for verifying to the user that the authentic rule-module nexus has been accessed.

In an exemplary embodiment of the method of the invention, the private code is registered to the user in the rule-module nexus by a party, said party comprising: the user; the rule-module nexus, and; an account issuer.

In an exemplary embodiment of the method of the invention, during the on-line financial transaction processing, the emergency code, distinct from a personal verification code and not used in verifying the user, is provided by the user to the transaction terminal for sending an alert via the rule-module nexus of an emergency comprising: the bid verification data being compromised; the nexus access token being compromised, and; the user being coerced.

In an exemplary embodiment of the method of the invention, the emergency code comprises: an alpha-numeric code; a visible image, and; an audible signal.

In an exemplary embodiment of the method of the invention, alerting of emergency invokes an execution command via the rule-module nexus, comprising: presenting a visible display of predetermined emergency data to the user; presenting an audible signal of predetermined emergency data to the user; alerting an emergency authority, and; identifying a compromised code.

In an exemplary embodiment of the method of the invention, the visible display comprises: a false financial account; a false financial data with in a financial account, and; confirming an emergency authority has been contacted.

In an exemplary embodiment of the method of the invention, the audible signal comprises: a false financial account; a false financial data within a financial account, and; confirming an emergency authority has been contacted.

In an exemplary embodiment of the method of the invention, resolving the compromised code further comprises deactivating the unique user code and activating a secondary personal verification code.

In an exemplary embodiment of the method of the invention, providing dual personal verification codes, further comprises the rule-module nexus enabling the user on a limited basis to provide a bid secondary personal verification code in replacement of the user's unique user code.

An exemplary embodiment of the method of the invention further comprises: a) calling by the user from a predetermined first phone number to a predetermined second phone number; b) data-entering by the user of the personal verification code of the user; c) invoking by the user of a secondary personal verification code, and; d) notifying the user that the secondary personal verification code has been activated for providing dual personal verification codes when verifying the user.

In an exemplary embodiment of the method of the invention, invoking by the user further comprises: creating by the user of a secondary personal verification code, and; accepting by the user of an offered secondary personal verification code.

An exemplary embodiment of the method of the invention further comprises: a) emailing by the user from a predetermined internet protocol address to a predetermined web site; b) data-entering by the user of the personal verification code of the user; c) invoking by the user of a secondary personal verification code, and; d) notifying the user that the secondary personal verification code has been activated for providing dual personal verification codes when verifying the user.

In an exemplary embodiment of the method of the invention, invoking by the user further comprises: creating by the user of a secondary personal verification code, and; accepting by the user of an offered secondary personal verification code

In an exemplary embodiment of the method of the invention, providing dual personal verification codes further comprises the bid personal verification code and the bid secondary personal verification code, both provided directly by the user to the user interface apparatus, being electronically compared by the verification platform with a registered personal verification code and a registered secondary personal verification code, to make a matching determination for verifying the user's authority to access the rule-module nexus.

In an exemplary embodiment of the method of the invention, the limited basis comprises: a predetermined time period; predetermined financial account access when using the secondary personal verification code; predetermined frequency for usage for using the secondary personal verification code, and; predetermined geographic area for using the secondary personal verification code.

In an exemplary embodiment of the method of the invention, the secondary personal verification code comprises: an alpha-numeric sequence selected by the user; an alpha-numeric sequence selected by the rule-module nexus; an alpha-numeric sequence selected by an account issuer, and; a biometric sample selected by the user.

In an exemplary embodiment of the method of the invention, processing the on-line financial transaction further comprises: a credit transaction; a debit transaction; a scrip transaction; a rewards transaction; an electronic check transaction; a private label transaction; a stored value transaction; an electronic benefits transfer transaction; a brokerage trade transaction; invoking a surcharge to a transaction based on predetermined criteria; a buyer-seller exchange transaction wherein a user's financial account balance is adjusted and an account issuer's financial account is correspondingly adjusted; an intra-account transfer transaction between financial accounts of the user without a buyer-seller exchange; redeeming a pre-paid ticket transaction for venue admittance, and; redeeming a pre-paid membership benefit transaction for venue admittance.

In an exemplary embodiment of the method of the invention, the venue comprises: a concert hall; a sports stadium; a movie theatre; a live-action theatre; an airplane; a train; a bus; a boat; a dance club; a restaurant; a garage; an office building; a health club; an apartment building; a medical facility; a toll booth, and; a dining club.

In an exemplary embodiment of the method of the invention, venue admittance comprises displaying a facial photograph of the user, wherein upon the verification platform making a positive matching determination that the user is authorized to access the rule-module nexus, the rule-module nexus transmits the user's registered facial photograph for display to a third-party present during the on-line financial transaction for visually verifying that the user's actual face is sufficiently similar to the user's displayed facial photograph to permit venue admittance.

In an exemplary embodiment of the method of the invention, accessing financial accounts comprises: querying data in a financial account; retrieving data from a financial account;

querying data of a financial account via accessing a third-party computer; accessing a third-party computer to retrieve data from a financial account; presenting an electronic visible image of a financial account; presenting an audible signal of a financial account; adjusting the balance in a financial account by making a credit to a financial account, and; adjusting the balance in a financial account by making a debit from a financial account.

In an exemplary embodiment of the method of the invention, the data-storing in the nexus access token comprises: storing no data which can directly access a specific on-line financial account of the user, and; storing no data which can directly identify a specific on-line financial account of the user.

An exemplary embodiment of the method of the invention further comprises verifying the user, further comprising displaying a facial photograph of the user, wherein upon the verification platform making a positive matching determination that the user is authorized to access the rule-module nexus, the rule-module nexus transmits the registered facial photograph of the user for display to a third-party present during the on-line financial transaction, for visually verifying that the user's actual face is sufficiently similar to the user's displayed facial photograph to permit the on-line financial transaction.

An exemplary embodiment of the method of the invention, further comprises data-storing in a user interface apparatus, wherein a hardware verification code, registered with the rule-module nexus and unique to the user interface apparatus, is stored in the user interface apparatus.

In an exemplary embodiment of the method of the invention, a rule-module is registered to an account issuer, said registered rule-module comprising a pattern data associated with an execution command.

In an exemplary embodiment of the method of the invention, a pattern data comprises: the account issuer's legal name; a user interface apparatus hardware verification code; an employer identification number; financial account access authorization fields; a unique account issuer code; an account issuer verification code; a transaction terminal identification code; an emergency code; a financial account; an email address; a telephone number; a mailing address; authority of at least one employee of the account issuer; a digital certificate; a network credential; an Internet protocol address; a digital signature; an encryption key; electronic audible signature, and; an electronic visible signature.

In an exemplary embodiment of the method of the invention, the execution command comprises: accessing a user's financial account; processing a user's financial transaction; presenting selected data from user's rule-module data, and; alerting an emergency authority.

In an exemplary embodiment of the method of the invention, processing the on-line financial transaction further comprises verifying the account issuer, wherein the verification platform electronically compares bid verification data of the account issuer with registered verification data of an account issuer, and makes a matching determination for verifying the account issuer's authority to access the rule-module nexus, said matching determination comprising: making a positive matching determination verifying that the account issuer is authorized to access the rule-module nexus, and; failing to make a positive matching determination, wherein making a negative matching determination is automatic, verifying that the account issuer is not authorized to access the rule-module nexus.

In an exemplary embodiment of the method of the invention, the bid verification data comprises any registered pattern data of the account issuer enabling the verification platform to verify that the account issuer is authorized to access the rule-module nexus.

In an exemplary embodiment of the method of the invention, upon the verification platform making a positive matching determination of the account issuer's authority to access the rule-module nexus, an execution command of the account issuer is invoked, comprising: authorizing a field for accessing rule-modules in the rule-module nexus; accepting a subordinated account user; authorizing a field for accessing a third-party computer being accessed by the rule-module nexus, and; invoking a processing preference of the account issuer.

In an exemplary embodiment of the method of the invention, upon a determination by the rule-module nexus that the account issuer has committed fraud involving the rule-module nexus, data of the account issuer data is registered with a fraud prevention platform, said data comprising: a pattern data; an execution command, and; a rule-module.

In an exemplary embodiment of the method of the invention, a platform is a computer-based set of related data subject to electronic processing with software using predetermined criteria associated with the rule-module nexus, said processing comprising: data storage; data queries; data retrieval, and; data modification.

In an exemplary embodiment of the method of the invention, the rule-module nexus is remotely located from the user, the user interface apparatus, and the nexus access token.

In an exemplary embodiment of the method of the invention, processing the on-line financial transaction further comprises accessing the remotely located rule-module nexus via a network comprising: a cable network; a wireless network; a land-line phone network; the Internet; an intranet; a local area network, a wide area network; an X.25 network.

In an exemplary embodiment of the method of the invention, processing the on-line financial transaction further comprises transmitting transaction data via the rule-module nexus, said transaction data comprising: pricing information; a list of goods and services; a verification data of the user; a verification data of an account issuer; a date or time; a location of the user interface apparatus; a hardware verification code of the user interface apparatus; a payee; an invoice number, and; transaction settlement instruction.

In an exemplary embodiment of the method of the invention, the payee and the account issuer are identical.

In an exemplary embodiment of the method of the invention, the predetermined time period for settlement comprises: an immediate adjustment of a balance in the user's financial account; a delayed adjustment of a balance in the user's financial account, and; a time interval for repeated adjustment of a balance in the user's financial account.

In an exemplary embodiment of the method of the invention, the account issuer of a financial account is the named entity having primary fiduciary duty for administering a financial account of the user, said primary fiduciary duty comprising: managing the financial data within the financial account; adjusting the financial data within the financial account, and; reconciling the financial data within the financial account.

In an exemplary embodiment of the method of the invention, the account issuer comprises: a bank; a merchant; a scrips provider; credit account organization; the rule-module nexus; a government agency; an insurance company; a brokerage firm; a reward incentives provider; a services barter provider; a product barter, and; an internet payment provider.

In an exemplary embodiment of the method of the invention, the financial account is a computerized set of related financial data having a predetermined legal monetary value for usage comprising: purchasing a product; purchasing of a service; exchanging a product; exchanging a service, and; exchanging for other financial data of equivalent monetary value.

In an exemplary embodiment of the method of the invention, the financial account comprises any: checking account; credit account comprising Visa®, MasterCard® and American Express®; reward incentives account; insurance account; brokerage account; savings account; scrip incentives account; pre-paid account; pre-paid ticket; membership benefits account; private label credit account; services barter account; product barter account, and; internet payment account.

In an exemplary embodiment of the method of the invention, an incentives account comprises financial data, comprising: gift certificate units; stored-value units; electronic coupon units having a predetermined monetary value; minutes of telephone calling time; miles towards earning a free airplane flight; accruing units of a predetermined monetary value exchangeable for a product, and; accruing units of a predetermined monetary value exchangeable for a service.

In an exemplary embodiment of the method of the invention, accessing financial accounts further comprises presenting a financial account to the user, comprising: a visible display of an electronic visible signature, and; an audible signal of an electronic audible signature.

An exemplary embodiment of the method of the invention, further comprises ranking the plurality of proprietary financial accounts within a user account registry, wherein predetermined criteria is used for tagging and ranking the plurality of proprietary financial accounts in a certain order.

In an exemplary embodiment of the method of the invention, the predetermined criteria for the ranking further comprises: improving a transaction benefit for an account issuer, and; improving a transaction benefit for the user.

In an exemplary embodiment of the method of the invention, improving a transaction benefit further comprises: increasing efficiency; increasing speed; increasing profit; increasing security; decreasing cost; increasing reward incentives, and; invoking a surcharge predetermined by the user.

In an exemplary embodiment of the method of the invention, the ranking further comprises presenting to the user displays comprising: a plurality of financial accounts, with visibly distinct indicators for the respective rankings of the financial accounts, and; a plurality of financial accounts displayed in sequence as a function of their respective rankings.

In an exemplary embodiment of the method of the invention, the electronic visible signature is an electronic visible image comprising: streaming media; a video clip; a moving image; a holographic display; a static display; a dynamic display; an alpha-numeric display, and; a textual display.

In an exemplary embodiment of the method of the invention, ranking proprietary financial accounts further comprises presenting: a plurality of financial accounts, with audibly distinct indicators for the respective rankings of the financial accounts.

In an exemplary embodiment of the method of the invention, the electronic audible signature is an audible signal comprising: a musical fragment; speech; phonation, and; a song.

In an exemplary embodiment of the method of the invention, the surcharge comprises: an additional financial amount debited from the financial account selected by the user, and credited to a different financial account.

In an exemplary embodiment of the method of the invention, the surcharge comprises: a fixed financial amount, and; a variable financial amount.

In an exemplary embodiment of the method of the invention, the variable financial amount comprises a formula for calculating the surcharge as a function of a predetermined factor comprising: income of the user; a credit score of the user; a financial amount of the transaction; time; a purchasing frequency of the user; a balance in a financial account of the user; an economic indicator, and; a financial objective of the user.

In an exemplary embodiment of the method of the invention, processing the on-line financial transaction further comprises the rule-module nexus accessing a third-party computer, comprising: verifying a user; detecting a rule-module nexus fraud; registering a user fraud; registering an account issuer fraud; alerting of an emergency; resolving a compromised code; accessing a financial account; settlement of the on-line financial transaction, and; completing the on-line financial transaction.

In an exemplary embodiment of the method of the invention, accessing financial accounts further comprises verifying resources, wherein upon a selection of a financial account by the user, an electronic determination is made if the selected financial account of the user has sufficient resources for settlement of the financial transaction.

An exemplary embodiment of the method of the invention further comprises settlement of the on-line financial transaction, comprising: invoking a debit of financial data within the selected financial account of the user, and; invoking a credit of financial data within the selected financial account of the user.

In an exemplary embodiment of the method of the invention, the data-storing in the nexus access token further comprises storing the unique user code in the nexus access token in memory comprising: read only memory, and; read and write memory.

In an exemplary embodiment of the method of the invention, processing the on-line financial transaction further comprises: the rule-module nexus accessing a third-party computer; the rule-module nexus accessing the transaction terminal, and; the rule-module nexus accessing the user interface apparatus.

In an exemplary embodiment of the method of the invention, accessing financial accounts invokes an execution command comprising: querying the user's financial account balance; invoking an authorization a field within the rule-module nexus; invoking a user's rewards program; invoking a micro-merchandising advertising and upsell program; invoking an intelligent tracking and extrapolating agent, and; invoking an automated User notification program.

In an exemplary embodiment of the method of the invention, the automated User notification program invokes an outgoing communication comprising: sending a wireless phone text message; mailing a paper notice; sending a fax; a phone number dialing, and; sending a page.

In an exemplary embodiment of the method of the invention, the transaction terminal comprises: a wireless telephone; a wireless pager; a personal computer; a merchant point of sale register; a vending machine; a venue admittance device; a personal digital assistant; an internet kiosk; a land line telephone; a television, and; a digital music player.

In an exemplary embodiment of the method of the invention, the transaction terminal further comprises: a data-entering touch screen; a data-entering key pad; a visible display screen; an audible signal speaker, and; an audio receiver.

In an exemplary embodiment of the method of the invention, the user interface apparatus comprises: a contactless proximity communications data-reader; a contactless proximity communications data-reader and data-writer; a data-entering touch screen; a data-entering key pad; a visible display screen; an audible signal speaker; an audio receiver, and; a biometric scanning sensor.

In an exemplary embodiment of the method of the invention, the nexus access token communicating capability comprises: radio frequency; infrared signal; digital signal; cellular signal, and vibrational signal; audio signal.

In an exemplary embodiment of the method of the invention, the nexus access token is conjoined with a device comprising: wireless telephone, key fob; wireless pager; personal digital assistant; wearable ornament; digital media player; refillable container; removeably implantable computer chip, and; door key.

In an exemplary embodiment of the method of the invention, the wearable ornament comprises any of the following: jewelry, and; clothing.

In an exemplary embodiment of the method of the invention, the refillable container comprises any of the following: a beverage container, and; a gasoline container.

In an exemplary embodiment of the method of the invention, processing the on-line financial transaction further comprises the real-time elapsed in which the transaction terminal remains on-line communicating with the remotely located rule-module nexus as measured from verifying the user to selecting the financial account.

In an exemplary embodiment of the method of the invention, completing the on-line financial transaction comprises: declining the on-line financial transaction, and; settlement of the financial transaction.

In an exemplary embodiment of the method of the invention, declining the on-line financial transaction is invoked by a party comprising: the user; an account issuer, and; the rule-module nexus.

In an exemplary embodiment of the method of the invention, declining the on-line financial transaction is invoked based upon predetermined criteria comprising: insufficient financial data within the financial account; a credit score of the user; geography; usage frequency; usage recency; demographics of the user; financial amount of the on-line financial transaction; a user fraud; an account issuer fraud, and; a compromised code.

In an exemplary embodiment of the method of the invention, accessing the financial account further comprises determining resources via an account issuer, comprising: a positive determination wherein the selected financial account has sufficient resources, outputting an approval of the financial account for settlement of the on-line financial transaction; a negative determination wherein the selected financial account has insufficient resources, outputting a decline of the financial account for settlement, whereupon at least one other financial account of the user is automatically displayed to the user by the transaction terminal based upon predetermined criteria.

In an exemplary embodiment of the method of the invention, a rule-module comprises: pattern data associated with a plurality of execution commands; a plurality of pattern data associated with an execution command, and; a plurality of pattern data associated with a plurality of execution commands.

In an exemplary embodiment of the method of the invention, the rule-module nexus comprises: a master rule-module nexus comprising all pattern data, execution commands, and rule-modules registered by users and account issuers, and; a subset rule-module nexus comprising a subset of all pattern data, execution commands, and rule-modules registered by users and account issuers.

In an exemplary embodiment of the method of the invention, the subset rule-module nexus comprises a subset of data selected as a function of predetermined criteria, comprising: a credit score of the user; geography; usage frequency; usage recency; demographics of the user; financial amount of the on-line financial transaction; a user fraud; an account issuer fraud, and; a compromised code.

In an exemplary embodiment of the method of the invention, registering a rule-module further comprises checking user re-registration, wherein the registered rule-module of the user is compared against a previously registered rule-module, wherein a match alerts the rule-module nexus that the user is attempting a re-registration.

In an exemplary embodiment of the method of the invention, the biometric sample is an electronic template scanned directly from a biometric of the user, said biometric comprising: a unique human characteristic, comprising: a finger, a retina, an iris, a voice, a face.

An exemplary embodiment of the method of the invention, further comprises notifying a user, wherein upon completing the on-line financial transaction, the transaction terminal presents notification to the user of the on-line financial transaction results, comprising: notification of a decline of the financial transaction, and; notification of settlement of the financial transaction.

In an exemplary embodiment of the method of the invention, presenting notification comprises: a visible display; an audible signal; and a printed receipt.

In an exemplary embodiment of the method of the invention, the emergency authority comprises: a government agency, and; a private entity.

In an exemplary embodiment of the method of the invention, registering a rule-module further comprises aggregating financial account maintenance, wherein the rule-module nexus aggregates maintenance services for the plurality of proprietary financial accounts of the user, said maintenance services comprising: invoicing the user; collecting invoice payments from the user; reconciling scrip incentive financial data; reconciling reward incentive financial data; being an agent for intelligent data tracking on behalf of the user, and; being an agent for extrapolating data on behalf of the user.

An exemplary embodiment of the method of the invention, further comprises verifying the user interface apparatus, wherein the verification platform electronically compares a bid hardware verification code of the user interface apparatus with a previously registered hardware verification code, to make a matching determination for verifying the authenticity of the user interface apparatus via the rule-module nexus, said matching determination comprising: making a positive matching determination verifying to the rule-module nexus that the user interface apparatus is authentic, and; failing to make a positive matching determination, wherein making a negative matching determination is automatic, verifying to the rule-module nexus that the user interface apparatus is not authentic.

The invention also describes a system for on-line financial transactions, comprising: a) a registration platform, configured within a rule-module nexus to comprise registering a rule-module to a user, said rule-module further comprising a pattern data associated with an execution command; b) a nexus access token, configured to comprise: storing a unique user code of the user, and; contactless proximity communications; c) an on-line financial transaction processing platform, comprising: (i) a user interface apparatus, conjoined with a transaction terminal and located remotely from the rule-module nexus, configured to gather bid verification data of the user, said verification data comprising: a bid unique user code scanned directly from the nexus access token, and; a bid personal verification code provided directly by the user; (ii) a verification platform configured to verify a user on-line using the bid verification data, wherein a user's authority to access the rule-module nexus is verified, and; (iii) a user account registry platform configured to access financial accounts via the rule-module nexus, wherein upon the verification platform verifying the user is authorized to access the rule-module nexus, the user is provided on-line access to a plurality of proprietary financial accounts from which the user can select for completing the on-line financial transaction; whereby, a nexus access token and a rule-module nexus provide an authorized user access to a plurality of proprietary financial accounts for processing an on-line financial transaction.

In an exemplary embodiment of the system of the invention, the unique user code comprises: no data directly accessing a specific on-line financial account of the user; no data directly identifying a specific on-line financial account of the user, and; a network routing instruction for processing the on-line financial transaction via the rule-module nexus.

In an exemplary embodiment of the system of the invention, the pattern data comprises: the personal verification code; the unique user code, and; the plurality of proprietary financial accounts.

In an exemplary embodiment of the system of the invention, the user interface apparatus is fully integrated with the transaction terminal.

In an exemplary embodiment of the system of the invention, the rule-module nexus is configured to preserve a processing preference of an account issuer during completing the on-line financial transaction.

In an exemplary embodiment of the system of the invention, the transaction terminal is configured for a financial account to be selected by the user, comprising: a touch-screen; a key pad; data—an audio receiver.

In an exemplary embodiment of the system of the invention, preserving the processing preference of the account issuer comprises: invoking criteria predetermined by the account issuer for declining the on-line financial transaction; invoking criteria predetermined by the account issuer for approving the on-line financial transaction, and; invoking criteria predetermined by the account issuer for settlement of the on-line financial transaction.

In an exemplary embodiment of the system of the invention, criteria predetermined by the account issuer for settlement of the financial transaction comprises: invoking a proprietary network; invoking a discount rate; invoking an interchange fee; invoking a settlement protocol; invoking a surcharge; invoking a processing partner, and; invoking a time period for settlement.

In an exemplary embodiment of the system of the invention, the on-line financial transaction processing platform is configured to comprise: precluding a global execution command from requiring all on-line financial transactions of all users to bypass a processing preference of an account issuer; precluding a global execution command from requiring all on-line financial transactions of all users to invoke a specific processing preference of a specific account issuer; precluding a global execution command from requiring all on-line financial transactions of all users to use a specific merchant service, and; precluding a global execution command from requiring all on-line financial transactions of all users to use a specific merchant product.

An exemplary embodiment of the system of the invention, further comprises a compromised code identification platform, configured to identify a code as compromised based on an occurrence comprising: unusual usage of the code; loss of the code; inaccessibility of the code due to nexus access token damage; fraudulent duplication of the code; unauthorized access to the code, and; coersion of the user.

In an exemplary embodiment of the system of the invention, the compromised code comprises: a unique user code; a personal verification code; a verification approval code; a user account registry code, and; an account issuer verification code, and; a user interface apparatus hardware verification code.

An exemplary embodiment of the system of the invention, further comprises a compromised code resolution platform configured to comprise: deactivating the compromised code and activating a replacement code, and; verifying the user by providing dual personal verification codes.

In an exemplary embodiment of the system of the invention, activating the replacement code comprises: data-storing a replacement unique user code in the nexus access token of the user to replace a compromised unique user code stored therein, and; data-storing a replacement unique user code in a new nexus access token of the user, the new nexus access token replacing a nexus access token of the user storing a compromised unique user code.

In an exemplary embodiment of the system of the invention, the plurality comprises at least two.

In an exemplary embodiment of the system of the invention, proprietary financial accounts comprise: an account issuer of a first financial account being distinct from an account issuer of a second financial account.

In an exemplary embodiment of the system of the invention, the verification platform further comprises being configured to electronically compare the user's bid unique user code and the user's bid personal verification code with a user's registered unique user code and a user's registered personal verification code, and make a matching determination for verifying the user's authority to access the rule-module nexus, said matching determination comprising: making a positive matching determination verifying that the user is authorized to access the rule-module nexus, and; failing to make a positive matching determination, wherein making a negative matching determination is automatic, verifying that the user is not authorized to access the rule-module nexus.

In an exemplary embodiment of the system of the invention, upon a positive matching determination, the verification platform issues a verification approval code invoking a rule-module of the user in the rule-module nexus.

In an exemplary embodiment of the system of the invention, the verification approval code invokes a user account registry code identifying a user account registry platform, said user account registry code comprising: no data directly identifying a specific financial account of the user, and; no data identifying a primary financial account of the user for all on-line financial transactions of the user.

In an exemplary embodiment of the system of the invention, the account registry platform comprises a plurality of proprietary financial accounts of the user.

In an exemplary embodiment of the system of the invention, the verification approval code is the same as the user account registry code identifying the account registry platform.

An exemplary embodiment of the system of the invention, further comprises a rule-module modification platform, configured for a rule-module of the user to be modified by parties authorized by the rule-module nexus, said parties comprising: the user; the rule-module nexus; an account issuer; and a third-party with predetermined authorization.

In an exemplary embodiment of the system of the invention, modifying a rule-module further comprises: registering, deleting, adding pattern data; registering, deleting, adding execution commands, and; registering, deleting, adding associations between pattern data and execution commands.

In an exemplary embodiment of the system of the invention, the pattern data comprises: personal legal name; a private code; a driver's license number; a unique user code; a personal verification code; a secondary personal verification code; an emergency code; a plurality of proprietary financial accounts; demographic information; an email address; social security number; a mother's maiden name; a biometric sample; a facial photograph; an Internet browsing pattern; a telephone number; a mailing address; a purchasing pattern; an authorized subordinated user; electronic data usage patterns; employee status; job title; data on user behavior patterns; a credit score; a digital certificate; a network credential; an Internet protocol address; a digital signature; an encryption key; an instant messaging address; personal medical records; an electronic audible signature, and; an electronic visible signature.

In an exemplary embodiment of the system of the invention, the execution command comprises invoking at least one of the following: accessing the rule-module nexus; accessing a financial account; authorizing a subordinated user to access a financial account of the user; presenting a financial account of the user; completing the on-line financial transaction; authorizing settlement of the on-line transaction; presenting the pattern data; presenting the execution command; presenting the rule-module; notifying an emergency authority upon rule-module nexus receiving an emergency code of the user; accessing a third-party database, and; accessing an account issuer.

In an exemplary embodiment of the system of the invention, invoking the rule-module comprises: accessing a plurality of rule-modules in the rule-module nexus; accessing a plurality of proprietary financial accounts; authorizing a subordinated account user authority; accessing a third-party computer via the rule-module nexus.

In an exemplary embodiment of the system of the invention, the unique user code comprises: a dynamic code which changes periodically based on predetermined criteria synchronized with the verification platform, and; a static code which remains constant based on a predetermined code synchronized with the verification platform.

In an exemplary embodiment of the system of the invention, the personal verification code comprises: an alpha-numeric sequence selected by the user; an alpha-numeric sequence selected by the rule-module nexus; an alpha-numeric sequence selected by an account issuer, and; a biometric sample selected by the user.

In an exemplary embodiment of the system of the invention, the rule-module nexus further comprises a fraud prevention platform configured to invoke criteria predetermined to detecting fraud by the user involving the rule-module nexus, said criteria comprising: unusual usage of bid verification data; unusual modifying of a rule-module, and; unusual accessing of a financial account.

An exemplary embodiment of the system of the invention, further comprises a user fraud registration platform configured to determine if the user has committed fraud involving the rule-module nexus, wherein data of the user is registered with a fraud prevention platform, said data comprising: a pattern data; an execution command, and; a rule-module.

An exemplary embodiment of the system of the invention, further comprises a rule-module nexus verification platform, configured for the private code, registered to the user, distinct from a personal verification code and not used in verifying the user, to be presented to the user via the rule-module nexus for verifying to the user that the authentic rule-module nexus has been accessed.

In an exemplary embodiment of the system of the invention, the private code is registered to the user in the rule-module nexus by a party, said party comprising: the user; the rule-module nexus, and; an account issuer.

An exemplary embodiment of the system of the invention, further comprises an emergency alert platform configured to send an alert via rule-module nexus of an emergency wherein, the emergency code, distinct from a personal verification code and not used in verifying the user, is provided by the user to the transaction terminal, said emergency comprising: the bid verification data being compromised; the nexus access token being compromised, and; the user being coerced.

In an exemplary embodiment of the system of the invention, the emergency code comprises: an alpha-numeric code; a visible image, and; an audible signal.

In an exemplary embodiment of the system of the invention, the emergency alert platform is configured to invoke an execution command via the rule-module nexus, comprising: presenting a visible display of predetermined emergency data to the user; presenting an audible signal of predetermined emergency data to the user; alerting an emergency authority, and; identifying a compromised code.

In an exemplary embodiment of the system of the invention, the visible display comprises: a false financial account; a false financial data with in a financial account, and; confirming an emergency authority has been contacted.

In an exemplary embodiment of the system of the invention, the audible signal comprises: a false financial account; a false financial data within a financial account, and; confirming an emergency authority has been contacted.

In an exemplary embodiment of the system of the invention, the compromised code resolution platform is configured to further comprise deactivating the unique user code and activating a secondary personal verification code.

In an exemplary embodiment of the system of the invention, the rule-module nexus is configured to enable the user to provide a bid secondary personal verification code to the verification platform in replacement of the user's unique user code.

An exemplary embodiment of the system of the invention, further comprises: a) a calling platform configured for the user to call from a predetermined first phone number to a predetermined second phone number; b) a data-entering platform configured for the user to enter the personal verification code; c) an invoking platform configured for the user to invoke a secondary personal verification code, and; d) a notification platform for notifying the user that the secondary personal verification code has been activated for providing dual personal verification codes when verifying the user.

In an exemplary embodiment of the system of the invention, the invoking platform is configured to comprise: creating by the user of a secondary personal verification code, and; accepting by the user of an offered secondary personal verification code.

An exemplary embodiment of the system of the invention, further comprises: a) an emailing platform for the user to email from a predetermined internet protocol address to a predetermined web site; b) a data-entering platform configured for the user to enter the personal verification code; c) an invoking platform configured for the user to invoke a secondary personal verification code, and; d) a notification platform for notifying the user that the secondary personal verification code has been activated for providing dual personal verification codes when verifying the user.

In an exemplary embodiment of the system of the invention, the invoking platform is configured to comprise: creating by the user of a secondary personal verification code, and; accepting by the user of an offered secondary personal verification code

In an exemplary embodiment of the system of the invention, the verification platform is configured to further comprise the bid personal verification code and the bid secondary personal verification code, both provided directly by the user to the user interface apparatus, being electronically compared with a registered personal verification code and a registered secondary personal verification code, to make a matching determination for verifying the user's authority to access the rule-module nexus.

In an exemplary embodiment of the system of the invention, the limited basis comprises: a predetermined time period; predetermined financial account access when using the secondary personal verification code; predetermined frequency for usage for using the secondary personal verification code, and; predetermined geographic area for using the secondary personal verification code.

In an exemplary embodiment of the system of the invention, the secondary personal verification code comprises: an alpha-numeric sequence selected by the user; an alpha-numeric sequence selected by the rule-module nexus; an alpha-numeric sequence selected by an account issuer, and; a biometric sample selected by the user.

In an exemplary embodiment of the system of the invention, the on-line financial transaction platform is configured to comprise: a credit transaction; a debit transaction; a scrip transaction; a rewards transaction; an electronic check transaction; a private label transaction; a stored value transaction; an electronic benefits transfer transaction; a brokerage trade transaction; invoking a surcharge to a transaction based on predetermined criteria; a buyer-seller exchange transaction wherein a user's financial account balance is adjusted and an account issuer's financial account is correspondingly adjusted; an intra-account transfer transaction between financial accounts of the user without a buyer-seller exchange; redeeming a pre-paid ticket transaction for venue admittance, and; redeeming a pre-paid membership benefit transaction for venue admittance.

In an exemplary embodiment of the system of the invention, the venue comprises: a concert hall; a sports stadium; a movie theatre; a live-action theatre; an airplane; a train; a bus; a boat; a dance club; a restaurant; a garage; an office building; a health club; an apartment building; a medical facility; a toll booth, and; a dining club.

In an exemplary embodiment of the system of the invention, venue admittance comprises displaying a facial photograph of the user, wherein upon the verification platform making a positive matching determination that the user is authorized to access the rule-module nexus, the rule-module nexus transmits the user's registered facial photograph for display to a third-party present during the on-line financial transaction for visually verifying that the user's actual face is sufficiently similar to the user's displayed facial photograph to permit venue admittance.

In an exemplary embodiment of the system of the invention, the account registry platform is configured to comprise: querying data in a financial account; retrieving data from a financial account; querying data of a financial account via accessing a third-party computer; accessing a third-party computer to retrieve data from a financial account; presenting an electronic visible image of a financial account; presenting an audible signal of a financial account; adjusting the balance in a financial account by making a credit to a financial account, and; adjusting the balance in a financial account by making a debit from a financial account.

In an exemplary embodiment of the system of the invention, the nexus access token is configured to further comprise: storing no data which can directly access a specific on-line financial account of the user, and; storing no data which can directly identify a specific on-line financial account of the user.

In an exemplary embodiment of the system of the invention, the verification platform is configured to further comprise displaying a facial photograph of the user, wherein upon the verification platform making a positive matching determination that the user is authorized to access the rule-module nexus, the rule-module nexus transmits the registered facial photograph of the user for display to a third-party present during the on-line financial transaction, for visually verifying that the user's actual face is sufficiently similar to the user's displayed facial photograph to permit the on-line financial transaction.

In an exemplary embodiment of the system of the invention, the user interface apparatus is configured to comprise storing a hardware verification code, registered with the rule-module nexus and unique to the user interface apparatus.

In an exemplary embodiment of the system of the invention, the registration platform is configured to further comprise registering a rule-module to an account issuer, said registered rule-module comprising a pattern data associated with an execution command.

In an exemplary embodiment of the system of the invention, the pattern data comprises: the account issuer's legal name; a user interface apparatus hardware verification code; an employer identification number; financial account access authorization fields; a unique account issuer code; an account issuer verification code; a transaction terminal identification code; an emergency code; a financial account; an email address; a telephone number; a mailing address; authority of at least one employee of the account issuer; a digital certificate; a network credential; an Internet protocol address; a digital signature; an encryption key; electronic audible signature, and; an electronic visible signature.

In an exemplary embodiment of the system of the invention, the execution command comprises: accessing a user's financial account; processing a user's financial transaction; presenting selected data from user's rule-module data, and; alerting an emergency authority.

In an exemplary embodiment of the system of the invention, the verification platform is further configured to verify the account issuer by electronically comparing bid verification data of the account issuer with registered verification data of an account issuer, and makes a matching determination for verifying the account issuer's authority to access the rule-module nexus, said matching determination comprising: making a positive matching determination verifying that the account issuer is authorized to access the rule-module nexus, and; failing to make a positive matching determination, wherein making a negative matching determination is automatic, verifying that the account issuer is not authorized to access the rule-module nexus.

In an exemplary embodiment of the system of the invention, the bid verification data comprises any registered pattern data of the account issuer enabling the verification platform to verify that the account issuer is authorized to access the rule-module nexus.

In an exemplary embodiment of the system of the invention, upon the verification platform making a positive matching determination of the account issuer's authority to access the rule-module nexus, an execution command of the account issuer is invoked, comprising: authorizing a field for accessing rule-modules in the rule-module nexus; accepting a subordinated account user; authorizing a field for accessing a third-party computer being accessed by the rule-module nexus, and; invoking a processing preference of the account issuer.

An exemplary embodiment of the system of the invention, further comprises a fraud prevention platform configured to register data of the account issuer data upon a determination by the rule-module nexus that the account issuer has committed fraud involving the rule-module nexus, said data comprising: a pattern data; an execution command, and; a rule-module.

In an exemplary embodiment of the system of the invention, a platform is a computer-based set of related data subject to electronic processing with software using predetermined criteria associated with the rule-module nexus, said processing comprising: data storage; data queries; data retrieval, and; data modification.

In an exemplary embodiment of the system of the invention, the rule-module nexus is remotely located from the user, the user interface apparatus, and the nexus access token.

In an exemplary embodiment of the system of the invention, the on-line financial transaction processing platform is configured to further comprise accessing the remotely located rule-module nexus via a network, comprising: a cable network; a wireless network; a land-line phone network; the Internet; an intranet; a local area network, a wide area network; an X.25 network.

In an exemplary embodiment of the system of the invention, the on-line financial transaction processing platform further comprises transmitting transaction data via the rule-module nexus, said transaction data comprising: pricing information; a list of goods and services; a verification data of the user; a verification data of an account issuer; a date or time; a location of the user interface apparatus; a hardware verification code of the user interface apparatus; a payee; an invoice number, and; transaction settlement instruction.

In an exemplary embodiment of the system of the invention, the payee and the account issuer are identical.

In an exemplary embodiment of the system of the invention, the predetermined time period for settlement comprises: an immediate adjustment of a balance in the user's financial account; a delayed adjustment of a balance in the user's financial account, and; a time interval for repeated adjustment of a balance in the user's financial account.

In an exemplary embodiment of the system of the invention, the account issuer of a financial account is the named entity having primary fiduciary duty for administering a financial account of the user, said primary fiduciary duty comprising: managing the financial data within the financial account; adjusting the financial data within the financial account, and; reconciling the financial data within the financial account.

In an exemplary embodiment of the system of the invention, the account issuer comprises: a bank; a merchant; a scrips provider; credit account organization; the rule-module nexus; a government agency; an insurance company; a brokerage firm; a reward incentives provider; a services barter provider; a product barter, and; an internet payment provider.

In an exemplary embodiment of the system of the invention, the financial account is a computerized set of related financial data having a predetermined legal monetary value for usage comprising: purchasing a product; purchasing of a service; exchanging a product; exchanging a service, and; exchanging for other financial data of equivalent monetary value.

In an exemplary embodiment of the system of the invention, the financial account comprises any: checking account; credit account comprising Visa®, MasterCard® and American Express® reward incentives account; insurance account; brokerage account; savings account; scrip incentives account; pre-paid account; pre-paid ticket; membership benefits account; private label credit account; services barter account; product barter account, and; internet payment account.

In an exemplary embodiment of the system of the invention, an incentives account comprises financial data, comprising: gift certificate units; stored-value units; electronic coupon units having a predetermined monetary value; minutes of telephone calling time; miles towards earning a free airplane flight; accruing units of a predetermined monetary value exchangeable for a product, and; accruing units of a predetermined monetary value exchangeable for a service.

An exemplary embodiment of the system of the invention is configured to further comprise presenting a financial account to the user, comprising: a visible display of an electronic visible signature, and; an audible signal of an electronic audible signature.

In an exemplary embodiment of the system of the invention, the user account registry platform is configured to further comprise ranking the plurality of proprietary financial accounts, wherein predetermined criteria is used for tagging and ranking the plurality of proprietary financial accounts in a certain order.

In an exemplary embodiment of the system of the invention, the predetermined criteria for the ranking further comprises: improving a transaction benefit for an account issuer, and; improving a transaction benefit for the user.

In an exemplary embodiment of the system of the invention, improving a transaction benefit further comprises: increasing efficiency; increasing speed; increasing profit; increasing security; decreasing cost; increasing reward incentives, and; invoking a surcharge predetermined by the user.

In an exemplary embodiment of the system of the invention, the ranking further comprises presenting to the user displays comprising: a plurality of financial accounts, with visibly distinct indicators for the respective rankings of the financial accounts, and; a plurality of financial accounts displayed in sequence as a function of their respective rankings.

In an exemplary embodiment of the system of the invention, the electronic visible signature is an electronic visible image comprising: streaming media; a video clip; a moving image; a holographic display; a static display; a dynamic display; an alpha-numeric display, and; a textual display.

In an exemplary embodiment of the system of the invention, ranking proprietary financial accounts further comprises presenting: a plurality of financial accounts, with audibly distinct indicators for the respective rankings of the financial accounts.

In an exemplary embodiment of the system of the invention, the electronic audible signature is an audible signal comprising: a musical fragment; speech; phonation, and; a song.

In an exemplary embodiment of the system of the invention, the surcharge comprises: an additional financial amount debited from the financial account selected by the user, and credited to a different financial account.

In an exemplary embodiment of the system of the invention, the surcharge comprises: a fixed financial amount, and; a variable financial amount.

In an exemplary embodiment of the system of the invention, the variable financial amount comprises a formula for calculating the surcharge as a function of a predetermined factor comprising: income of the user; a credit score of the user; a financial amount of the transaction; time; a purchasing frequency of the user; a balance in a financial account of the user; an economic indicator, and; a financial objective of the user.

In an exemplary embodiment of the system of the invention, the on-line financial transaction processing platform is configured to further comprise the rule-module nexus accessing a third-party computer, comprising: verifying a user; detecting a rule-module nexus fraud; registering a user fraud; registering an account issuer fraud; alerting of an emergency; resolving a compromised code; accessing a financial account; settlement of the on-line financial transaction, and; completing the on-line financial transaction.

In an exemplary embodiment of the system of the invention, the user account registry platform is configured to further comprise verifying resources, wherein upon a selection of a financial account by the user, an electronic determination is made if the selected financial account of the user has sufficient resources for settlement of the financial transaction.

In an exemplary embodiment of the system of the invention, the on-line financial transaction processing platform is configured to further comprise settlement of the on-line financial transaction, comprising: invoking a debit of financial data within the selected financial account of the user, and; invoking a credit of financial data within the selected financial account of the user.

In an exemplary embodiment of the system of the invention, the nexus access token is configured to further comprise: read only memory, and; read and write memory.

In an exemplary embodiment of the system of the invention, the on-line financial transaction processing platform is configured to further comprise: the rule-module nexus accessing a third-party computer; the rule-module nexus accessing the transaction terminal, and; the rule-module nexus accessing the user interface apparatus.

In an exemplary embodiment of the system of the invention, the user account registry platform is configured to further comprise accessing financial accounts, comprising: querying the user's financial account balance; invoking an authorization a field within the rule-module nexus; invoking a user's rewards program; invoking a micro-merchandising advertising and upsell program; invoking an intelligent tracking and extrapolating agent, and; invoking an automated User notification program.

In an exemplary embodiment of the system of the invention, the automated User notification program invokes an outgoing communication comprising: sending a wireless phone text message; mailing a paper notice; sending a fax; a phone number dialing, and; sending a page.

In an exemplary embodiment of the system of the invention, the transaction terminal comprises: a wireless telephone; a wireless pager; a personal computer; a merchant point of sale register; a vending machine; a venue admittance device; a personal digital assistant; an internet kiosk; a land line telephone; a television, and; a digital music player.

In an exemplary embodiment of the system of the invention, the transaction terminal further comprises: a data-entering touch screen; a data-entering key pad; a visible display screen; an audible signal speaker, and; an audio receiver.

In an exemplary embodiment of the system of the invention, the user interface apparatus comprises: a contactless proximity communications data-reader; a contactless proximity communications data-reader and data-writer; a data-entering touch screen; a data-entering key pad; a visible display screen; an audible signal speaker; an audio receiver, and; a biometric scanning sensor.

In an exemplary embodiment of the system of the invention, contactless proximity communications comprise: radio frequency; infrared signal; digital signal; cellular signal, and vibrational signal; audio signal.

In an exemplary embodiment of the system of the invention, the nexus access token is conjoined with a device comprising: wireless telephone, key fob; wireless pager; personal digital assistant; wearable ornament; digital media player; refillable container; removeably implantable computer chip, and; door key.

In an exemplary embodiment of the system of the invention, the wearable ornament comprises any of the following: jewelry, and; clothing.

In an exemplary embodiment of the system of the invention, the refillable container comprises any of the following: a beverage container, and; a gasoline container.

In an exemplary embodiment of the system of the invention, the on-line financial transaction processing platform is configured to further comprise measuring the real-time elapsed in which the transaction terminal remains on-line communicating with the remotely located rule-module nexus from verifying the user to selecting the financial account.

In an exemplary embodiment of the system of the invention, completing the on-line financial transaction comprises: declining the on-line financial transaction, and; settlement of the financial transaction.

In an exemplary embodiment of the system of the invention, declining the on-line financial transaction is invoked by a party comprising: the user; an account issuer, and; the rule-module nexus.

In an exemplary embodiment of the system of the invention, declining the on-line financial transaction is based upon predetermined criteria comprising: insufficient financial data within the financial account; a credit score of the user; geography; usage frequency; usage recency; demographics of the user; financial amount of the on-line financial transaction; a user fraud; an account issuer fraud, and; a compromised code.

An exemplary embodiment of the system of the invention further comprises a resource determination platform configured to determining resources of a financial account via an account issuer, comprising: a positive determination wherein the selected financial account has sufficient resources, outputting an approval of the financial account for settlement of the on-line financial transaction; a negative determination wherein the selected financial account has insufficient resources, outputting a decline of the financial account for settlement, whereupon at least one other financial account of the user is automatically displayed to the user by the transaction terminal based upon predetermined criteria.

In an exemplary embodiment of the system of the invention, a rule-module comprises: pattern data associated with a plurality of execution commands; a plurality of pattern data associated with an execution command, and; a plurality of pattern data associated with a plurality of execution commands.

In an exemplary embodiment of the system of the invention, the rule-module nexus is configured to comprise: a master rule-module nexus comprising all pattern data, execution commands, and rule-modules registered by users and account issuers, and; a subset rule-module nexus comprising a subset of all pattern data, execution commands, and rule-modules registered by users and account issuers.

In an exemplary embodiment of the system of the invention, the subset rule-module nexus is configured to comprise a subset of data selected as a function of predetermined criteria, comprising: a credit score of the user; geography; usage frequency; usage recency; demographics of the user; financial amount of the on-line financial transaction; a user fraud; an account issuer fraud, and; a compromised code.

In an exemplary embodiment of the system of the invention, registering a rule-module further comprises checking user re-registration, wherein the registered rule-module of the user is compared against a previously registered rule-module, wherein a match alerts the rule-module nexus that the user is attempting a re-registration.

In an exemplary embodiment of the system of the invention, the biometric sample is an electronic template scanned directly from a biometric of the user, said biometric comprising: a unique human characteristic, comprising: a finger, a retina, an iris, a voice, a face.

An exemplary embodiment of the system of the invention, further comprises a notification platform configured to present notification of the on-line financial transaction results to the user upon completing the on-line financial transaction, comprising: notification via the transaction terminal of a decline of the on-line financial transaction, and; notification via the transaction terminal of settlement of the one-line financial transaction.

In an exemplary embodiment of the system of the invention, presenting notification comprises: a visible display; an audible signal; and a printed receipt.

In an exemplary embodiment of the system of the invention, the emergency authority comprises: a government agency, and; a private entity.

In an exemplary embodiment of the system of the invention, the rule-module nexus further comprises a financial account aggregating maintenance module configured to aggregate maintenance services for the plurality of proprietary financial accounts of the user, said maintenance services comprising: invoicing the user; collecting invoice payments from the user; reconciling scrip incentive financial data; reconciling reward incentive financial data; being an agent for intelligent data tracking on behalf of the user, and; being an agent for extrapolating data on behalf of the user.

In an exemplary embodiment of the system of the invention, the verification platform is configured to further comprise verifying the user interface apparatus by electronically comparing a bid hardware verification code of the user interface apparatus with a previously registered hardware verification code, to make a matching determination for verifying the authenticity of the user interface apparatus via the rule-module nexus, said matching determination comprising: making a positive matching determination verifying to the rule-module nexus that the user interface apparatus is authentic, and; failing to make a positive matching determination, wherein making a negative matching determination is automatic, verifying to the rule-module nexus that the user interface apparatus is not authentic.

It will be appreciated that the invention illustratively disclosed herein through exemplary embodiments may suitably be practiced in the absence of any element which is not specifically disclosed herein, particularly in a preferred embodiment.

These and other advantages of the invention will become more fully apparent when the following detailed description of the invention is read in conjunction with the accompanying drawings.

### BRIEF DESCRIPTION OF THE DRAWINGS

Additional aspects of the present invention will become evident upon reviewing the non-limiting, exemplary embodiments described in the specification and the claims taken in conjunction with the accompanying figures, wherein like reference numerals denote like elements.

FIG. 1 shows a preferred embodiment of the Rule-Module Nexus (RMN or Nexus), with a Nexus access token (NAT) and a User interface apparatus (UTA).

FIG. 2 shows a preferred embodiment of the Rule-Module Nexus, showing the network connections with various Account Issuers (AI).

FIG. 3 shows an embodiment of the invention depicting various configurations with an User Account Registry 15, internal Execution Platforms and external Execution Platforms, and Third-Party Platforms.

FIG. 3A shows a schematic illustration of an exemplary User Interface Apparatus in accordance with the present invention.

FIG. 4 shows an embodiment of the invention wherein the Rule-Module Nexus's network connectivity maintains dedicated frame relay lines to RMN Platforms co-located with Account Issuers' Acquirer sites and Account Issuers' Merchant Network Operation Centers (NOCs) in order to update and backup the RMN's data network. In turn, these RMN Platforms are linked to UIAs in Account Issuers' merchant locations through either the Merchant's in-store dedicated link to the Network Operations Center (NOC), or dial-up connectivity to an Acquirer/Processor.

FIG. 4A shows a flow chart of an embodiment of a verification (or authentication) process.

FIG. 4B through FIG. 4D show, respectively: an embodiment of a financial transaction request packet (or message); an embodiment of a financial transaction response packet (or message); an embodiment of the construction of a financial transaction response packet (or message).

FIG. 4E shows a flow chart of the operation of the User Interface Apparatus and the Transaction Terminal (or Terminal) for generating a request packet.

FIG. 4F shows a flow chart depicting the data encryption and sealing process at the User Interface Apparatus.

FIG. 4G shows a flow chart depicting the data decryption and counter party identification process at the Rule-Module Nexus.

FIG. 4H shows a flow chart depicting the data encryption and sealing process at the Rule-Module Nexus.

FIG. 4I shows a representational diagram of the request packet and the mandatory and optional data it contains.

FIG. 4J shows a representational diagram of the response packet and the mandatory and optional data it contains.

FIG. 5 shows an embodiment of the Rule-Modules for a plurality of Users within the Rule-Module Nexus.

FIG. 6, FIG. 7A, and FIG. 7B show various embodiments of Rule-Modules, with various associations between Pattern Data and Execution Commands, including Global Queries and Global Execution Commands.

FIG. 8 and FIG. 8A show embodiments of the invention, depicting wireless modem and networked connections between various UIA's and the RMN, including Subset RMN's, a Master RMN, Redundant Master RMN, and Third-Party Platforms.

FIG. 9 through FIG. 11 shows a system block diagram and system architecture for a Merchant Point-of-Sale connected to a remote RMN.

FIG. 11A shows a block diagram of an exemplary data structure of the UAR platform in accordance with the present invention.

FIG. 12 shows a high performance, semi-redundant configuration for the RMN FIG. 13 shows a RMN financial transaction for rewards.

FIG. 14 shows a RMN financial transaction for an electronic check (eCheck).

FIG. 15 and FIG. 16 show RMN financial transactions for Credit and Debit.

FIG. 17 shows a flow chart of registration and transaction processing with the Rule-Module Nexus.

FIG. 18 shows a flow chart of registration and transaction processing with the Rule-Module Nexus, User Account Registry, and Third-Party Platforms.

FIG. 19 through FIG. 21 show use-sensitive embodiments, with Master, Intermediary, and Local (or Subset) configurations.

FIG. 22 through FIG. 28 show process flow embodiments of Rule-Module Nexus processing of financial transactions.

### GLOSSARY

AI (ACCOUNT ISSUER): the named entity with primary fiduciary duty for administering a financial account of a user, said fiduciary duty comprising: managing the financial data within the financial account, and; reconciling the financial data within the financial account upon settlement of an on-line financial transaction.

ACCOUNT ISSUER BATCH: A collection of “add” and “delete” instructions complete with UUC-IDs, financial asset accounts, and account index codes verified and submitted by an account issuer to the RMN.

AIP (Account Issuer Platform): Platform comprising data for account issuers that are allowed to add and delete financial asset account numbers with the RMN or RMN-authorized Third-Party platforms.

AIT (Account Issuer Transaction Terminals): Provides a batch connection to the RMN or third-party platforms for account issuers to add and remove (their own) financial asset account numbers from specific individual's UUC records.

AOD (or AOP): Apparatus Owner Database (or Apparatus Owner Platform): stores information about the owners of UIA devices.

ASCII: American Standard Code for Information Interchange

ATM (Automated Teller Machinery): Uses encoded UUC-PVC packet verification information to obtain access to an account issuer or third-party platform, including authorizing cash dispensing and account management.

BRT (Banking Retail Transaction Terminal-UIA): UUC Registration and Re-Coding UIA's, located at retail banking outlets, BRT's combine UUC registration information with an individual-selected PVC and selected personal information to register individuals with the RMN or third-party platforms.

BRT-SP: Banking Retail Transaction Terminal-Subset Platform

CBC (Cipher Block Chaining): an encryption mode for the DES.

CCD: Charged-Coupled Device

CPT (Cable-TV Point-of-Sale UIA): Transaction terminal combining an onscreen display simulcast digital signal informing TV-top cable box of product information with product video, and an UIA controller remote which performs the UUC-PVC validation using the CATV communications network. Order/autho/mailing-address/item-id forwarded to merchant. Results of authorization are displayed on the TV.

CST (Customer Service Transaction Terminals): Provide RMN or third-party platforms User service personnel with varying degrees of access (based on access privilege) the ability to retrieve and modify information on individuals in order to help people with account problems.

DUAL SEALING STEP: The conversion of plain text to cipher text (known as “encryption”) in combination with the encrypted check-summing of a message that allows information to remain in plain text while at the same time providing a means for detecting any subsequent modification of the message.

DES (Digital Encryption Standard): A standard for the cryptographic protection of digital data. See standard ANSI X3.92-1981

DETERMINATION: the status of the command processed during the execution step.

DSP (Digital Signal Processor): a class of integrated circuits that specialize in the mathematical operations required by the signal processing applications.

DUKPT (Derived Unique Key Per Transaction): See standard ANSI/ABA X9.24-1992

EMERGENCY CODE: The alpha-numeric sequence, visible image or audible signal selected by an individual which, when accessed, will result in a transaction being labeled by the RMN or third-party platforms as an emergency alert, potentially causing the display of false screens and/or the notification of emergency authorities that said individual has been coerced into performing a transmission or transaction. An emergency authority may comprises: the RMN; a governmental agency (e.g., fire, medical, police, sheriff), and; a private third-party company (e.g., Brinks™, Bay Alarm™)

EP: Execution Platform (or ECP: Execution Command Platform)

ESP (Electronic Signature Platform): Platform comprising all MD5 and electronic signatures of all documents signed by anybody, referenced by authorization number.

EST (Electronic Signature Transaction Terminal): Uses UTA to verify, computer calculates checksum on document, sends checksum to RMN or third-party platforms,

RMN or third-party platforms validates, timestamps, saves checksum, and returns with sig-code. Uses Internet as transport. EST also verifies signatures given a sig code and an MD5 calculation.

EXECUTION COMMANDS: A program or subroutine residing in Rule-Modules of the RMN that performs a specific task, activated by a request message sent from a UIA-conjoined Transaction Terminal.

FAR (False Accept Rate): The statistical likelihood that one user's UUC-PVC algorithmic verification will be incorrectly verified as the UUC-PVC of another user.

FALSE SCREENS: Displays of information which has been intentionally pre-determined to be subtly inaccurate such that a coercing party will not illegally obtain accurate data about an individual's financial assets, all the while remaining unaware of the alteration of the information.

FDDI (Fiber Digital Device Interface): a networking device that utilizes a fiber optic token ring.

FS: Field Separator

FW (Firewall Platform): The network—Local or Subset net router that regulates traffic into and out of the RMN.

GEC (Global Execution Command): Preferably customized to the user. Note that in a preferred embodiment of this invention, a GEC does not require all financial transactions of all users to automatically comprise any of the following: being linked to any particular account issuer; invoking a specific on-line transaction processing preference for all financial accounts for all users; being appended to any particular product or service, and; being diverted from any predetermined processing preferences of an account issuer which would otherwise apply to a financial account selected by a user during a financial transaction.

GP (Gateway Platform): the main communications directing platforms in the RMN; which direct the flow of electronic messages to other platforms within the RMN and with third-party platforms.

INTERMEDIARY PLATFORM (or Intermediary Computer): Both defined the same, as computer hardware and software storing a more complete set of data than the Subset Platform, but storing less data than the Master Platform.

IPT (Internet Point-of-Sale Transaction Terminal): Communicates product/services data and merchant code from the internet, appends UUC-PVC via UIA for validation and sends to RMN using Internet, wherein autho/order/PO # forwarded to merchant. RMN response using internet as well, displaying results on screen of the Transaction Terminal.

ITT (Internet Teller UIA): Authorizes network UIA session using encrypted credential obtained from RMN using UUC-ID.

LCD (Liquid Crystal Display): A technology used for displaying text and visible images.

MAC (Message Authentication Code): an encrypted checksum algorithm, the MAC provides assurance that the contents of a message have not been altered subsequent to the MAC calculation. See standard ANSI X9.9-1986

MACP (or MACM): Message Authentication Code Platform (or Message Authentication Code Module): a software platform in the RMN that handles MAC validation and generation for inbound and outbound packets.

MDP (or MDM): Message Decrypt Platform (or Message Decrypt Module): a software module in the RMN that encrypts and decrypts packets from or destined to an UIA device.

MPP (or MDM): Message Processing Platform (or Message Processing Module): a software module in the RMN that performs the processing of request packets.

MASTER PLATFORM (or Master Computer): Both defined the same, as computing hardware and software storing a complete set of all data being used in the invention.

MERCHANT (or Retailer): A party retailing or selling services or goods via on-line financial transactions to other parties or entities by means of the Internet or a physical storefront.

MPU (Merchant Point-of-Sale UIA) or (RPU: Retailer Point-of-Sale UIA): a combines encoded UUC verification information with retail transaction information (possibly from an electronic cash register) and formulates authorization requests of the RMN or third-party platforms using X.25 networks, modems, etc.

MSP (Merchant Subset Platform) or (RSP: Retailer Subset Platform): A Platform residing with a Merchant, comprising a subset of all data in the RMN pertaining to a user

MDP (Message Decrypt Platform): A software platform in the RMN that encrypts and decrypts packets from or destined to an UIA device.

MPP (Message Processing Platform): A software platform in the RMN that performs the processing of request packets.

NAT (Nexus Access Token): Preferably, the NAT is “thin-client”, and not required to store any data which may directly identify or directly access an on-line financial account of an authorized user. The NAT uses contactless proximity communications and storing a user's unique user code. The NAT's contactless proximity embodiments can comprise any of the following: radio frequency identification; infrared beams, audible signals; and the like. The NAT may be conjoined with another conveniently portable device, such as a wireless phone, a personal digital assistant, or a wristwatch.

NETWORK CREDENTIAL: Both the user and the account issuer are identified by the RMN to create the network credential. The credential includes the individual's identification as well as the context of the connection (i.e., the TCP/IP source and destination ports). RMN creates a network credential using the individual's account id, the time of day, and the bank code. The RMN signs this credential using Public Key Encryption and the RMN's Private Key.

ON-LINE FINANCIAL TRANSACTION: means an electronic financial transaction wherein a User Interface Apparatus communicates with a remotely located rule-module nexus via a telecommunications network, wherein said telecommunications network comprising any of the following: a cable TV network, a wireless telephone network, a land-line telephone network, the Internet, an intranet, a LAN, a WAN, or an X.25 network.

PFP (Prior Fraud Platform): A platform for UUCP records which have had prior fraud associated with them. Every new User's UUCs and biometrics are checked against all PFP records with the intent of reducing recidivism.

PGL: Personal Verification Code—Group List

PVC (Personal Verification Code): a method for protecting access to an individual's account through secret knowledge, formed from either numbers, symbols, or alphabetic characters.

POS (Point-Of-Sale): A physical place where goods or services are sold.

PPU (Phone Point-of-Sale UIA): Transaction terminal combining phone number with merchant price and product information to authorize a transaction over a UIA-equipped telephone. Order/authorization/mailing-address/PO forwarded to merchant. Resulting authorization is displayed on phone LCD, or “spoken”, along with the individual's private code.

RAM: Random Access Memory

RF (Radio Frequency): Generally refers to radio frequency energy emitted during the normal operation of electrical devices.

REGISTERS: Memory reserved for a specific purpose, data set aside on chips and stored operands to instructions

REQUESTS: Electronic instructions from the UIA to RMN instructing the RMN to verify the individual and thereby process the individual's command in the event the identification or verification is successful.

RM (Rule-Modules): Comprising software associations between Pattern Data and Execution Commands.

RMN (Rule-Module Nexus): A subset or master Rule-Module Nexus is a platform which connects or links to a plurality of account issuers and their associated networks, and communicates with a transaction terminal and a User Interface Apparatus. The RMN supports a UUC-PVC verification platform, and invokes Rule-Modules to access and process financial transactions. During an on-line financial transaction, the Rule-Module Nexus is preferably remotely located from the user, the NAT, and the UIA.

RMN-RC (Rule-Module Nexus Routing Code): Comprising data stored on an NAT, said data comprising instructions for routing a financial transaction to the Rule-Module Nexus for processing.

RMP (Remote Merchant Platform): Comprises all merchant identification codes for merchant telephone and Cable TV order shops; indexed by merchant ID. Comprises per-merchant encryption codes as well.

SNP (Sequence Number Platform): A software platform in the RMN that handles the DUKPT sequence number processing for inbound request packets. Sequence number processing protects against replay attacks.

SUBSET PLATFORM (or Local Computer): Both defined the same, as computing hardware and software storing a set of related data which represents only a portion of all data stored in the Master Computer or Master Platform.

TRANSACTION TERMINAL (or TERMINAL): A transaction device preferably conjoined with a UIA, communicating with a UIA, making data available for the RMN; gathers encrypted UUCs and PVCs from UIAs to form request messages that are subsequently sent to the RMN for authorization and execution. Transaction Terminals preferably append ancillary information to request messages, such as financial data and purchasing data, verifying counterparties and the like. In the embodiment where the User Interface Apparatus and Transaction Terminal are conjoined without being fully integrated, the two devices each remain operationally and functionally separate from each other, but can communicate to exchange data. In the embodiment where the UIA and the Transaction Terminal are fully integrated, the two devices are operationally and functionally united as one device.

TITLE INDEX CODE: Alpha-numeric sequence uniquely verifying an individual's authorized role or capacity within the context of his employment

TRACKING CODE: An alpha-numeric sequence assigned to data stored in or transmitted by the RMN, such that said sequence may be used to recall the data or obtain a report on the status of the transmission of the data.

UAP (UIA Authorization Platform): Comprises the list of parties, whether users, individuals or account issuers, authorized to use modify and issue UIA devices.

UAR (User Account Registry): a platform comprising financial accounts of a user, which is preferably not identified by any specific or primary on-line financial account of a user.

UAR-CODE (User Account Registry Code): Identifies a User Account Registry comprising a plurality of proprietary financial accounts of a user. Preferably said User Account Registry Code does not identify a specific on-line financial account of the user or require designating a specific primary on-line financial account of a user.

UIA (User Interface Apparatus): A device which, during an on-line financial transaction, gathers UUC and PVC data directly from user, encoding, encrypting, communicating said UUC and PVC data to a Transaction Terminal, making data available for the RMN. Comes in various hardware models and software embodiments, including those comprising a reader or reader/writer for interrogating, or reading, the UUC stored on a contactless proximity NAT when the NAT is in a prescribed short-range to the UIA. The UIA is preferably conjoined with a Transaction Terminal, wherein conjoined may optionally include being fully integrated with a Transaction Terminal. In the embodiment where the User Interface Apparatus and Transaction Terminal are conjoined without being fully integrated, the two devices each remain operationally and functionally separate from each other, but can communicate to exchange data. In the embodiment where the UIA and the Transaction Terminal are fully integrated, the two devices are operationally and functionally united as one device.

UIA-SP: User Interface Apparatus-Subset Platform

UIA-VC (User Interface Apparatus hardware Verification Code): a unique code which is assigned to a UIA unit, which is appended to a financial transaction and transmitted to the Rule-Module Nexus in order to verify the authenticity of the UIA to the Rule-Module Nexus.

UOP (User Interface Apparatus Owner Platform): A platform comprising the geographic and contact information on the owner of each UIA.

UPP (UUC-PVC Platform): a software platform in the RMN maintains a registry of which UUCs are assigned to which PVC's, including a registry of algorithmically dissimilar UUCs linked to the same PVC.

UST: User Support Terminal

UUC (A unique user code): Stored in the nexus access token, which is distinct for each user of the RMN or Third-Party Platforms, and which preferably comprises no data directly identifying or directly accessing any specific on-line financial account of a user.

UUC-ID (A unique user code identification): An identifier used by the RMN to uniquely verify an individual's UUC record (IRID—Individual Record ID), which preferably comprises no data directly identifying or directly accessing any specific on-line financial account of a user.

UUCP (Unique User Code Platform): A platform for unique user codes. Queries against the UUCP are used to verify authority for financial transactions.

VAP (or VAD): Valid Apparatus Platform (or Valid Apparatus Database): A platform in which each UIA (with associated unique encryption codes) is identified, along with the owner of the UIA.

VAC (Verification Approval Code): Output by the Verification Platform upon a Positive Matching Determination, comprising a UAR-Code to identify a user's User Account Registry while preferably not directly identifying or directly accessing any specific financial account of the user.

### DETAILED DESCRIPTION OF THE INVENTION

It should be noted that as used herein, the article “a” means “one or more” of anything to which it refers, such as a platform, component, feature, element, process, step, method, system or the like of the invention. For example, “a platform” means “one or more platforms”. It should also be noted that as used herein, the term “plurality” means “two or more” of anything to which it refers. For example, “plurality of financial accounts” means “two or more financial accounts”. It should also be noted that the term “comprising” (or “comprises”) means “including, but not limited to” anything to which it refers, in any amount and/or in any order. For example, “financial accounts comprising: debt, credit, and stored value” means “financial accounts including, but not limited to: debit, credit, and stored value”. Other definitions and meanings shall be referred to in the glossary and elsewhere herein.

The method and system of the present invention may be described herein in terms of functional block components, flow charts, screen shots, optional selections and various processing steps. It should be appreciated that such functional blocks may be realized by any number of hardware and/or software components configured to perform the specified functions. For example, the present invention may employ various platforms comprising software and hardware components (e.g., memory elements, processing elements, logic elements, look-up tables, and the like), which may carry out a variety of functions under the control of one or more microprocessors or other control devices. Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Similarly, the platforms of the present invention may be implemented with any programming or scripting language such as C, C++, Java, COBOL, assembler, PERL, or the like, with the various algorithms being implemented with any combination of data structures, objects, processes, routines or other programming elements. Further, it should be noted that the platforms of present invention may employ any number of conventional techniques for data transmission, signaling, data processing, network control, and the like. For a basic introduction of cryptography, please review a text written by Bruce Schneier which is entitled “Applied Cryptography: Protocols, Algorithms, And Source Code In C,” published by John Wiley & Sons (second edition, 1995), which is hereby incorporated by reference. Protocols, as known in the art, are computing languages or computing instructions.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

It should be appreciated that the particular implementations shown and described herein are illustrative of the invention and its best mode and are not intended to otherwise limit the scope of the present invention in any way. Indeed, for the sake of brevity, conventional data networking, application development, methods of populating data onto platforms, including databases and other functional aspects of the methods and systems herein (and components of the individual operating components of the systems) may not necessarily be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

It should be appreciated that the particular implementations shown and described herein are illustrative of the invention and its best mode and are not intended to otherwise limit the scope of the present invention in any way. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system. It should further be noted that the order of the steps denoted in the attached drawings are not intended as limitations and the steps may be accomplished in other orders without deviating from the scope of the present invention. Still further, the actors denoted as performing individual steps in the disclosed process should not be interpreted as limiting in any way as one with ordinary skill in the art appreciates that the steps may be performed by actors different from those disclosed herein without deviating from the spirit and scope of the present invention.

In the following detailed description of a preferred embodiments, reference may be made to the accompanying drawings, which form a part hereof, and within which are shown by way of illustration specific embodiments by which the invention may be practiced. It is to be understood that other embodiments may be utilized and structural changes may be made without departing from the scope of the invention.

It will be appreciated that the methods, systems, and their comprising elements of this invention, may be practiced in any order, in any timeframe with respect to other steps, other systems and their comprising elements. It will further be appreciated that the invention illustratively disclosed herein suitably may be practiced in the absence of any element which is not specifically disclosed or required herein.

It will be appreciated, that many applications and embodiments of the present invention could be formulated. One skilled in the art will appreciate that a network may include any system for exchanging data or transacting business, such as the Internet, an intranet, an extranet, WAN, LAN, satellite or wireless communications, and/or the like. Moreover, although the invention and its platforms use protocols such as TCP/IP to facilitate network communications, it will be readily understood that the invention could also be implemented using IPX, Appletalk, IP-6, NetBIOS, OSI or any number of existing or future protocols. Moreover, the method and the system contemplate the use, sale, exchange, transfer, or any other distribution of any goods, services or information over any network having similar functionality described herein.

Further still, the terms “Internet” or “network” may refer to the Internet, any replacement, competitor or successor to the Internet, or any public or private network, intranet or extranet that is based upon open or proprietary protocols. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); LOSHIN, TCP/IP CLEARLY EXPLAINED (1997). All of these texts are hereby incorporated by reference.

Communication between the parties (e.g., an Account Issuer, a User, merchant, and/or third-party computer) and the rule-module nexus of the present invention may be accomplished through any suitable communication means, such as, for example, a telephone network, intranet, Internet, point-of-interaction device (point-of-sale device, personal digital assistant, cellular phone, kiosk, etc.), online communications, offline communications, wireless communications, and/or the like. One skilled in the art will also appreciate that, for security reasons, any databases, systems, or components of the present invention may consist of any combination of databases or components at a single location or at a plurality of locations, wherein each database or system includes any of various suitable security features, such as firewalls, access codes, encryption, decryption, compression, decompression, and/or the like.

Referencing the computer networked aspect of a preferred embodiment of this invention, each party is equipped with a computing system to facilitate online commerce transactions. The computing units may be connected with each other via a data communication network. The network is a public network and assumed to be insecure and open to eavesdroppers. In exemplary embodiment, the network is embodied as the Internet. In this context, the computers may or may not be connected to the Internet at all times. For instance, the computer may employ a modem to occasionally connect to the Internet, whereas the rule-module nexus might maintain a permanent connection to the Internet. It is noted that the network may be implemented as other types of networks, such as an interactive television (ITV) network.

The merchant computer and the transaction Account Issuer or provider computing systems may be interconnected via a second network, referred to as a payment network. The payment network represents existing proprietary networks that presently accommodate transactions for credit, debit, loyalty/rewards, and other types of financial/banking transactions. The payment network is a closed network that is assumed to be secure from eavesdroppers. Examples of the payment network include the American Express™, VisaNet™ and the Verifone™ network.

The User may interact via the rule-module nexus with a transaction system or a merchant using any transaction terminal such as a telephone, keyboard, mouse, kiosk, personal digital assistant, touch screen, voice recognition device, transponder, biometrics device, handheld computer (e.g., Palm Pilot™), cellular phone, web TV, web phone, blue tooth/beaming device and/or the like. Similarly, the invention could be used in conjunction with any type of personal computer, network, computer, workstation, minicomputer, mainframe, or the like, running any operating system such as any version of Windows, Windows NT, Windows2000, Windows 98, Windows 95, MacOS, OS/2, BeOS, Linux, UNIX, MVS, OS, or the like.

As will be appreciated by one of ordinary skill in the art, the present invention may be embodied as a method, a data processing system, a platform for data processing, and/or a computer program product, wherein the steps and/or processes may be performed in a variety of sequences and/or orders, without restricting the scope of this invention. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, flash card memory and/or the like.

The transaction Account Issuer (AI) (or Account Provider) platform 28 includes any provider of products and/or services that facilitates any type of transaction. As contemplated by an exemplary embodiment of the present invention, the Account Issuer platform 28 establishes and maintains account and/or transaction information for the User. The Account Issuer platform 28 may issue products to the User and may also provide both the User and the Merchant platform 28 with the processes to facilitate the transaction system of the present invention. The Account Issuer platform 28 includes banks, credit unions, credit, debit or other transaction-related companies, telephone companies, or any other type of card or account issuing entities, such as card-sponsoring companies, incentive rewards companies, or third-party providers under contract with financial entities. Unless otherwise specifically set forth herein, although referred to as “Account Issuer,” this term should be understood to mean any entity issuing any type of account to facilitate any transaction, exchange or service, and should not be limited to companies possessing or issuing physical cards. In an exemplary system, the Account Issuer platform 28 may be any transaction facilitating company such as a credit account providers like American Express™, VISA™, Mastercard™, Discover™, and the like. In another embodiment, the Account Issuer platform 28 could be any membership organization or union. In some instances, the Account Issuer platform 28 and the Merchant platform 28 may be the same, for example, where the credit account is issued by the same entity that provides the product or service. A phone card using a credit account issued by a telephone company, where the credit account is associated to the User's home telephone account is one such occasion.

Although the present system for facilitating transactions may exist within one transaction Account Issuer system, exemplary embodiments contemplate use with other third-party authorization and settlement systems and networks.

The authorization and settlement processes may occur as separate steps or as a single step. In one embodiment, referred to herein as an electronic data capture (EDC) system, the Merchant platform 28 sends an authorization request to an Account Issuer platform 28 and if the authorization request is approved, a receipt of charges is created and submitted for the Merchant platform 28. Separate sequences of file transmissions or messages are therefore not required. Various embodiments, hybrids, and modifications of these processes should be apparent to one skilled in this art.

It will be appreciated that the invention illustratively disclosed herein suitably may be practiced in the absence of any element which is not specifically disclosed herein, particularly in a preferred embodiment.

The invention is an on-line financial transaction system which uniquely enables a User to present a single “thin-client” token and benefit from centralized financial account access, financial account aggregation and financial account presentation by means of a secure, remotely located Rule-Module Nexus 14.

A financial transaction is any electronic transfer or exchange of financial data having a predetermined monetary or monetary-equivalent unit value which is legal tender or a legal tender-equivalent, and which is honored by an Account Issuer, such that a User's purchase, expenditure or usage of these units results in the User's purchase or sale of goods, services or currency involving an Account Issuer. Financial data can also include units of currency, minutes of telephone calling time, miles towards earning a free airplane flight, points towards a gallon of gas, and the like.

A “financial account number” or “transaction number” as used herein, may include any identifier for a financial account (e.g., credit, charge debit, checking, savings, reward, loyalty, travel or the like) which may be maintained by a transaction Account Issuer (e.g., payment authorization center) and which may be used to complete a financial transaction. A typical account number (e.g., account data) may be correlated to a credit or debit account, loyalty account, travel or rewards account maintained and serviced by such entities as American Express, Visa and/or MasterCard, such as reward points as currency wherein a User can use reward or scrip points (e.g., Star Alliance™, eScrip™) as currency to pay for purchases). For ease in understanding, the present invention may be described with respect to a credit card account. However, it should be noted that the invention may not be so limited and other accounts permitting an exchange of goods and services for an account data value may be contemplated to be within the scope of the present invention.

An Account Issuer as defined herein is the named entity with primary fiduciary duty for administering a financial account of a User, said fiduciary duty comprising: managing the financial data within the financial account, and; reconciling the financial data within the financial account upon settlement of an on-line financial transaction. An Account Issuer comprises any of the following: a bank, a merchant, a scrips provider, credit account organization, a government agency, an insurance company, a brokerage firm, a reward incentives provider, a services barter provider, a product barter provider, an internet payment provider, and the rule-module nexus of this invention. A financial account, storing related financial data, resides with an Account Issuer if said Account Issuer has the primary responsibility to store, administer and reconcile the financial data within the User's financial account.

The Account Issuer may be within the RMN 14 or may be within a RMN-authorized Third-Party Platform 28.

Preferably, once the User makes an account selection from a plurality of proprietary accounts presented, the RMN 14 does not universally “stand-in” for Account Issuers, nor automatically invoke a default program or Global Execution Command (GEC) 55, to cause financial transactions of all RMN 14 Users to bypass, supersede, divert or switch an already-existing interchange fee, discount rate, or other settlement process which would otherwise apply to a financial account selected by the User, or which would otherwise apply to the selected financial account's associated Account Issuer (AI). Alternatively put, the RMN 14 is preferably designed wherever possible to compliment, not contravene, the already-existing interchange fee, discount rate, or settlement process of the User's selected financial account and its associated Account Issuer(s). Preferably, the RMN 14 maintains, wherever possible, a financial account's already-associated transaction processors (issuing banks, credit associations, national automated clearinghouse association (“NACHA®”), merchant banks), their respective proprietary networks (VisaNet®, Pulse®, Nova®, Interlink® and the like), and their respective processing fees (interchange fees, discount rates), protocols, and procedures. Similarly, in a preferred embodiment, the RMN 14 does not act to “stand-in” or “mirror” the transaction processing of an Account Issuer (AI) which has a pre-existing association with a financial account selected by a User.

Preferably, it is an objective of the present invention to compliment, not contravene, the already-existing interchange fee, discount rate, or settlement process of the User's selected financial account and its associated Account Issuer(s). Alternatively put, the invention herein is preferably designed not to universally “stand-in” for an existing Account Issuer, nor to cause all financial transactions of the invention herein to bypass, divert or switch an already-existing interchange fee, discount rate, or settlement process which would otherwise be applied by the Account Issuer(s) of the User's selected financial account and its associated transaction processing.

It is will be appreciated that a preferred embodiment of this invention maximizes security of the Rule-Module Nexus (RMN) 14 transactions and minimize the size and cost of the nexus access token, by employing a “thin-client”, passive RFID-based Nexus Access Token (NAT) 62. As used herein, “thin-client” means that, during processing of an on-line financial transaction, the NAT 62 does not require use of any stored data on a User's Nexus Access Token 62 which may directly identify or directly access an on-line financial account of the User.

Further, as a passive RFID-based token, the “thin-client” NAT preferably does not require a battery power supply, nor does it require an integrated circuit chip. In one embodiment, a purely passive or “reflective” NAT 62 may rely upon the electromagnetic energy radiated by a UTA 16 reader to power the RF integrated circuit that makes up the RFID tag within the NAT 62. As such, in this embodiment, the NAT 62 may be said to be “beam powered”. This “thin-client” NAT may be low-cost, high-security, and miniaturized for conjoining with other conveniently portable tokens, such as a wearable finger ring or a house key. For high security, it is preferred that stored data on a User's NAT 62 comprises a User's Unique User Code (UUC) 200, which may also comprise a RMN-Routing Code (RMN-RC) 61. In one embodiment, the NAT 62 does not store the User's User Account Registry Code (UAR-Code) 59. The UAR-Code 59 identifies a User Account Registry 15 of the RMN 14 which comprises the Financial Accounts 65 of a User, even though preferably said UAR-Code 59 does not itself directly identify any specific financial account of the User, nor preferably does the UAR-Code 59 depend upon the designation of any financial account of the User as a primary account. In this embodiment, preferably no stored data on the NAT 62 can be read or copied off-line which could provide direct access to a specific financial account of the User. As such, if a User's NAT 62 is stolen, lost or copied, the NAT 62 and its stored data would not provide an unauthorized User with direct access to a financial account of an authorized User of the RMN 14. In an exemplary embodiment, there are a plurality of different UAR-Codes 59, each identifying a User Account Issuer (UAR) 15 of the User, comprising: a UAR 15 within the RMN 14; a UAR 15 within a Third-Party Platform 28; a Subset UAR 19 within a Subset RMN 17; and the like.

Therefore, a preferred NAT 62 in this embodiment contrasts with a standard “fat-client” token requiring stored data which directly identifies, or enables direct access to, a specific financial account of a User. For example, a standard “fat-client” magnetic stripe card stores a credit card number in a sixteen-digit format as four spaced sets of numbers, represented by a number like “1234 5678 9101 1213”. The first five to seven digits are reserved for processing purposes and identify the issuing bank, card type, etc. In this example, the last (sixteenth) digit is used as a sum check for the sixteen-digit number. The intermediary eight-to-ten digits are used to uniquely identify the consumer. A merchant account number may be, for example, any number or alpha-numeric characters that identifies a particular merchant for purposes of card acceptance, account reconciliation, reporting, or the like.

The invention provides a Rule-Module Nexus (RMN) 14 method and system for a financial User to authorize a financial transaction using Financial Accounts 65 either at the merchant point of sale or over the Internet. A Rule-Module Nexus 14 and a Verification Platform 12 are used to accomplish these goals.

A Unique User Code (UUC) 200 is defined as any data string, unique to a User, which is stored into a User's Nexus access token (NAT) 62, and comprises any of the following: a dynamic code which changes periodically based on predetermined criteria synchronized with the verification platform, and; a static code which remains constant based on a predetermined code synchronized with the verification platform. One such UUC is registered for the User with the Rule-Module Nexus 14.

A Personal Verification Code (PVC) 202, distinct from the Unique User Code 200, comprises any alpha-numeric sequence or data string, not necessarily unique to a User, which is input by the User during a financial transaction. At least one such PVC 202 is registered for the User with the Rule-Module Nexus 14.

A Rule-Module 50 is defined as any Pattern Data 54 associated with an Execution Command 52. At least one such Rule-Module 50 is registered for the User with the Rule-Module Nexus 14.

The components of the computer system of this invention comprises any of the following:

Nexus access token (NAT);

User Interface Apparatus (UTA);

Communication lines for a Network;

Rule-Module Nexus (RMN);

These components together allow a financial transaction to occur without requiring the User to use a plurality of financial cards, paper coupons, credit cards, debit cards, or other physical objects.

### Nexus Access Token (NAT)

Preferably, the NAT 62 is a portable transponder using passive contactless proximity technologies, wherein either: the NAT 62 reflects energy from the User Interface Apparatus 16, or; the NAT 62 absorbs and temporarily stores a very small amount of energy from the UIA 16 signal to generate its own quick response. In either case, in this preferred embodiment, the NAT 62 requires strong signals from the User Interface Apparatus 16, and the signal strength returned from the NAT 62 is constrained to very low levels by the limited energy.

It will also be appreciated that in the invention's preferred embodiment, the “thin-client” NAT 62 of the invention permits optimal miniaturization, preferably enabling the NAT 62 to be embedded in a User's most-conveniently portable token, such as a watch, a ring, a door key, a PDA, a bracelet, a cell phone, or the like. Preferably, the NAT 62 does not require a battery; rather, the power is supplied by the UIA 16 conjoined with a radio frequency identification (RFID) scanner having read/write capabilities. When a NAT 62 encounters radio waves from a UIA 16, a coiled antenna within the NAT 62 forms a magnetic field. The NAT 62 draws power from the magnetic field, energizing the circuits in the NAT 62, enabling the UIA 16 to read the stored data on the NAT 62. In this embodiment of the invention, the thin-client NAT 62 has several advantages, including: not requiring an embedded battery; sustaining its function for twenty years or more; reduced cost; miniaturization to smaller than a grain of rice.

### User Interface Apparatus (UIA)

The UIA 16 is a device that gathers or comprises verification information for use in authorizing financial transactions. Each UIA 16 conducts one or more of the following operations:

Gathers UUC input from scanning a NAT of a User;

Gathers a PVC code from a User via a keypad, touch screen, or audio microphone;

Secure communications between UIA and its conjoined Transaction Terminal, preferably using encryption;

Secure storage of secret encryption keys;

Store and retrieve a unique Account Issuer UIA-VC;

Secure enclosure & components from unauthorized tampering;

Display information, allow parties to approve or cancel a financial transaction;

Automated data scanning for dedicated contactless proximity communications from a NAT, using an RFID sensor or scanner, an infrared sensor, or an audio frequency sensor, and the like;

Store, verify, and retrieve an Account Issuer's digital verification code;

Allow parties to select, via a conjoined Transaction Terminal, from among choices of Account Issuer and a plurality of a User's Proprietary Financial Accounts.

Preferably, the UUC 200 input is gathered using a UUC 200 sensor or scanner, located within the UIA 16. UUC 200 sensor is a dedicated short range contactless communications sensor, however it is understood that other types of UUC 200 sensors for wireless tokens can be used, such as infrared and the like.

For gathering a PVC 202, the UIA 16 has PVC 202 input means comprising a keypad 70, touch screen or an audio microphone also located securely inside the UIA 16.

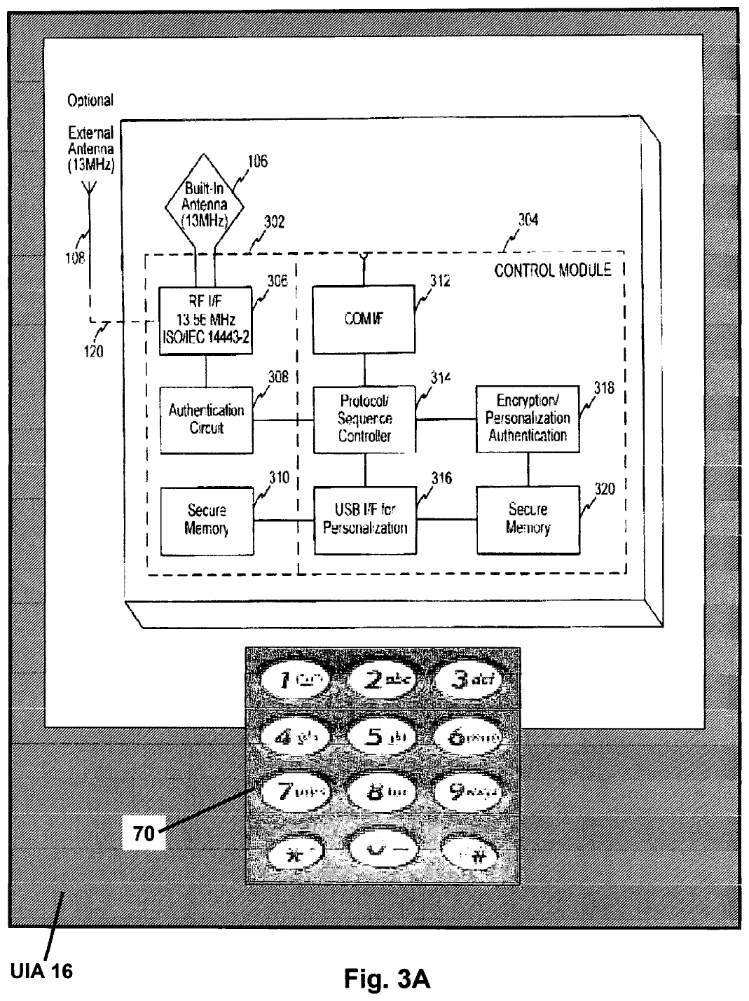

FIG. 3A illustrates an exemplary embodiment of a UIA 16 in accordance with the present invention, with exemplary components for use in gathering a User's bid verification data for an on-line financial transaction via the RMN 14. In general, the operation of UIA 16 may begin when NAT 62 may be presented for payment, and may be interrogated by UUC-scanner within the UIA 16. NAT 62 and UIA 16 may then engage in mutual authentication after which the NAT 62 may provide the UUC 200 and/or RMN-RC 61 to the UIA 16, which may further provide the information to the Transaction Terminal 2 conjoined with the UIA 16.

Although the present invention may be described with respect to a NAT 62, the invention may use a NAT 62 conjoined with a key ring, tag, fob, card, cell phone, hat, shirt, audio entertainment device, wristwatch, clothes (e.g., jackets, raincoats, shoes), or any such form capable of being presented for interrogation.

The UIA 16 may be configured to communicate using a RFID internal antenna 106. Alternatively, UIA 16 may include an external antenna 108 for communications with NAT 62, where the external antenna may be made remote to the UIA 16 using a suitable cable and/or data link 120. UIA 16-Transaction Terminal 2 (conjoined) may be in communication with the RMN 14 via a Network 18. The UIA 16 may be conjoined or wholly integrated with a Transaction Terminal 2, including a point-of-interaction device such as, for example, a merchant point-of-sale (POS) electronic cash register or a computer interface (e.g., User interface). In one exemplary embodiment the UIA 16 is conjoined with the Transaction Terminal 2 via a USB connector. As described more fully below, the UIA 16 may include the keypad 70 or touch screen for data-entry of a bid PVC 202 by the User.

In one embodiment, the UIA 16 may have a serial (RS232) and USB1.1 interface, wherein the device application programming interface (API) allows the RF field to be turned on/off and provide status and version information. The RFID command-set includes block read, block write and NAT 62 inventory (enumerate UUCs 200 of all NATs 62 in range) commands. The UIA 16 can issue addressed commands (affect only one NAT 62) and non-addressed commands (obeyed by all NATs 62 in range). C++ class libraries in the UIA 16 may also support digital signatures, based on strong encryption, to detect tampering with (and corruption of) data on the UIA 16.

Although the UIA 16 may be described herein with respect to being conjoined with a merchant point-of-sale (POS) Transaction Terminal 2, the invention may not be so limited. Indeed, a Transaction Terminal 2 may be used herein by way of example, and the point-of-interaction device may be any device capable of being conjoined with a UIA 16. The UIA 16 conjoined with the Transaction Terminal 2 may also be provided with additional or ancillary transaction data to append to the encrypted packet for transmittal to the RMN 14. Said additional transaction data may include the cost of goods, type of goods, UIA-VC 204, and the like. In addition, UIA 16 conjoined with the Transaction Terminal 2 may be in communication with a RSP 130, an Account Issuer host or proprietary Network 18, and/or any other access point for processing any Transaction Request 251. In this arrangement, information may be provided via the UIA 16-Transaction Terminal 2 to the RMN 14 using Network 18.

FIG. 3A also illustrates a block diagram of an exemplary embodiment of a UIA 16 in accordance with the present invention. UIA 16 includes, for example, an antenna 106, 108 coupled to a RF module 302, which may be further coupled to a control module 304. In addition, UIA 16 may include an antenna 108 positioned remotely from the UIA 16 and coupled to UIA 16 via a suitable cable 120, or other wire or wireless connection.

RF module 302 and antenna 106, 108 may be suitably configured to facilitate communication with NAT 62. Where NAT 62 may be formatted to receive a signal at a particular RF frequency, RF module 302 may be configured to provide an interrogation signal at that same frequency. For example, in one exemplary embodiment, NAT 62 may be configured to respond to an interrogation signal of about 13.56 MHz. In this case, RFID antenna 106, 108 may be 13 MHz and may be configured to transmit an interrogation signal of about 13.56 MHz. That is, NAT 62 may be configured to include a first and second RF module (e.g., transponder) where the first module may operate using a 134 kHz frequency and the second RF module may operate using a 13.56 MHz frequency. The UIA 16 may include two receivers which may operate using the 134 kHz frequency, the 13.56 MHz frequency or both. When the UIA 16 may be operating at 134 kHz frequency, only operation with the 134 kHz module on the NAT 62 may be possible.

When the UIA 16 may be operating at the 13.56 MHz frequency, only operation with the 13.56 MHz module on the NAT 62 may be possible. Where the UIA 16 supports both a 134 kHz frequency and a 13.56 MHz RF module, the NAT 62 may receive both signals from the UIA 16. In this case, the NAT 62 may be configured to prioritize selection of the one or the other frequency and reject the remaining frequency. Alternatively, the UIA 16 may receive signals at both frequencies from the NAT 62 upon interrogation. In this case, the UIA 16 may be configured to prioritize selection of one or the other frequency and reject the remaining frequency.

Further, protocol/sequence controller 314 may include an optional feedback function for notifying the User via a Display 6 conjoined with the Transaction Terminal 2 of the status of a particular transaction. For example, the optional feedback may be in the form of a Display 6, such as an audio transmitter of audible signatures, an LED screen, an LCD screen and/or other visual display which may be configured to light up or display a static, scrolling, flashing and/or other message and/or signal to inform the User that the transaction may be initiated (e.g., NAT 62 may be being interrogated), the UUC 200-PVC 202 may be valid (e.g., User may be verified for accessing the RMN 14), transaction may be being processed (e.g., UUC 200 may be being read by UIA 16), and/or the transaction may be completed (e.g., transaction approved or disapproved/denied). Such an optional feedback may or may not be accompanied by an audible indicator (or may present the audible indicator singly) for informing the User of the transaction status. The audible feedback may be a simple tone, multiple tones, musical indicator, and/or voice indicator configured to signify when the NAT 62 may be being interrogated, the transaction status, or the like.

RFID antenna 106 may be in communication with a NAT 62 for transmitting an interrogation signal and receiving at least one of an authentication request signal and/or a UUC 200 from NAT 62. RFID communicator 306 may be configured to send and/or receive RF signals in a format compatible with antenna 106, 108 in similar manner as with respect to NAT 62 transponder. For example, where RFID communicator 306 may be 13.56 MHz RF rated antenna 106, 108 may be 13.56 MHz compatible. Similarly, where RFID communicator 306 may be ISO/IEC 14443 rated, antenna 106 may be ISO/IEC 14443 compatible.

RF module 302 may include, for example, RFID communicator 306 in communication with authentication circuitry 308 which may be in communication with a secure internal platform 310. In one embodiment, internal platform 310 may store data corresponding to the NAT 62 being authorized to transact business over the UIA 16. Internal platform 310 may additionally store UIA-VC 204 identifying information for providing to NAT 62 for use in authenticating whether UIA 16 may be authorized to be provided the UUC 200 data stored on NAT 62 to the Transaction Terminal 2.

As may be described more fully below, in one embodiment, NAT 62 and UIA 16 optionally engage in mutual authentication. In this context, “mutual authentication” may mean that operation of the UIA 16 may not take place until NAT 62 authenticates the signal from UIA 16, and UIA 16 authenticates the signal from NAT 62.

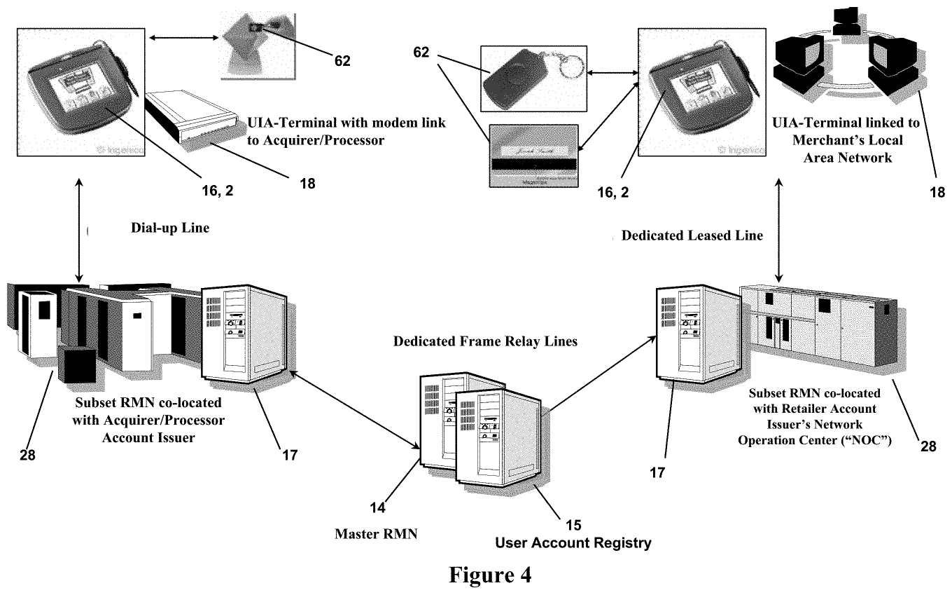

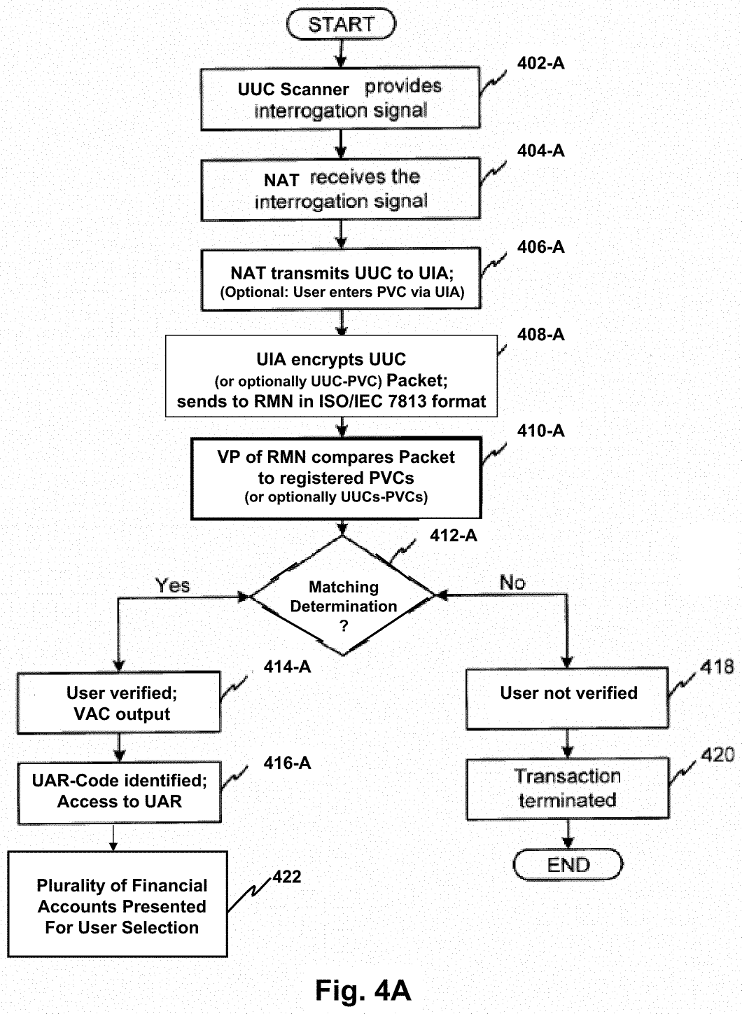

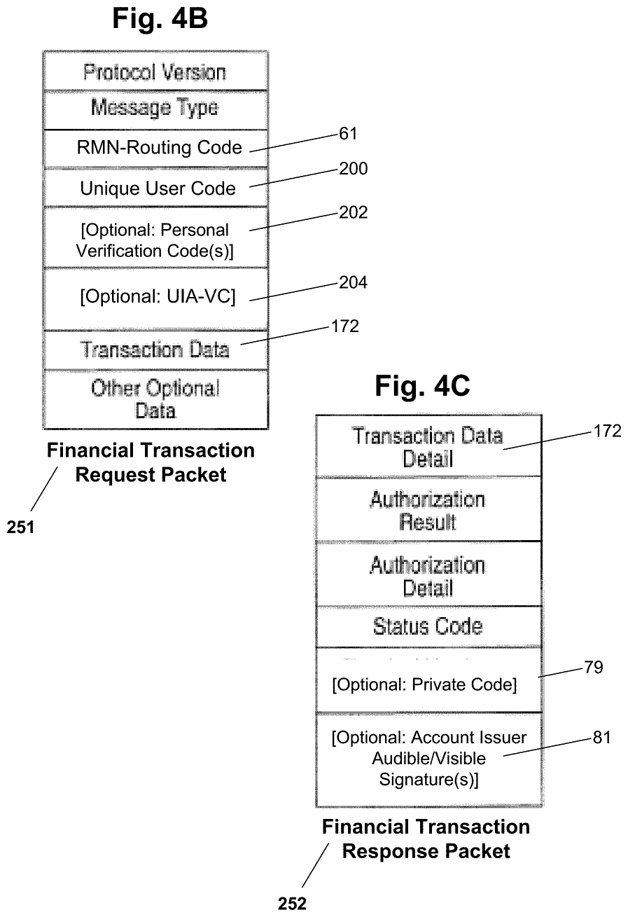

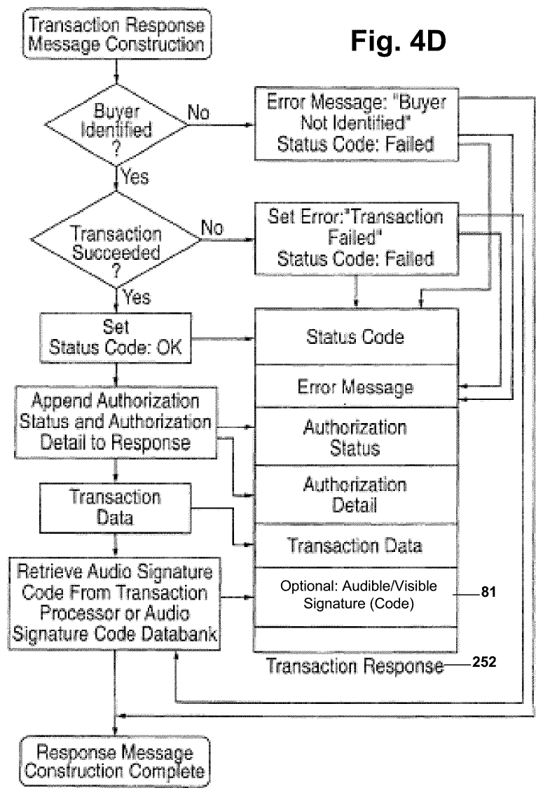

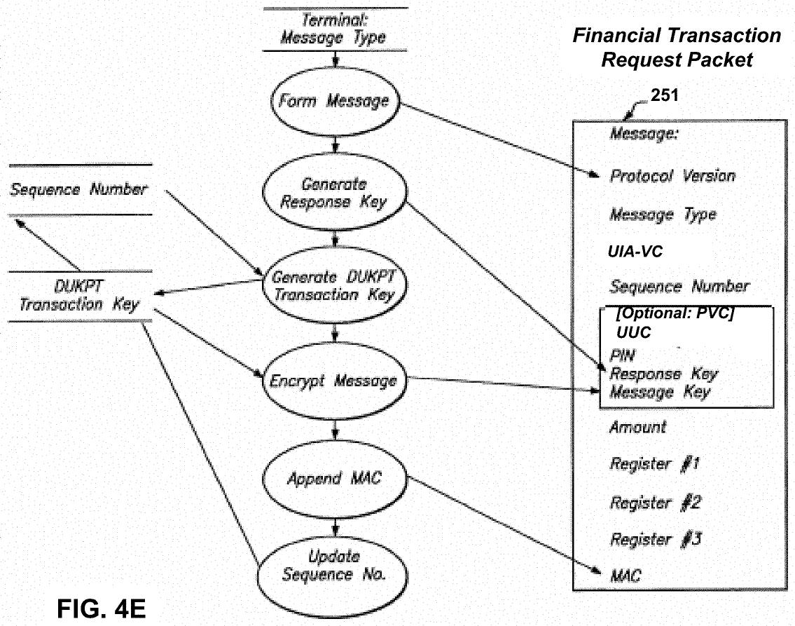

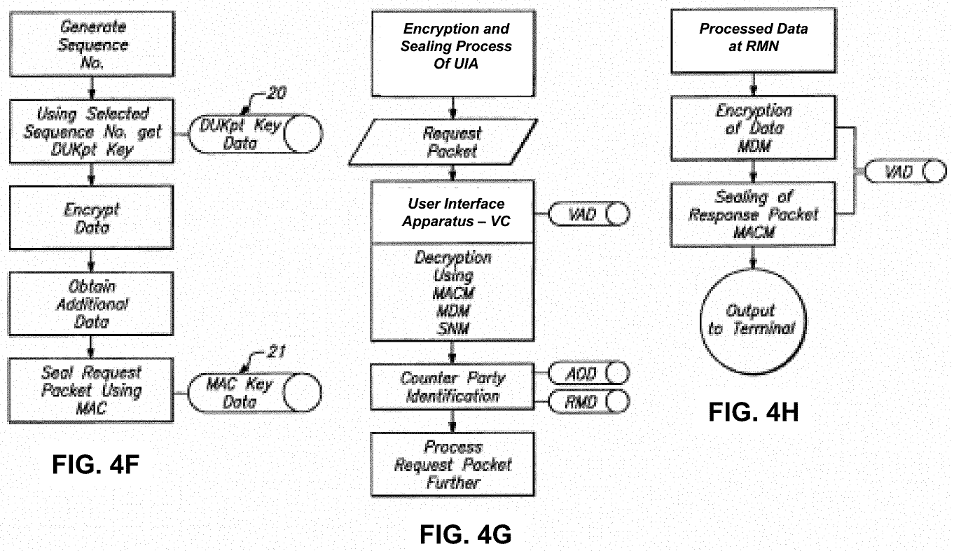

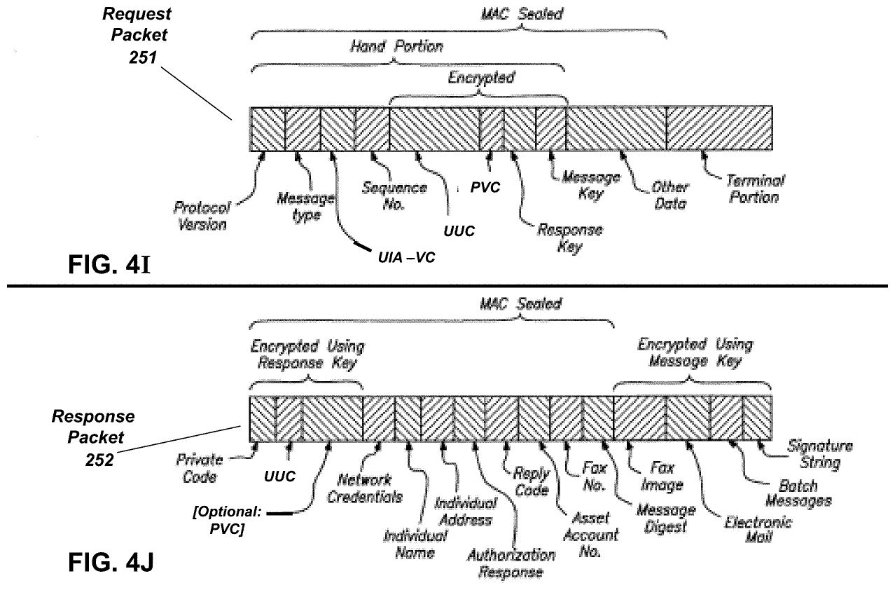

FIG. 4A is a flowchart of an exemplary authentication process in accordance with the present invention. The authentication process of this embodiment may be depicted as one-sided. That is, the flowchart depicts the process of the UIA 16 interrogating the NAT 62, although certain similar steps may be followed in an embodiment wherein the NAT 62 authenticates UIA 16.

As noted, in this embodiment, internal platform 310 may store security keys for encrypting or decrypting signals received from NAT 62. In an exemplary authentication process, the UIA 16 may provide an interrogation signal to NAT 62 (step 402). The interrogation signal may include a random code generated by the UIA 16 authentication circuit, which may be provided to the NAT 62 and which may be encrypted using a unique encryption key corresponding to the NAT 62. For example, the protocol/sequence controller 314 may provide a command to activate the authentication circuitry 308. Authentication circuitry 308 may provide from internal platform 310 an interrogation signal including a random number as a part of the authentication code generated for each authentication signal. The authentication code may be an alphanumeric code which may be recognizable (e.g., readable) by the UIA 16 and the NAT 62. The authentication code may be provided to the NAT 62 via the RFID-RF interface 306 and antenna 106 (or alternatively antenna 108).

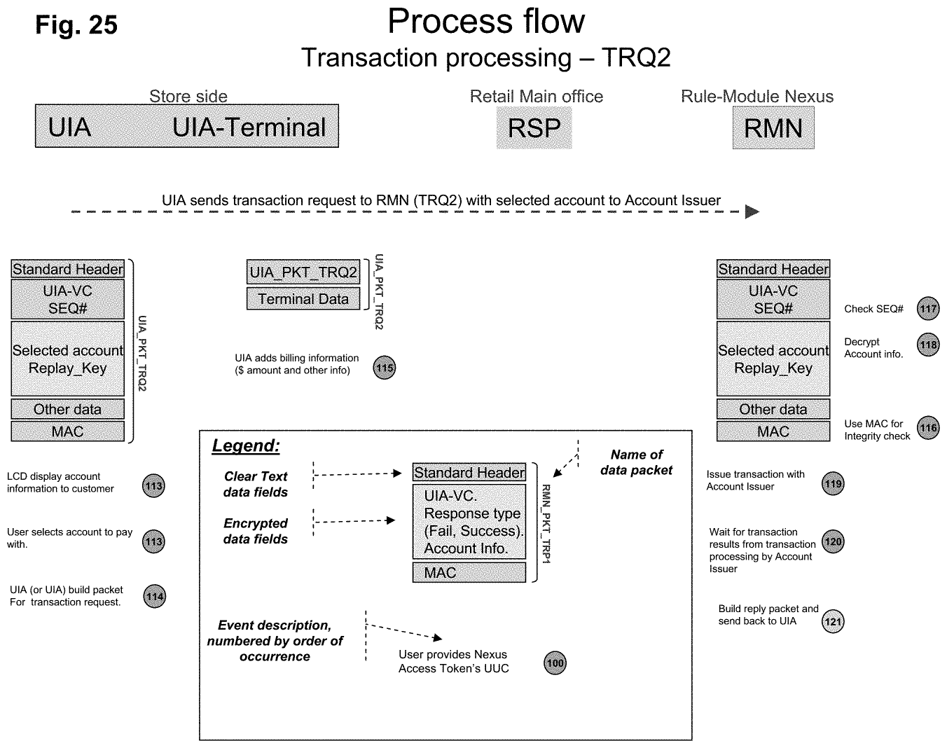

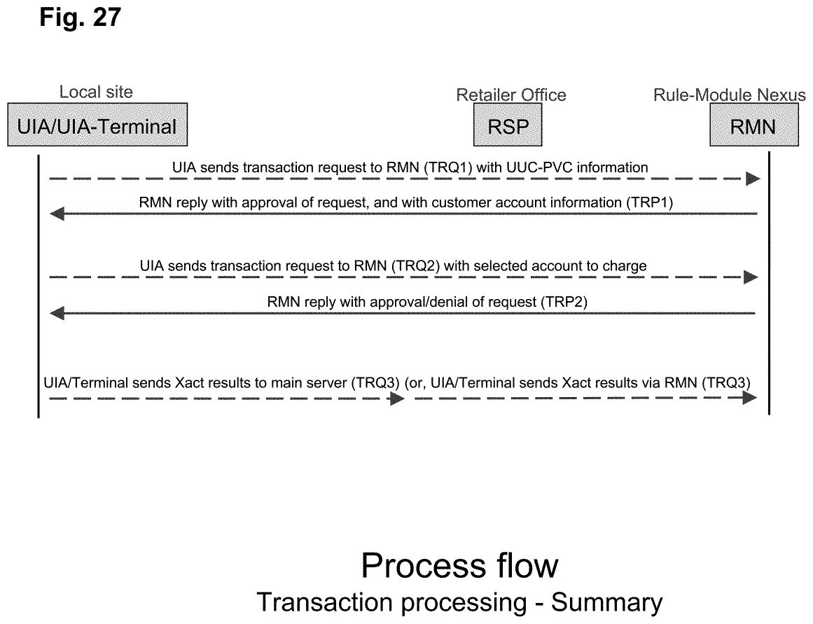

NAT 62 receives the interrogation signal (step 404), optionally including the authorization code. Once the NAT 62 is activated, the interrogation signal, optionally including the authorization code, may be provided to an modulator/demodulator circuit within the NAT 62, where the signal may be demodulated prior to providing the signal to protocol/sequence controller 314. Protocol/sequence controller 314 may recognize the interrogation signal as a request for authentication of the NAT 62, and provide the authentication code to authentication circuit 308. The NAT 62 may then encrypt the authentication code (step 406). In particular, encryption may be done by authentication circuit 308, which may receive the authentication code and encrypt the code prior to providing the encrypted authentication code to protocol/sequence controller 314. NAT 62 may then provide an encrypted UUC 200 via a response signal to the UIA 16 (step 406). That is, the encrypted UUC 200 may be provided by the NAT 62 to the UIA 16 via modulator/demodulator circuit, RF interface 306 and antenna 106, 108. Also, the User provides a PVC 202 via the UIA 16, optionally by data-entering using a keypad 70 (step 406), or by touch screen tapping, or by voice commands. The UIA 16 builds an encrypted packet with the UUC 200 and the PVC 202 and converts the packet into a format compatible with the ISO/IEC 7813 standard for transmitting to the VP 12 associated with, or conjoined within, the RMN 14 via a Network 18 (step 408). In one exemplary embodiment illustrated in FIG. 25 and FIG. 27, the UUC 200-PVC 202 packet may be forwarded in Track 1/Track 2 format from the UIA 16 conjoined with the Transaction Terminal 2.

The PVC 202 may be provided to the UIA 16 conjoined with the Transaction Terminal 2 using a conventional merchant (e.g., POS) key pad 70. For UIA 16 using a secondary PVC 202, such as a biometric, the UIA 16 also includes any biometric sensor or scanner known in the art which can electronically read or scan any of the following biometric samples: a fingerprint, an iris, a retina, a voice, a palm, a face.

VP 12 may then receive and decrypt the UUC 200-PVC 202 packet for electronically comparing with registered UUCs 200 and registered PVCs 202 (step 410). Once the VP 12 makes the electronic comparison using algorithmic methodologies known in the art, the VP 12 makes either a positive matching determination or a negative matching determination. If the matching determination is deemed to be failed and a negative matching determination is automatically output, wherein the User is not verified (step 418) and User is notified of termination of the financial transaction (step 420), which is deemed to be completed.

Alternatively, if the VP 12 makes a positive matching determination, outputting a VAC 206 (step 414), wherein a UAR-Code 59 is identified and a UAR 15 is accessed (step 416). The financial transaction proceeds with a plurality of proprietary Financial Accounts 65 of the User being accessed, wherein the Visible or Audible Signature(s) 81 are retrieved the RMN 14 and transmitted to the UIA 16-Transaction Terminal 2 for presentation to, and selection by, the User (step 422).

Encryption/decryption component 318 may be further in communication with a secure platform 320 which stores the security keys necessary for decrypting the encrypted UUC 200 scanned from the NAT 62. Upon appropriate request from protocol/sequence controller 314, encryption/decryption component (e.g., circuitry 318) may retrieve the appropriate security key, decrypt the UUC 200 and forward to protocol sequence controller 314 in any format readable to the Transaction Terminal 2. In one exemplary embodiment, the UUC 200 may be combined with the RMN-RC 61 and PVC 202 received from the keypad 70, wherein the packet is encrypted and converted into a format compatible with the ISO/IEC 7813 standard for transmitting the RMN 14 via Network 18. Further, wherein the UIA 16-Transaction Terminal 2 receives a response from the RMN 14 or an Account Issuer platform 28 via Network 18 (e.g., transaction authorized or denied), the protocol/sequence controller 314 may provide the response for visibly and/or audibly communicating the response to User via Display 6.

UIA 16 may additionally include a USB interface 316, in communication with the protocol/sequence controller 314 and the Transaction Terminal 2. In one embodiment, the USB interface may be a RS22 serial data interface. Alternatively, the UIA 16 may include a serial interface such as, for example, a RS232 interface in communication with the protocol/sequence controller 314 and the Transaction Terminal 2. The USB connector 316 may be in communication with a personalization system (not shown) for initializing UIA 16 to certain application parameters. That is, the UIA 16 may be in communication with personalization system for populating internal platform 310 with a listing of security keys belonging to authorized NATs 62, and for populating internal platform 320 with the security keys to decrypt UUCs 200 scanned from NATs 62, enabling conversion of the UUC 200 into ISO/IEC 7813 format. In this way, UIA 16 may also be populated with a unique identifier (e.g., UIA-VC 204) which may be used by NAT 62 to determine if UIA 16 may be authorized to receive a NAT 62 encrypted UUC 200.

The NAT 62 and the UIA 16 may then engage in mutual authentication. Where the mutual authentication may be unsuccessful, an error message may be provided to the User via Display 6 of the Transaction Terminal 2, and the transaction may be aborted. Where the mutual authentication may be successful, the UIA 16 may prompt the User via the Display 6 of the Transaction Terminal 2, to provide the UIA 16 with a bid PVC 202 via the data-entry keypad 70 or touch screen.

Preferably, the UIA 16 also has secure memory that can store and retrieve the unique secret encryption keys used to enable secure communications with the RMN 14 via the Transaction Terminal 2. In this embodiment, this is battery backed-up RAM that is set up to be erased whenever the tamper-detect circuitry reports that tampering has been detected.

To use encryption keys, a key management system must be employed to assure that both sender and receiver are using the same key. When using DES, a preferred key management system is DUKPT, which is well known in the industry. DUKPT is designed to provide a different DES key for each transaction, without leaving behind the trace of the initial secret key. The implications of this are that even successful capture and dissection of a UIA 16 will not reveal messages that have previously been sent, a very important goal when the effective lifetime of the information transmitted is years. DUKPT is fully specified in ANSI X9.24. The DUKPT key table is stored in the secure memory.

Each UIA 16 preferably has a hardware verification code (UIA-VC) 204, unique to each UIA 16, and this UIA-VC 204 that is registered with the RMN 14 at the time of manufacture or distribution to an authorized Account Issuer. This makes the UIA 16 uniquely identifiable to the RMN 14 in all financial transactions from that device. This UIA-VC 204 is preferably stored in write-once memory.

UIA 16 physical security is assured by standard mechanisms known in the art. Preferably, these comprise tamper-detect circuitry, an enclosure that cannot be easily opened without visibly injuring the enclosure, erasable memory for critical secrets such as encryption keys, write-once memory for hardware verification, tight integration of all components, and “potting” of exposed circuitry.

Information such as the amount of a transaction, the verification of a User, or other transaction-related information is displayed via the conjoined Transaction Terminal 2 using Display 6 with an integrated LCD screen. It is preferable that the Display 6 be connected securely to the other components in the UIA 16 to maintain security.

Approval or cancellation of a financial transaction is done using the UIA keypad 70 or touch screen.

Optionally, the UIA 16 also validates public key digital certificates. In one embodiment, public keys of a particular certifying authority are initially stored in the UIA 16 at the time of construction. This provides the mechanism to verify an Account Issuer's digital certificates that are signed by the certifying authority, or an Account Issuer's digital certificates that are signed by the certifying authority.

Although a preferred embodiment is described above, there are many different variations on specific UIA 16 implementations. Fundamentally any device that is secure, can verify a User, an Account Issuer or an Account Issuer with a high degree of certainty, and can connect to the Master RMN 14 via some form of communication line can serve as a UIA 16.

In some embodiments, specifically the home use and public use instances, the UIA-VC 204 is not used to verify either the UIA 16 or the Account Issuer.

### Registration

Parties that wish to either originate or receive financial transactions must first register with the Rule-Module Nexus 14, and its associated Verification Platform 12. The verification and financial information registered with the RMN 14 or RMN-authorized Third-Party Platform 28 for a given party depends on the mode used to originate or receive settlement. A User, usually an individual person, should preferably register at least one UUC 200 and a PVC 202, as well as a Rule-Module 50 with Pattern Data 54 such as a plurality of proprietary Financial Accounts 65, associated with at least one

Execution Command 52 that can govern the accessing, deposit, display, deducting, and disbursing of financial data using at least one financial account. The Financial Accounts 65 of a User are arranged within a User Account Registry 15, identified by a User Account Registry Code (UAR-Code) 59. Preferably, the UAR-Code 59 does not: identify a specific Financial Account 65 or specific Financial Account Number 65 of the User, nor; depend on a specific Financial Account 65 of the User being tagged as the “primary” account.

For the User, registering verification data and Financial Accounts 65 can occur via a Transaction Terminal 2 using a Network 18 connection to the RMN 14, wherein data magnetic stripe cards, paper checks, coupons, smart cards, and the like, are data-entered or electronically scanned. Registration may occur at a merchant's point-of-sale, over the Internet, or through a registration Transaction Terminal 2. Data-entry of registration verification data and Financial Account 65, along with associated data, can occur via: a keypad 70; voice commands spoken into an audio receiver or microphone; swiping the magnetic stripe card; reading a paper check with a magnetic ink character reader, and the like. The User's registration processes links any such data to the User's UUC 200 and PVC 202 verification data, including the User's Rule-Modules 50, within the RMN 14. The User is assigned and issued a NAT 62, stored with the UUC 200 for that User.

Further data which registered to the User may include: a driver's license number, a passport number, a debit account, a credit account, a checking account, a money-market account, a stored-value account comprising pre-paid financial, and the like. Optionally, a stored value account with a participating Account Issuer may be pre-credited with funds, or financial, from the Account Issuer and for the use of which the User has pre-paid a premium to the Account Issuer.

For verification data, the User registers by submitting, or being assigned, a registration PVC 202 obtained from the User, and the User being assigned a UUC 200 which is stored into a NAT 62 issued to the User. The UIA 16 confirms that the PVC 202 code is accurate, and in a preferable embodiment, scans the User's NAT 62 to determine that it and its stored UUC 200 are non-fraudulent. The UIA 16 then translates and compresses this UUC 200-PVC 202 encrypted packet into a format suitable for rapid electronic transmittal to the RMN 14. In one embodiment, the User selects and enters a PVC 202 into the UIA keypad 70 or touch screen.

Next, the person associates at least two proprietary Financial Accounts 65 with the registration UUC 200 and PVC 202 in the RMN 14 or RMN-authorized Third-Party Platform 28, such as an associated Verification Platform 12. Preferably, as described above, this is accomplished by automatically scanning a bar-code or a magnetic stripe through the data reader attached to the UIA 16. In one embodiment, this bar-code or magnetic stripe comprises not only the User's financial UUC 200, but also the verification of the Account Issuer or financial entity with which this account is associated.

Preferably, an attendant verifies that the User is the legally authorized signer on the Financial Account 65 by comparing personal, official photo identification such as a driver's license, passport, identification card, and like, to the name listed on the credit card, debit card, paper check and the like being used for registering the accounts.

The UTA 16 transmits the registration data to the RMN 14. Preferably, the Master RMN 14 then inserts the UUC 200-PVC 202 packet into the appropriate Verification Platform 12 and generates an User Verification Approval Code 206 that is unique to the User and is subsequently output by the Verification Platform 12 when issuing a positive matching determination from electronically comparing a User's bid UUC 200 and bid PVC 202 with registered UUCs 200 and registered PVCs 202. From this point on, any time the User is verified by the Verification Platform 12 via submitted a UUC 200-PVC 202 packet, the User Verification Approval Code 206 is forwarded to the Master Rule-Module Nexus 14 where it invokes at least one Rule-Module 50 for that User. In the Master Rule-Module Nexus 14 platform, a Rule-Module 50 is created that is identified by the User Verification Approval Code 206. In one embodiment, the Verification Approval Code 206 identifies a User Account Registry 15. In another embodiment, the Verification Approval Code 206 is identical the UAR-Code 65, but does not: identify a specific Financial Account 65 or a specific Financial Account Number 65.

Before a new UUC 200 (or UUC 200-PVC 202) record is enabled to originate or invoke a Rule-Module 50, the individual's submitted UUC 200 are checked against previously registered UUC 200 in the electronic Verification Platform 12 using the same UUC 200 comparison techniques as those used in the individual verification procedure. If a match is found for the newly submitted UUC 200 record, the UUC 200 record's status is set to “prior registration”. If the prior registration check was executed as part of a registration request, the Gateway Platform 26 forwards a “registering individual with prior registration” warning to the Prior Fraud Platform 27, indicating that the person has attempted to register with the RMN 14 or RMN-authorized Third-Party Platform 28 more than once.

In one embodiment, the Master RMN 14 validates the Account Transaction Data (or Transaction Data) 172 submitted during registration. This involves making certain that the Financial Account 65 being registered is a valid account and that the User is an authorized signer.

In a preferred embodiment wherein an Account Issuer Platform 28 receives electronic transfers of financial data and/or Account Transaction Data 172, the Account Issuer, usually a corporate entity, must also register data with the RMN 14, comprising: verification data unique to that Account Issuer, such as a digital certificate: their UIA-VC 204; processing preferences for a Financial Account 65 of the User. The processing preferences may include: invoking a proprietary network; invoking a discount rate; invoking an interchange fee; invoking a settlement protocol; invoking a surcharge; invoking a processing partner, and; invoking a time period for settlement.

Any Account Issuer may register also additional data that is unique to itself, comprising: an alpha-numeric verification code, an Audible or Visible Signature 81, a digital certificate, or a UIA-VC 204 to verify itself to the RMN 14. Digital certificates are available from certifying authorities, and they provide the assurance that the entity with the certificate is the authentic owner of that verifier. These certificates comprise readable text and other information that describes the entity. This can include an Account Issuer the address, as well as the company name.

This entity verification data is then linked to at least one User Financial Account 65 or an Account Issuer Account.

UTA-VC's 204 are unique numbers assigned to UIA 16 devices at the time of manufacture. A participating Account Issuer installing UIA 16 devices at the point of sale can register a User Interface Apparatus 16 with the RMN 14. Preferably, this causes any transaction, either registration or purchase, flowing through those registered User Interface Apparatus 16 to automatically verify to the RMN 14 the participating Account Issuer which owns the UIA-VC 204.

Preferably, the security surrounding the registration of any verifying and/or financial data, such as digital certificates, UIA-VCs 204, and Financial Accounts 65 numbers, is extremely strong, as this is a potential source for large losses over a short period of time.

### Network Communications

Communications via a Network 18 between the UIA 16 and a conjoined Transaction Terminal 2, and the Verification Platform 12 associated with the RMN 14 occur via many different communication methods. Most depend on the particular communication networks already deployed by the organization or merchant that deploys the transmission authorization system. Communication security over the Network 18 is provided by encryption using unique secret keys known only to that specific UIA 16 and the RMN 14, and the DES encryption algorithm, preferably triple-encrypted. Triple encryption means successive encrypt/decrypt/encrypt operations using two distinct 56-bit DES keys. This provides significantly higher security than a single encryption operation with one 56-bit DES key. Alternately, a public/private key system may also be used to encrypt information that passes between UIA 16 and RMN 14. Both DES and public key encryption is well known in the industry.

In an embodiment the User Interface Apparatus 16 are connected via Ethernet 18 to a Local or Subset router 18, which is itself connected to a network operations center (NOC) via frame relay lines. At least one Verification Platform 12 is located at the NOC. Messages are sent from UIA 16 to the Verification Platform 12 using TCP/IP over this network. In another embodiment, the User Interface Apparatus 16 are connected via a cellular digital packet data (CDPD) modem to a CDPD provider, who provides TCP/IP connectivity from the UIA 16 to an intranet 18 to which at least one Verification Platform 12 is attached.

In yet another embodiment, a UIA 16 is connected via the Internet, as is at least one Verification Platform 12. TCP/IP is used to transmit messages from UIA 16 to Verification Platform 12. There are many different ways to connect UIA 16 to Verification Platform 12, both tethered and wireless, that are well understood in the industry, including but not limited to: the Internet 18; an intranet 18; an extranet 18; a Local or Subset area network (“LAN”) 18; and a wide area network (“WAN”) 18.

### Rule-Module Nexus

Rule-Module Nexus (RMN) 14 serves to verify the Account Issuer and the User in a transaction, retrieve for verified parties a plurality of proprietary Financial Accounts 65, and optionally Account Transaction Data (or Transaction Data) 172, and perform the execution that will result in facilitating completing on-line financial transactions, including settlement of transactions. The Rule-Module Nexus 14 is comprised of an electronic Verification Platform 12, a Master Rule-Module Nexus 14, an internal Execution Platform 38, a Firewall 40, a Decryption Platform 22, a Gateway Platform 26, and a Logging Platform 42.

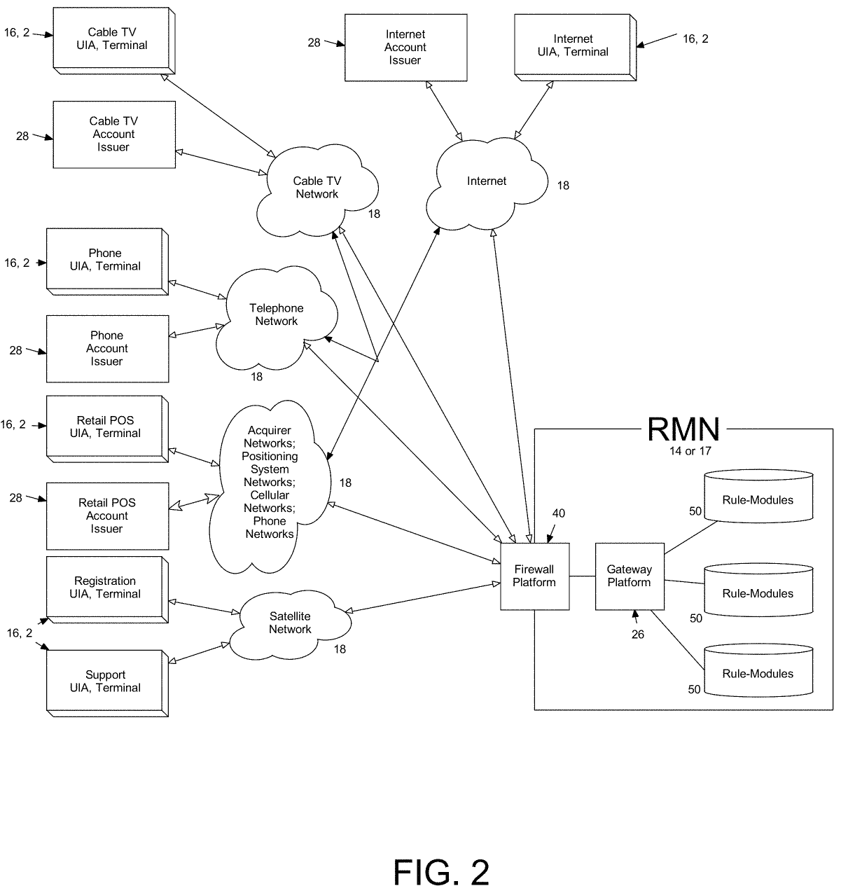

As seen in FIG. 2, the Master RMN 14 is connected to a network, like the Internet 18 or intranet 18, using a Firewall Machine (FW or FM) 40 that filters out all messages that are not from legitimate UIA 16 devices.

In a preferred embodiment, the messages are decrypted. For this, the transaction processor uses the Decryption Platform (DP) 22, which utilizes the UIA-VC 204 of the UIA 16 to verify the encryption codes that is required to decrypt the message from the UIA 16.

Once decrypted, the verification of parties to the transaction is determined using the electronic Verification Platform 12.

### Verification Platform

The electronic Verification Platform (VP) 12 serves to verify the User in an electronic financial transaction. The Verification Platform 12 compares a User's bid UUC 200 scanned from the User's NAT 62 and the User's bid PVC 202 provided to the UIA 16 with previously stored UUC 200-PVC 202 packets from registered Users, in order to verify the User. If a bid UUC 200-PVC 202 packet is successfully matched against a registered UUC 200-PVC 202 packet, and the Verification Platform makes User makes a positive matching determination, the User Verification Approval Code 206 which had been assigned to the User during initial registration is output and forwarded to the Master Rule-Module Nexus 14. The User Verification Approval Code transmitted by the Verification Platform 12 is used by the Master Rule-Module Nexus 14 to locate the Rule-Modules 50 that are customized to that User, including the User Account Registry 15

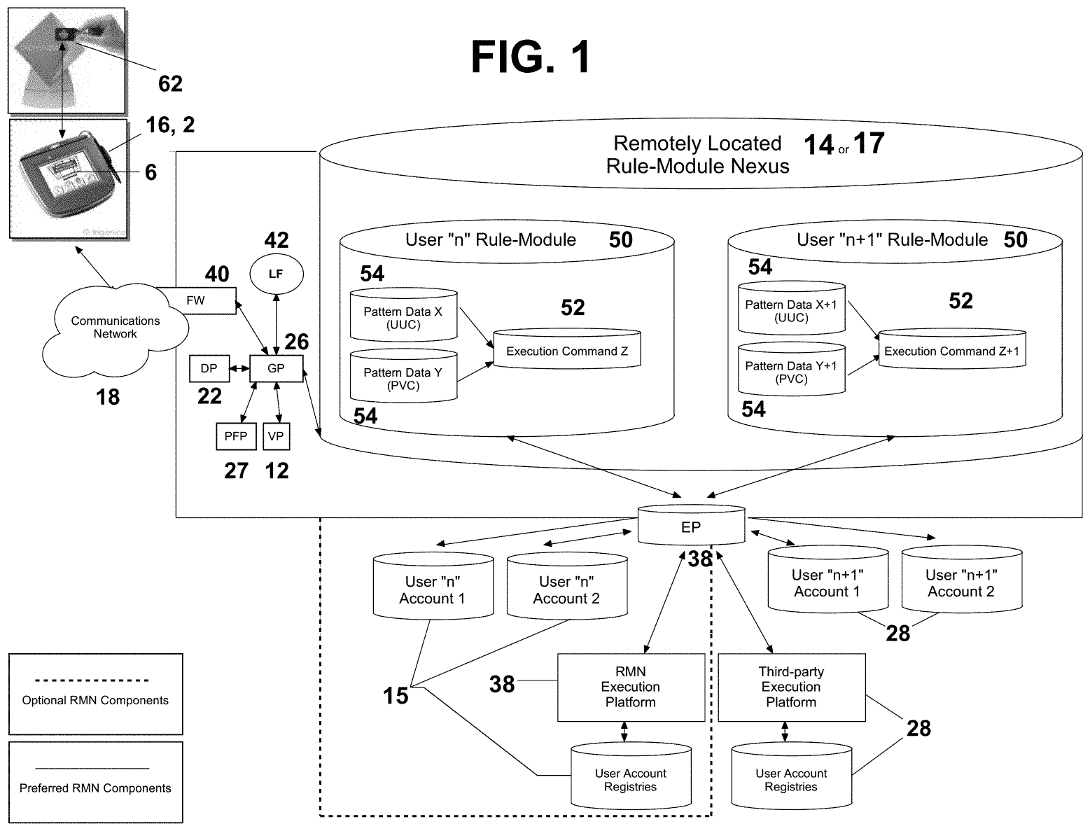

As seen in FIG. 1, a Firewall machine 40 connects the Verification Platform 12 to the Internet 18 or intranet 18. Messages are sent to a Gateway Platform 26, which is responsible for overseeing the steps required to process the financial transaction, including forwarding the financial transaction to the Verification Platform 12 and the Master Rule-Module Nexus 14.

Preferably, electronic messages transmitted between the UIA 16 and the Master RMN 14 are encrypted. For this, the financial transaction processor uses the Decryption Platform (DP) 22, which utilizes the UIA-VC 204 of the UIA 16 to verify the encryption codes that is required to decrypt messages from the UIA 16. Once decrypted, the verification of the User is determined using Verification Platform 12, which provides storage, retrieval and comparison of UUC 200-PVC 202 packet.

In another embodiment, the Verification Platform 12 provides periodic User re-verification queries. In this embodiment, in order for a User to extend an on-line session, the User is requested by the Verification Platform 12 to re-verify themselves using a User bid UUC 200 and a bid PVC 202.

In another embodiment, an Account Issuer is also verified by the Verification Platform 12 using verification data comprising: a digital certificate, an Internet protocol (“IP”) address, a UUC 200, a UTA-VC 204, or any other code, text or number that uniquely identifies the entity. In this way, the Verification Platform 12 is enabled to provide the User with confirmation that the correct Account Issuer participated in the electronic financial transaction. Examples include confirming that the correct Account Issuer web site or remote Third-Party Platform 28 was accessed by the User, that the correct entity designee received the User's email or instant message, and the like.

In another embodiment, the Verification Platform 12 platform is integrated with the Master Rule-Module Nexus 14 platform.

In a preferred embodiment, more than one Verification Platform 12 provides fault tolerance from either natural or man-made disasters. In this embodiment, each Verification Platform 12 uses a backup power generator, redundant hardware, mirrored platforms, and other standard fault tolerant equipment known in the industry.

Verification of the User occurs using different methods, depending on the verification information that is provided by the UTA 16. The Verification Platform 12 has subsystems for each type of information that is received by the Verification Platform 12, and each subsystem is highly optimized to provide rapid verification as outlined below.

In a preferred embodiment, Verification Platform 12 comprises subsystems that can verify parties from the following information:

UUC 200 data and Personal Verification Code (PVC) 204;

digital verification (digital certificates);

UTA-VC 204;

Biometric Identification Subsystem (BID).

### Biometric Identification Subsystem (BID)

In one embodiment of the Verification Platform 12, a User registers with the RMN 14 a secondary PVC 202 with a biometric template, the BID subsystem comprises at least two BID processors, each of which is capable of verifying Users only from their scanned biometric sample, comprising any of the following biometrics: finger, retina, voice, face, hand, palm, iris.

In one embodiment, each BID processor comprises the entire platform of registered biometrics. To distribute the financial transactions evenly across processors without undue effort, the Verification Platform 12 determines randomly which BID processor will be used for a given electronic financial transaction, and delegates the verification request to that BID processor. That BID processor performs a search of its BID platform in order to find a matching registered biometric sample. In another embodiment, there is a financial User re-registration check step, wherein the User's registration biometric is compared against previously registered biometrics wherein if a match occurs, the Rule-Module Nexus 14 is alerted to the fact that the User has attempted to re-register, and a warning message is sent to the Prior Fraud Platform (PFP) 27.

In another embodiment, other information is present that assists the BID processor in searching the platform. For finger images, this includes information such as the classification of the image (whirl, arch, etc.), and other information about the finger ridge structure that is useful for selecting out biometrics that are not likely to match, or information on biometrics that are likely to match. Such biometric-based sorting and classification systems using mathematical algorithms, are known in the art for fingerprints and for other biometrics such as retina of the eye, voice print, and face vascular patterns.

Preferably, other information is present that assists the BID processor in searching the platform, including a User's primary PVC 202 (on a limited basis) or a User's UUC 200. The User's biometric is stored in a basket labeled with the User's UUC 200 or primary PVC 202, which may be non-unique. The PVC-labeled basket may comprise a plurality of registered biometrics of a plurality of distinct Users, all of whom happen to have the same PVC 202. A biometric basket labeled with a PVC 202 comprises a subset of all biometrics registered with the RMN 14, and therefore is more efficient, more cost-effective and more accurate to search. This is known as a “one-to-some” or “one-to-many”. Alternatively, a biometric basked may be labeled with the User's UUC 200, which is unique to the User, wherein the only biometric(s) in that basket are of the User. This is known as a “one-to-one” search. Thus UUC-labeled basket can comprise only one User's registered biometric(s), and conducting a search with the aid of the UUC-labeled basket can be the most efficient and accurate. By contrast, conducting a “cold search” of all the biometric records stored in the RMN 14 or RMN-authorized Third-Party Platform 28, without the aid of a PVC-labeled basket, can be far more expensive, slower and less accurate. This is known as a “one-to-all” search.

In one embodiment, the User is enabled to provide, on a limited basis, dual PVCs 202 for verification, wherein two PVCs 202 of the User are provided to the UTA 16 in the event that the User's UUC 200 and/or NAT 62 has been comprised (e.g., lost, stolen, damaged, or copied), said PVCs 202 comprising any combination of the following: an alpha-numeric PVC 202; a biometric PVC 202; an alpha-numeric secondary PVC 202, and; a biometric secondary PVC 202.

### UUC-PVC Verification Platform

In a preferred embodiment, the Verification Platform (VP) 12 further comprises at least two Subset VP's 12, all being are capable of verifying parties from their UUC 200 and PVC 202.

In one embodiment, the records of parties identifiable from UUC 200-PVC 202 combinations are distributed equally across all Subset VP's 12. In one embodiment, one Subset Verification Platform 13 is responsible for verifying Users with PVCs 202 or UUCs 200 numbered 1-10, another Subset Verification Platform 13 is responsible for verifying Users with PVCs 202 or UUCs 200 numbered 11-20, and a third Subset Verification Platform 13 is responsible for verifying Users with PVCs 202 or UUCs 200 numbered 21-30. For example, all messages from the UIA 16 comprising a PVC 202 or a UUC 200 numbered 30 would be routed to Verification Platform 12 for verification of the User.

In an exemplary embodiment, wherein a Verification Platform 12 receives a bid UUC 200-PVC 202 packet from the Transaction Terminal 2 conjoined with a UIA 16, for verification, a processor searches through its platform, retrieving all registered UUCs 200 that match or correspond to that particular bid PVC 202. Once all corresponding registered UUCs 200 are retrieved, the Verification Platform 12 compares the bid UUC 200 obtained from the electronic financial transaction to all retrieved registered UUCs 200. If a match occurs, the Verification Platform 12 makes a positive matching determination and outputs the User Verification Approval Code 206 to access the User Account Registry 15 and associated Rule-Modules 50 of the User. If no match is found, the Verification Platform transmits a “not identified” message back to Gateway Platform 26 and to the logging facility 42.

In one embodiment, there is a UUC 200 theft resolution step, wherein the financial User's PVC 202 is changed if the financial User's UUC 200 is determined to have been compromised or fraudulently duplicated.

### Digital Identification Subsystem

In a preferred embodiment, the Digital Identification subsystem comprises a plurality of processors, each of which is capable of verifying an entity, such as an Account Issuer, from their digital certificates. In this embodiment, digital certificates are used to perform digital verification of an entity. Preferably, these include corporate web site addresses and certifying authorities only. Where possible, computers provide digital certificates for verification of the Account Issuer, including a UIA-VC 204 for two-factor verification.

Verifying that a particular digital certificate is valid requires a public key from the certifying authority that issued that particular digital certificate. This requires that the digital verification subsystem have a list of certifying authorities and the public keys used to validate the digital certificates they issue. This table must be secure, and the keys stored therein must be kept up to date. These processes and others relating to the actual process for validating digital certificates are well understood in the industry.

### UIA Hardware Verification (or Identification) Subsystem (UHV or UHI)

In a preferred embodiment, UIA-VC's 204 are translated into entity verification by the UHI subsystem. This subsystem maintains a list of all User Interface Apparatus 16 manufactured. Preferably, when a particular User uses a UIA 16, that User's geographic location is identified by their use of that particular UIA 16 during that electronic financial transaction session.

In another embodiment, the UIA-VC 204 does not serve to verify either the User or an entity. This is the case in User Interface Apparatus 16 installed in public venues such as airport Transaction Terminals 2, Automated Teller Machines in banks, or computers with User Interface Apparatus 16 for home use.

### User Verification Approval Code

A User Verification Approval Code 206 is an electronic message output by the Verification Platform 12 upon a positive matching determination of the User. The VAC 206 informs the Master Rule-Module Nexus 14 that a User has been successfully identified, and instructs the Master Rule-Module Nexus 14 to invoke the Rule-Modules 50 for that particular User. Preferably, any time the User is verified by the Verification Platform 12 via submitted a UUC 200-PVC 202 packet, the User Verification Approval Code 206 is forwarded to the Master Rule-Module Nexus 14 where it identifies a UAR-Code 65, invoking access to a User Account Registry 15 and invoking at least one Rule-Module 50 for that User. In the Master Rule-Module Nexus 14 platform, a Rule-Module 50 is created that is identified by the User Verification Approval Code 206. In a preferred embodiment, the Verification Approval Code 206 is identical to the UAR-Code 65, but does not: identify a specific Financial Account 65, identify a specific Financial Account Number 65.

### Rule-Module Nexus

In a preferred embodiment, once the User is identified by the Verification Platform 12, the User Verification Approval Code 206 is forwarded to the Master Rule-Module Nexus 14. The Master Rule-Module Nexus 14 instructs the Execution Platform 38 to take the necessary steps for executing the Execution Commands 52 that are associated with the Pattern Data 54 of the User registered with the Master Rule-Module Nexus 14.

### Rule-Modules

The Master Rule-Module Nexus 14 is comprised of at least one Rule-Module 50 which comprises Pattern Data or an Execution Command which is “distinct” or “unique” to one registered User (hence, “User-Unique”). In a preferred embodiment, at least one Rule-Module 50 is unique and exclusive to an individual User. In the event that a Rule-Module comprises pattern data and an execution command that is indexed to one or more registered Users, said Rule-Module is deemed “customized” to a User but not unique to that User (hence, “User-Customized”). As defined herein, User-customized does not necessarily mean that any Pattern Data 54 or the Execution Command 52 is unique to a User, but rather that they are indexed to or are assigned to a specific User. As such, the same Pattern Data 54 or Execution Command 52 may be assigned to several specific Users, and hence would not be unique to any one User.

The Master Rule-Module Nexus 14 functions as a central storage facility for registering, indexing, updating, and invoking various Rule-Modules 50, whereby the Rule-Modules 50 govern the deposit, the display, the deducting, and the dispensing of financial. Preferably, each of these Rule-Modules 50 is composed of at least two Pattern Data 54 which is associated with or electronically linked to at least one Execution Command. Preferably, said Pattern Data 54 minimally comprise: a UUC 200, a PVC 202, and two proprietary Financial Accounts 65.

The Master Rule-Module Nexus 14 optionally stores User-customized Pattern Data 54 that is unassociated with any User-customized Execution Commands 52 and optionally stores User-customized Execution Commands 52 that are not associated with any User-customized Pattern Data 54. Therefore, such unassociated Pattern Data 54 or Execution Commands 52 are optionally stored within the Master Rule-Module Nexus 14 until they are associated with a Pattern Data 54 or an Execution Command 52 together thereby forming an executable Rule-Module 50.

Once the Verification Platform 12 outputs a positive matching determination for a User, the User Verification Approval Code 206 is forwarded to the Master Rule-Module Nexus 14. The Master Rule-Module Nexus 14 takes the User Verification Approval Code 206, optionally along with the UTA-VC 204, the UTA 16 location data and the Financial Transaction Request Message (or Transaction Request or Transaction Request Message) 251, and searches among the User's customized Rule-Modules 50 to invoke Pattern Data 54 and associated Execution Commands 52 relevant to the financial transaction being undertaken.

### Pattern Data (PD)

As previously noted, Pattern Data 54 may be provided by the User, by the Master Rule-Module Nexus 14, or by an authorized financial entity 28, while the User provides at least one associated Execution Command 52, to form a single Rule-Module 50.

Pattern Data 54 of a User is stored electronic data, which is customized to at least one User. For example, Pattern Data 54 may include any stored User-customized and User-unique electronic data, comprising: a primary Personal Verification Code (PVC) 202, which is optionally alpha-numeric; demographic information; an email address; a plurality of proprietary Financial Accounts 65; a stored-value account comprising pre-paid or pre-earned financial; the User's date of birth; a secondary PVC 202; a telephone number; Account Transaction Data 172; a mailing address; purchasing patterns; a UUC 200. The UUC 200 is unique to each User and is not shared between Users.

Any such Pattern Data 54 may be provided to the Master Rule-Module Nexus 14 by: a User; a Master Rule-Module Nexus 14; or an authorized third-party 28 such as an Account Issuer.

Account Transaction Data 172 associated with a Financial Account 65 is any information pertaining to a User Account or an Account Issuer Account (respectively, User Account Data and Account Issuer Account Data). Such data includes any of the following: a number which uniquely locates or routes a transaction to a Financial Account 65; a number which uniquely identifies the Financial Account 65; User usage location; User usage frequency; User usage recency; User usage demographics, and; User usage volume of electronic financial transactions; a financial transaction processing preference of the Account Issuer associated with the Financial Account 65.

In a preferred embodiment, within the Rule-Module Nexus 14, a User Account Registry (UAR) 15, which is identified by a User Account Registry Code (UAR-Code) 59, contains a plurality of proprietary Financial Accounts 65 of a User, including associated Account Transaction Data (or Transaction Data) 172, and associated Rule-Modules 50. For example, in the event that the Financial Account 65 is a incentives account for rewards or scrip (e.g., a rewards incentives account), the value for each unit of financial data could be a dollar amount, a number of minutes of telephone calling time, points towards the purchase of a product or service, a percentage discount on current or future purchases, and the like. For rewards transactions, the Account Issuer then designates the number of financial to be disbursed to Users based upon the occurrence of predetermined criteria. This criteria may include a credit or debit of financial in the User's Financial Account 65 based on the User's purchasing patterns as a function of any of the following: time; demographics; frequency; recency, and; amount of expenditure.

In another embodiment, within a User Account Registry 15, the Master Rule-Module Nexus 14 stores and manages Financial Accounts 65 for participating Account Issuers, Users, and counter-party entities. Further, The Master Rule-Module Nexus 14 may comprise Execution Commands 52 to display the Financial Account 65 status, calculations, and adjustments, and the like for participating Account Issuers, counter-party entities, and Users.

### Execution Commands (ECs)

An Execution Command 52 may be invoked by Pattern Data 54 with which it is associated. Execution Commands 52 stored within the Rule-Module Nexus 14 and executed by the Execution Platform 38, may transmit electronic messages necessary for depositing, displaying, deducting, and/or disbursing financial data associated with Financial Accounts 65 of a User and, optionally, an Account Issuer. For example, the Execution Commands 52 may also include instructions or commands pertaining to the preserving the preferences of an Account Issuer for processing and/or completing of an on-line financial transaction, comprising: invoking criteria predetermined by the account issuer for declining the on-line financial transaction; invoking criteria predetermined by the account issuer for approving the on-line financial transaction; invoking criteria predetermined by the account issuer for settlement of the on-line financial transaction; invoking a proprietary network; invoking a discount rate; invoking an interchange fee; invoking a settlement protocol; invoking a surcharge; invoking a processing partner, and; invoking a time period for settlement. A processing partner is a Third-Party Platform 28, preferably registered with the RMN 14, comprising: an account issuer (e.g., Wells Fargo Bank™); a merchant private label (e.g., Nordstrom's™); an aquirer (e.g., First Third Bank™); a credit association (Visa™); an intermediary (e.g., First Data Corporation™ GE Capital™); a debit processor (e.g., Interlink™), and; a credit company (e.g., American Express™)

Another exemplary embodiment of the invention includes a Financial Account 65 being used under predetermined circumstances comprising: the number of units of financial data to be debited from a Financial Account 65 under which circumstances and the number of units of financial to be credited to an Account Issuer Account under which circumstances. Such Execution Commands 52 may include: a pre-calculated formula for surcharging a User's Financial Account 65 during a financial transaction, such that said surcharge is automatically disbursed to a financial counter-party (e.g., a non-profit charity or a checking account of a subordinated User) or deposited into another Financial Account 65 of the User (e.g., a savings account or brokerage account); a pre-designation that Financial Accounts 65 are to be displayed to the User such that the User can select which Financial Account 65 to invoke for the financial transaction; a pre-designation that Audible or Visible Signatures 81 are presented to the User on a UTA Display 6 or Transaction Terminal Display 6 such that the User may select which entity will be the counter-party of the financial transaction disbursement; a pre-designation that purchases from certain participating Account Issuers will automatically invoke a financial disbursal to at least one certain financial counter-party; a pre-designation that upon accumulation of certain types of financial, such as frequent-flyer miles or free phone minutes, such types of financial will be automatically disbursed to a predetermined financial counter-party; a pre-designation that upon accumulation of certain amounts of financial, there will be a disbursal to at least one predetermined financial counter-party; a pre-designation that upon one financial counter-party having received a certain quantity of financial transactions from the User, perhaps even within a certain timeframe, the User will be notified or further financial disbursal will automatically transfer to a different counter-party.

In one embodiment of a scrip transaction, a Rule-Module 50 from the Master Rule-Module Nexus 14 comprises an Execution Command 52 which permits a merchant to contribute financial directly to a non-profit charity based upon a User's purchases. In such transactions, units of financial are electronically debited from the merchant account, and corresponding units of financial are electronically credited to the Financial Account 65 of the non-profit charity.

The Execution Commands 52 in the Rule-Module Nexus's 14 may further provide several predetermined designations including any of the following: immediate cash discounts or premium charges to a User's Financial Account 65 during a commercial transaction; a deduction of financial units from a User's Financial Account 65, and an immediate transaction thereof via electronic funds transfer (EFT) to an Account Issuer; a recurring debit based upon a predetermined interval of time, and; an accrual of financial which are credited towards a User's future purchase of a product or service.

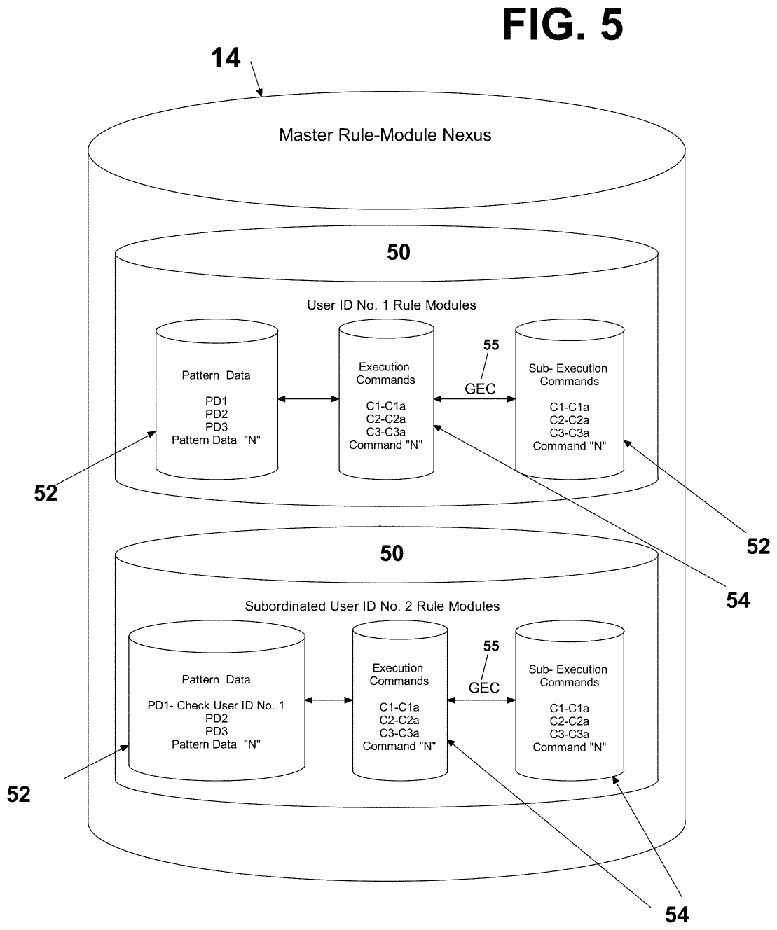

FIG. 5 is illustrative of an embodiment, wherein Rule-Modules 50 are registered to a User and a subordinated User, each having a plurality of Pattern Data 54 are associated with a plurality of Execution Commands 52, including Global Execution Commands 55.

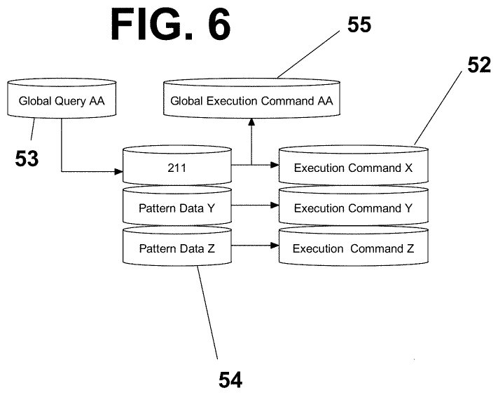

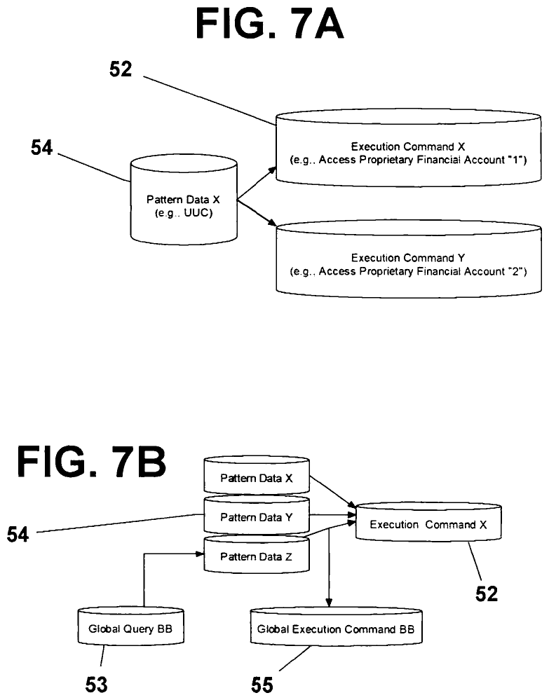

FIG. 6 shows another embodiment wherein only one Pattern Data 45 associated with one Execution Command 52.

FIG. 7A is illustrative of an embodiment wherein a Pattern Data 54 is associated with a plurality of Execution Commands 52, thereby forming a plurality of Rule-Modules 50.

FIG. 7B shows another embodiment, wherein a plurality of Pattern Data 54 are associated with an Execution Command, again forming a plurality of Rule-Modules 50.

Any User-customized Execution Command 52 may be provided to the Nexus 14 by a party comprising: the User, the Nexus 14, or an authorized third-party.

### Global Queries and Global Execution Commands

In a preferred embodiment of this invention, a Global Execution Command (GEC) 55 does not automatically compel or require all financial transactions of all Users to: be linked to any particular Account Issuer, and/or merchant, and/or product, and/or service, and/or; bypass or be diverted from the Account Issuer or Network 18 which might otherwise apply to a Financial Account 65 selected by any User during an on-line financial transaction. As such, preferably there are no “default” GECs 55 governing all of the Financial Accounts 65 of all Users.

An example would be as follows: upon the Verification Platform 12 making a positive matching determination from comparing the User's bid UUC 200-PVC 202 packet with registered UUCs 200 and PVCs 202, the User's unique Verification Approval Code 206 is output to the Rule-Module Nexus 14, matching Global Queries 53 and invoking User-customized Rule-Modules 50. In a preferred embodiment, the Verification Approval Code 206 matches the User Account Registry Code (UAR-Code) 59 which uniquely identifies the User Account Registry 15 of a User.

In an exemplary embodiment, the submitted Verification Approval Codes 206 automatically matches to a set of Global Queries 53 in the Rule-Module Nexus 14. For example, when a Verification Approval Code 206 is submitted, it may match automatically with Global Queries 53 such as the following: “What is the User's home zip code?”; “What that the User's most frequently used merchant?”; “What is the status of the User's financial account(s)?”. The answers to these Global Queries 53 are contained in the User-customized Pattern Data 54 which are statements that comprise data customized to the User. In this example, the Pattern Data 54 responses to the above Global Queries 53 are, respectively, as follows: “95401”; “Macy's”; “All payments are current”. In this embodiment, these Pattern Data 54 responses invoke Global Execution Commands (GEC) 55 which govern automatic response programs such as, respectively: “Notify the User to re-new subscription to Santa Rosa Symphony”; “Email the User an electronic coupon for discounted apparel and sports accessories at Macy's in Santa Rosa, Calif.”; “Mail the User an offer for reduced credit card interest rates because account is in good standing”. In this embodiment, therefore: Global Queries 53 and the Global Execution Commands 52 are actually non-specific, or non-customized, to any particular User; however, the Pattern Data 54 and Execution Commands 52 are unique to, or customized to, the specific User whose Verification Approval Code 206 has been submitted. This exemplary embodiment renders a platform architecture for the Rule-Module Nexus 14 that has: User-customized sub-modules with User-customized Pattern Data 54 and Execution Commands 52; while the Global Queries 53 and the Global Execution Commands 55 sub-modules are not required to be customized to any one single User.

### On-Line Financial Transactions

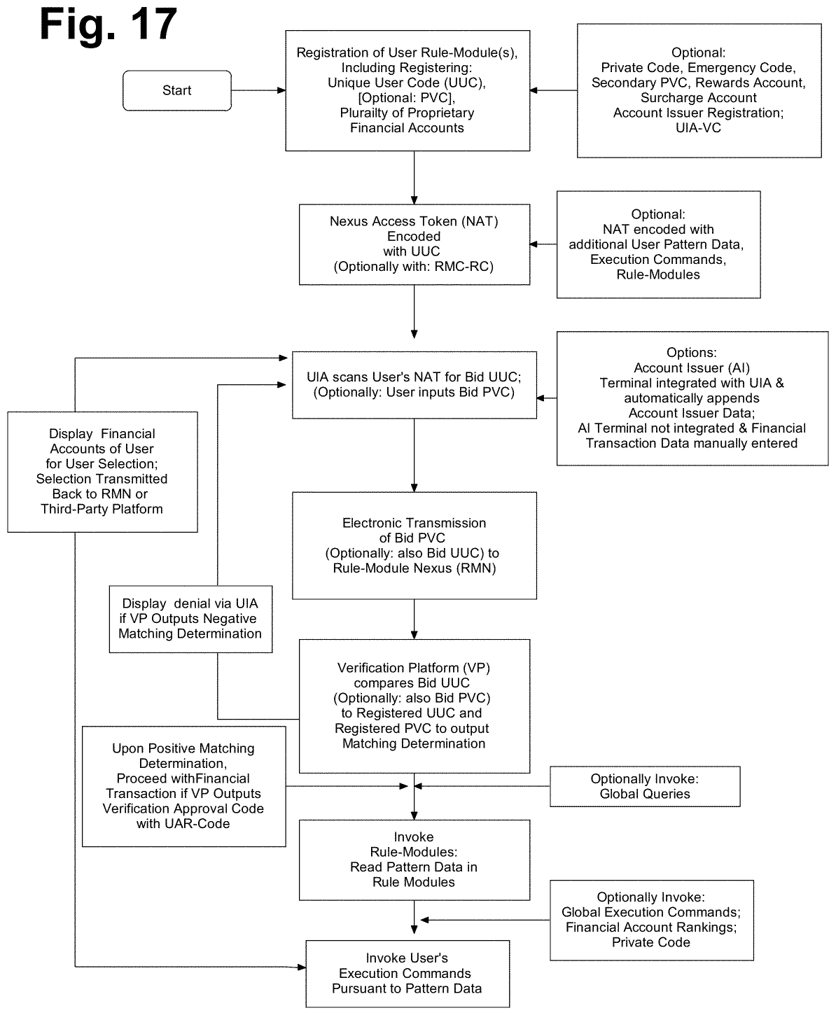

FIG. 17 illustrates an exemplary financial transaction, characterized by verifying the User providing a bid UUC 200 from a scanned NAT 62 and a bid PVC 202 entered via a keypad 70 on the UIA 16 of an Account Issuer. The UIA 16-Transaction Terminal 2 transmits the UUC 200-PVC 202 packet to the Master RMN 14 for verification, along with the UIA-VC 204. The User is thus verified (or identified) through the bid UUC 200—PVC 202 packet submitted to the Verification Platform 12, while the Account Issuer is verified (or identified) through the UIA-VC 204 of the UIA 16.

The VP 12 outputs a VAC 206 upon verifying the User, wherein a UAR 15 is identified and accessed for presenting a plurality of Financial Accounts 65 of the User via a Display 6 on a UIA 16-Transaction Terminal 2.

The User selects a presented Financial Account 65 via the UIA 16-Transaction Terminal 2, wherein transaction data is entered and appended via the Transaction Terminal 2 either using an electronic cash register or manually. The User then either authorizes or cancels the transaction using the keypad 70 of the UIA 16-Transaction Terminal 2. Once the financial transaction is authorized, the UIA 16-Transaction Terminal 2 transmits to the Account Issuer platforms 28 via the RMN 14. The Master RMN 14 preserves a forwards the transaction to the financial responsible party(ies) for completing the transaction, optionally including execution and settlement, said party(ies) comprising: the Master RMN 14, a participating Account Issuer platform 28, and the like.

Execution of the transaction may result in a declined transaction due to lack of financial or other problem condition reported by the Account Issuer. If the transaction is declined, the Master RMN 14 or the Account Issuer platform 28 may transmit the decline notification back to the UIA 16-Transaction Terminal 2, canceling the transaction.

As further described below, FIG. 4B through FIG. 4D show, respectively: an embodiment of a financial transaction request packet (or message); an embodiment of a financial transaction response packet (or message); an embodiment of the construction of a financial transaction response packet (or message).

FIG. 4B shows an embodiment of a Transaction Request Message (or Transaction Request or Transaction Request Message) 251: A Transaction Request Message 251 originates from the UIA 16-Transaction Terminal 2 and comprises information and data that is required for the processing of an electronic transaction. In one embodiment these data comprise: a bid UUC 200-PVC 202 packet, a RMN-RC 61, and a UIA-VC 204; in an alternative embodiment, the Transaction Request Message 251 includes additional Transaction Data 172, comprising: amount of purchase, the User's selected Financial Account 65, and other instructions.

FIG. 4C shows an embodiment of a Financial Transaction Response Message (or Transaction Response or Transaction Response Message) 252: A Transaction Response Message 252 originates from the RMN or an Account Issuer platform 28 and comprises information and data that confirms the success or failure of a requested electronic transaction, preferably also including the Visible or Audile Signature 81 of the Account Issuer.

FIG. 4D shows an embodiment of construction of a Transaction Response Message 252, wherein the User (or Buyer) is verified (or identified). Optionally, this may includes an Account Issuer entity code if the Account Issuer audible or visible signature is already stored on Secure Memory 320 or 310 of the UIA 16, or if a new Account Issuer audible/visible signature is to be stored on Secure Memory 320 or 310 of the UIA 16, and played back or displayed to the User. In one embodiment, a registered Audible Signature 81 of an Account Issuer is a series of notes, such as a MIDI sequence, or a sample audio waveform, such as a 44.1 kHz 16-bit stereo audio stream. Each Audible/Visible Signature 81 is associated with an Account Issuer through an Audible/Visible Signature 81 code. The RMN 14 may thereby present Audible/Visible Signatures 81 to the User via the UIA 16-Transaction Terminal 2 to identify an Account Issuer party or a Financial Account 65 to the User.

FIG. 4E shows a flow chart of the operation of the User Interface Apparatus and the Transaction Terminal (or Terminal) for generating a request packet. FIG. 4F shows a flow chart depicting the data encryption and sealing process at the User Interface Apparatus.

FIG. 4G shows a flow chart depicting the data decryption and counter party identification process at the Rule-Module Nexus. FIG. 4H shows a flow chart depicting the data encryption and sealing process at the Rule-Module Nexus. FIG. 4I shows a representational diagram of the Transaction Request Packet (or Request Message) 251, and the mandatory and optional data it contains. FIG. 4J shows a representational diagram of the Transaction Response Packet (or Response Message) 252, and the mandatory and optional data it contains.

FIG. 13 shows an embodiment of a rewards or coupon transaction executed via the Rule-Module Nexus 14: a transaction is sent from the UIA 16-Transaction Terminal 2 to the RMN 14. Upon a User's UUC 200-PVC 202 packet being verified with a positive matching determination from the VP 12, the VAC 206 is output for accessing the UAR 15 and retrieving the User's rewards Financial Account Number 65 (e.g., Safeway™ Club number), optionally including associated purchasing Financial Account Number 65 (e.g., Visa™ account number) and optionally including related Transaction Data 172 (e.g., Visible Signature 81; list of items recently purchased). In one embodiment, the Visible Signature(s) 81 for the rewards Financial Account 65, and optionally a credit Financial Account 65 for payment, are transmitted to the UIA 16-Transaction Terminal 2 for display to the User. Upon the User's selection of the rewards Financial Account 65, and optionally the credit Financial Account 65 for payment in the event of a purchase, the on-line transaction is sent to the Account Issuer platforms 28 for further processing. Specifically, portions of the Financial Transaction Request packet (or message) 251 are forwarded to the (AI)-Rewards Processor platform 28, and in the event of a purchase, to the payment account's Account Issuer platform 28 (not shown). The AI-Rewards Processor platform 28 generates predetermined rewards, coupons or incentives; in addition, optionally, the data for the Financial Account 65 for payment is sent to the AI-Acquirer platform 28 for authorization and settlement (not shown).

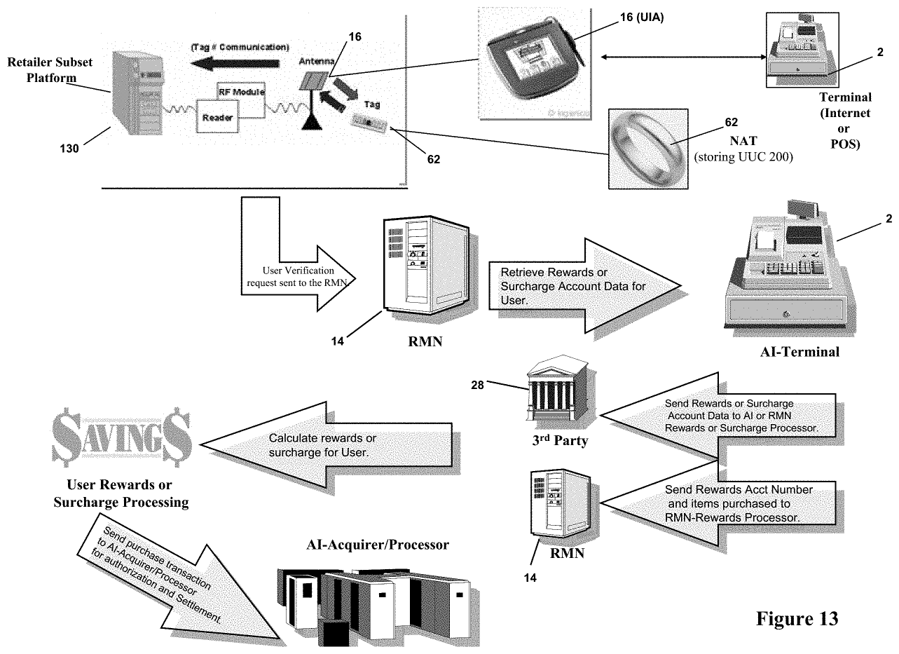

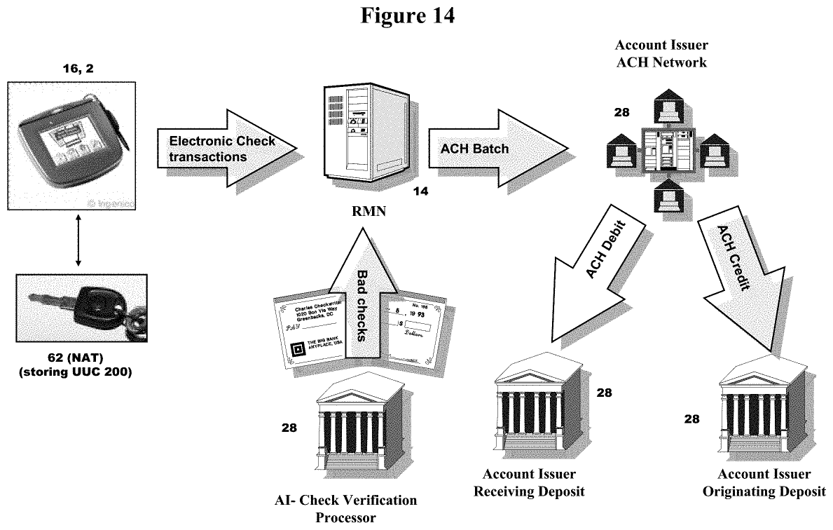

FIG. 14 shows an embodiment of an electronic check transaction executed via the Rule-Module Nexus 14: the merchant UIA 16-Transaction Terminal 2 at point of sale sends a UUC 200-PVC 202 packet to the RMN 14 for a User's verification; a positive matching verification enables the UAR 15 to retrieve the e-Check Financial Account 65 for transmitting the e-Check Visible Signature 81 to the UIA 16-Transaction Terminal 2. Upon the User's selection of the e-Check Financial Account 65, the transaction may be passed along to a AI-Check Verification Processor platform 28 where certain high-risk e-Check transactions are vetted by in order to weed out previously tagged bad check writers, and to avoid a decline at the point of sale; the e-Check transaction may then be batched and sent to the AI-ACH Network platform 28 for processing; the ACH Network platform 28 then doles out ACH credits and debits to the appropriate Originating Depository Account Issuer platforms (ODAI) 28 and Receiving Depository Account Issuer platforms (RDAI) 28.

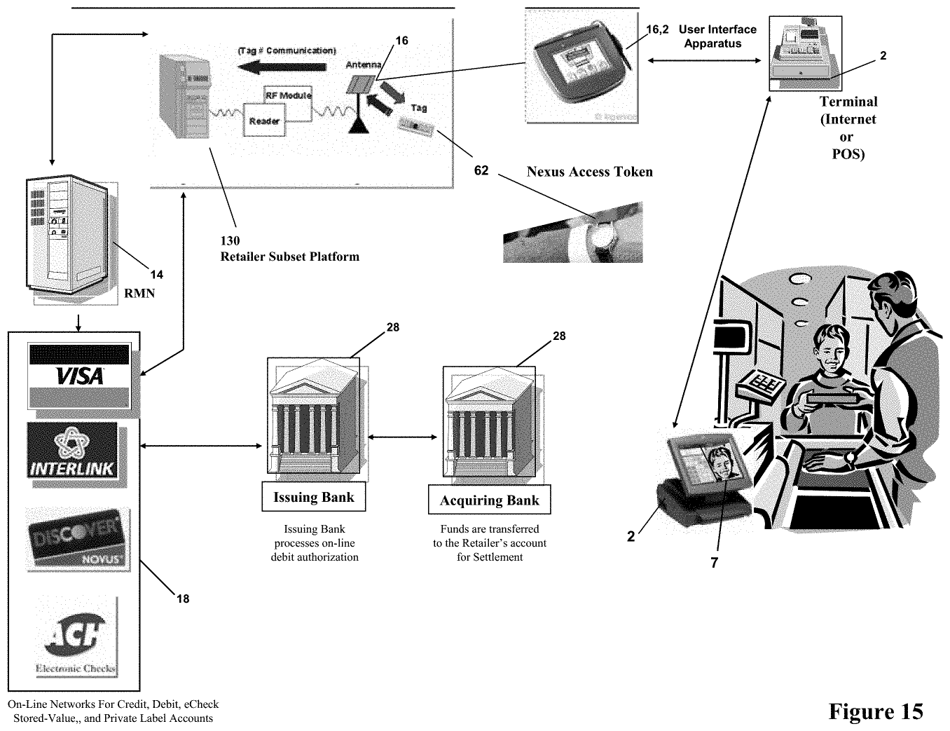

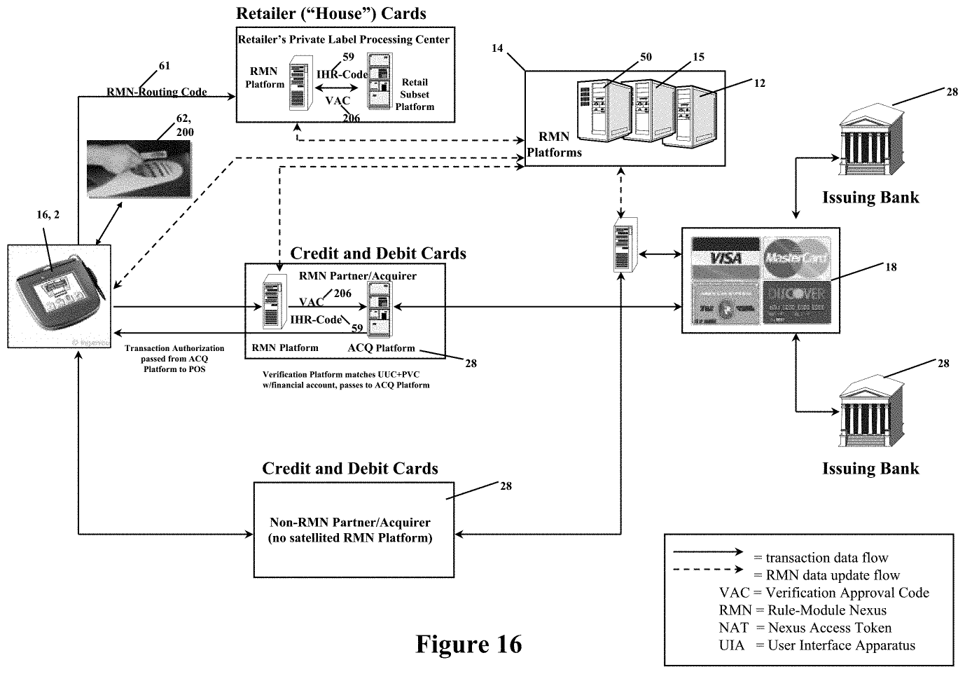

FIG. 15 and FIG. 16 show embodiments of credit and debit transactions executed via the Rule-Module Nexus 16: a User's Unique User Code (UUC) 200 is scanned from a Nexus Access Token (NAT) 62 by the User Interface Apparatus (UIA) 16; the User enters a Personal Verification Code (PVC) 202 into the UIA 16, wherein both the UUC 200 and PVC 202 are encrypted; the UUC 200-PVC packet is transmitted to the Rule-Module Nexus (RMN) 14 for User verification and, upon verifying the User, Financial Account 65 access via the User's UAR 15. The RMN 14 invokes Rule-Modules 50 of the User, transmits Visible Signatures 81 of a plurality of proprietary Financial Accounts 65 to the UIA 16, optionally with Account Transaction Data 172 along with the User's name and Private Code 79 for presentation to the User via Display 6. In this embodiment, the User views the Private Code 79 and Financial Accounts 65 on the Display, and selects a Financial Account 65 either by entering an alpha-numeric code, or touching a Visible Signature 81 of a Financial Account 65. The UIA 16-Transaction Terminal 2 constructs a Financial Transaction Request Message 251 either automatically if the UIA 16 is integrated with the Transaction Terminal-Electronic Cash Register (ECR) 2, or; manually by a cashier if the UIA 16 is not integrated directly to the Transaction Terminal-ECR 2. which is then transmitted via the Network 28 to an Account Issuer (AI)-Merchant platform 28. The UTA 6-Transaction Terminal 2 at AI-Merchant either transmits the encrypted financial transaction to a modem bank at the AI-Processor platform 28 which handles AI-Merchant's credit transactions on behalf of AI-Merchant's Acquiring Bank platform 28, or, transmits the encrypted financial transaction to the RMN 14, which then forwards it to the AI-Processor platform 28; the selected Financial Account Data (or Account Transaction Data) 172 tells the AI-Processor platform 28 to route the Transaction Data (e.g., issuing bank code and transaction amount) 172 to the appropriate on-line Network 18, with a query as to whether the account is valid and the transaction can be authorized; the account data tells the AI-Processor platform 28 to route the query to the AI-Issuing Bank platform 28, which confirms that the account is valid and that the credit balance is sufficient to cover the amount of the transaction, wherein the AI-Issuing Bank 28 platform responds affirmatively to the AI-Processor platform 28; the AI-Processor 28 platform hands off the approval to the AI-Acquirer Bank platform 28, which routes the approval to AI-Merchant platform 28 and marks AI-Merchant's account for settlement.

FIG. 15 also shows an embodiment of User verification further comprising a User facial photograph display, wherein upon the VP 12 outputting a positive matching determination that the User is authorized to access the rule-module database, the RMN 14 transmits the User's registered facial photograph 7 for the UTA 16 or the Transaction Terminal 2 to present via a Display 7 for a third-party present, such as a cashier, in real-time during the financial transaction, to visually compare the User's actual face with the User's displayed facial photograph 7, for affirming or denying that the authentic User is providing the UUC 200 and/or PVC 202.

FIG. 16 also shows an embodiment of the Subset RMN Platforms 17 co-located with an AI-Processor 28, including private label “house accounts”, Visa™, MasterCard™ Discover™, Interlink™ and American Express™. Upon the RMN's 14 verification of the User's bid UUC 200-PVC 202 data, the credit/debit card and merchant point-of-sale financial transactions are processed through both the RMN 14 authorized partner platforms 28 and third-party, non-partner AI-Acquirers platforms 28. The Master RMN Platforms 14 may also update the Subset RMN Platforms 17.

In another exemplary embodiment of the invention, upon the Verification Platform's 12 successful verification of the User from their bid UUC 200 and bid PVC 202, other embodiments of Execution Commands 52 governing electronic transmission access comprise permitting the User: to access their health insurance account and validate their prepaid benefits to a health-care provider prior to being admitted to a hospital; to access their prepaid entertainment account and validate to admittance personnel their eligibility to attend an entertainment event, such as a live music concert on a predetermined day, at a predetermined time and to sit in a predetermined seat; to access their prepaid video club rental account and validate to an Account Issuer their eligibility to rent videos under their pre-paid membership account; to access their dining club privileges at a restaurant using their prepaid membership account for recurring charges.

FIG. 17 shows a flow chart of registration and transaction processing with the Rule-Module Nexus.

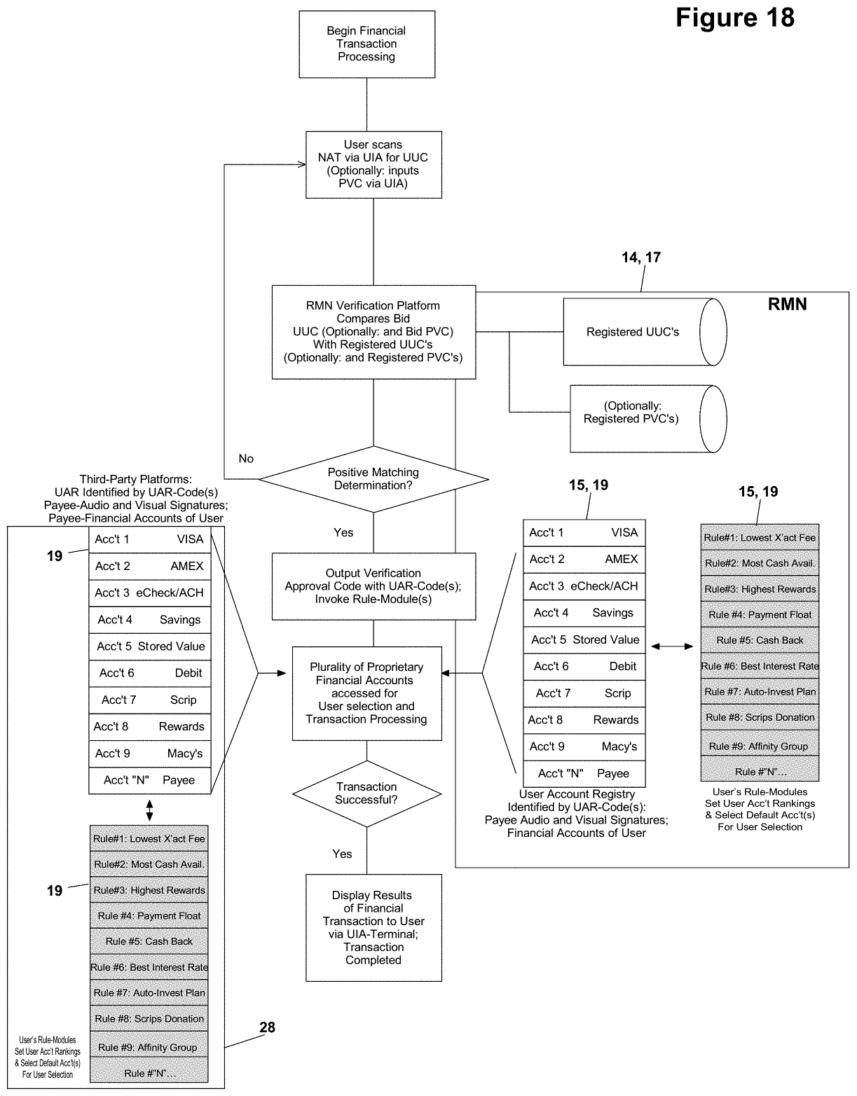

FIG. 18 shows a flow chart of registration and transaction processing with the Rule-Module Nexus 14, User Account Registry 15, and Third-Party Platforms 28.

In another embodiment of the invention, the Execution of a Rule-Module (RM) 50 and/or an Execution Command (EC) 52 by the Execution Platform (Execution Platforms) 38 may result in a declined financial transaction due to unidentifiable data comprising: bid UUC 200; bid UUC 200-bid PVC 202; a lack of an identifiable Account Issuer platform 28; a closed or inoperative participating Account Issuer platform 28; a closed Financial Account 65; a prior fraud record, and/or; some other immediately detectable problem condition. If the transmission is declined, the Master Rule-Module Nexus 14 or the Verification Platform 12 transmits the decline notification back to the UIA 16.

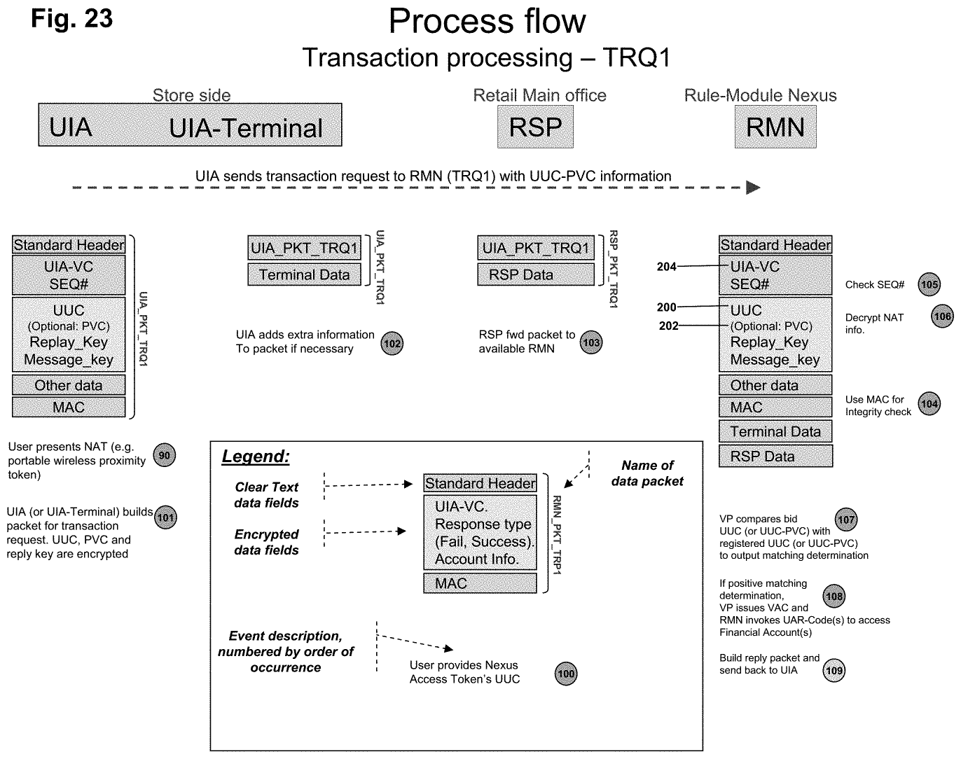

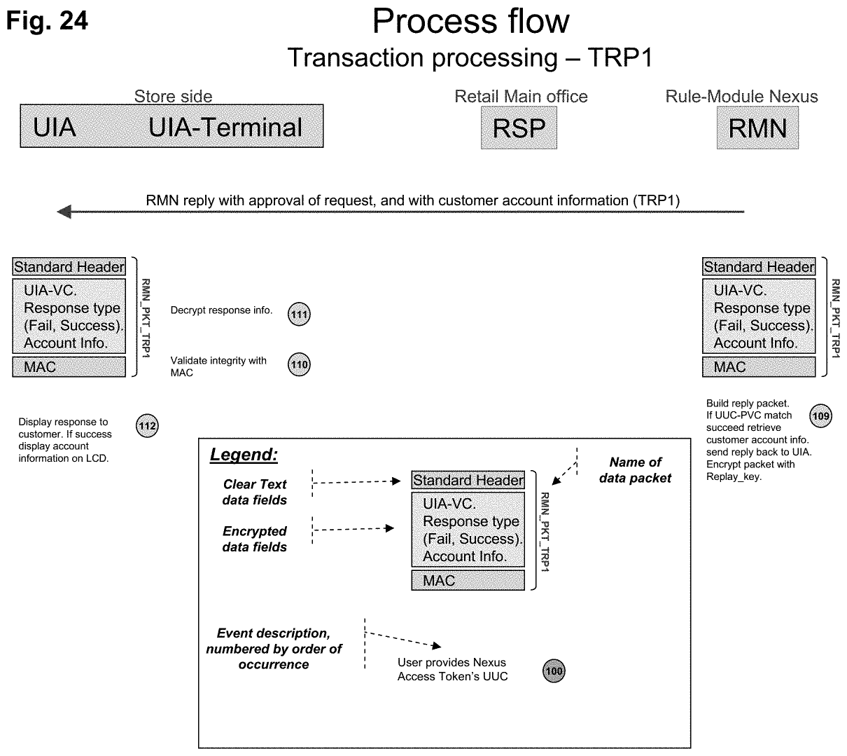

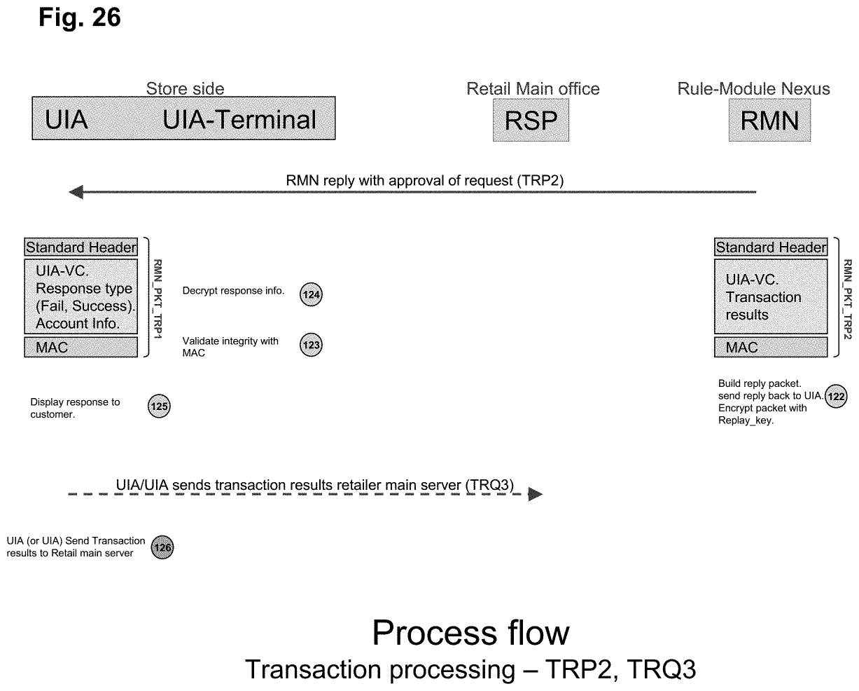

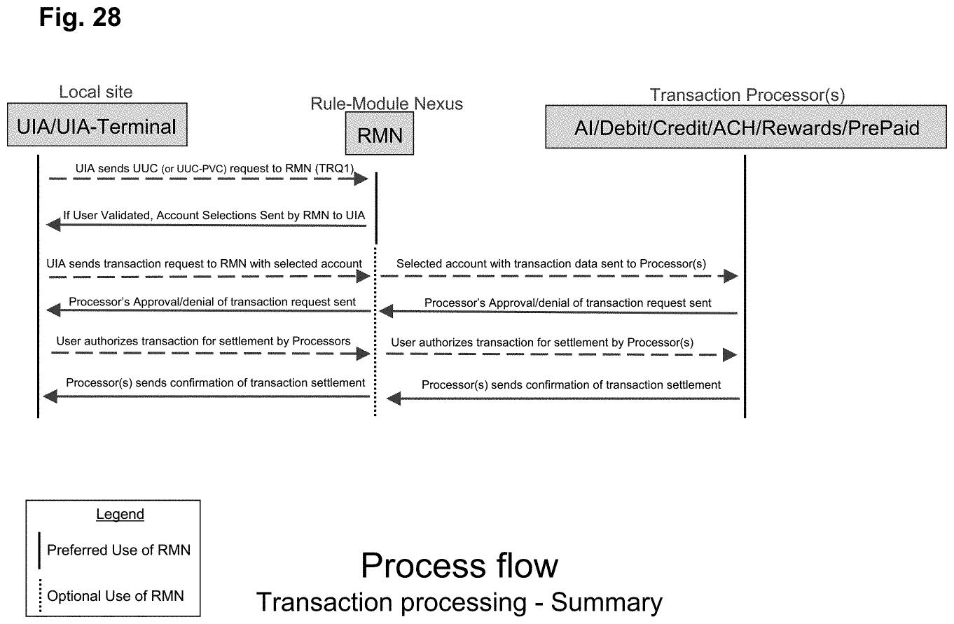

FIG. 23 through 28 show the process flow of a financial transaction via the Rule-Module Nexus 14, including: the User inputs a bid Personal Verification Code (PVC) 202 into a User Interface Apparatus (UIA) 16, and also presents a Nexus Access Token (NAT) 62 to the User Interface Apparatus (UIA) 16 for scanning of a bid UUC 200. The UIA 16, optionally integrated with a POS-Transaction Terminal 2, builds an encrypted packet for a Transaction Request 251, wherein the UUC 200, the PVC 202, a UIA Verification Code (UIA-VC) 204 and a reply key are encrypted. Additional Account Transaction Data 172 is appended to the packet from the POS-Transaction Terminal 2, wherein the Merchant Subset Platform (MSP) forwards the encrypted packet to the Rule-Module Nexus 14. The Rule-Module Nexus 14 platforms check the sequence number of the UIA-VC 204, decrypt the UUC 200 and the PVC 202, using a Message Authentication Code (MAC) for checking the integrity of the encrypted message. The Verification Platform (VP) 12 then compares bid UUC 200-PVC 202 with registered UUC 200-PVC 202's, to output a matching determination. If there is a positive matching determination, VP 12 issues a Verification Approval Code (VAC) 206, and the RMN 14 invokes at least one Rule-Module 50 of the User, including Pattern-Data 54 and Execution Command 52, to access Financial Account(s) of the User.

In this exemplary embodiment, a transaction is initiated from the UIA 16 when the User enters his PVC and the User's UUC 200 is scanned from his NAT 62, along with optionally appending the financial transaction data from the POS-Transaction Terminal 2, whereby a request (TRQ1) is transmitted to RMN 14; The RMN 14 transmits a reply packet (TRP1) including User account information is sent back to UIA 16 and POS-Transaction Terminal 2; Once the User has chosen the Financial Account 65, a second request (TRQ2) with transaction amount and selected account is sent to the RMN 14; The RMN 14 will process the transaction with Account Issuer processor, and reply back (TRP2) the results to UIA 16 and POS-Transaction Terminal 2. POS-Transaction Terminal 2 will submit the results to merchant main server (TRQ3).

### User Account Registries for Financial Accounts

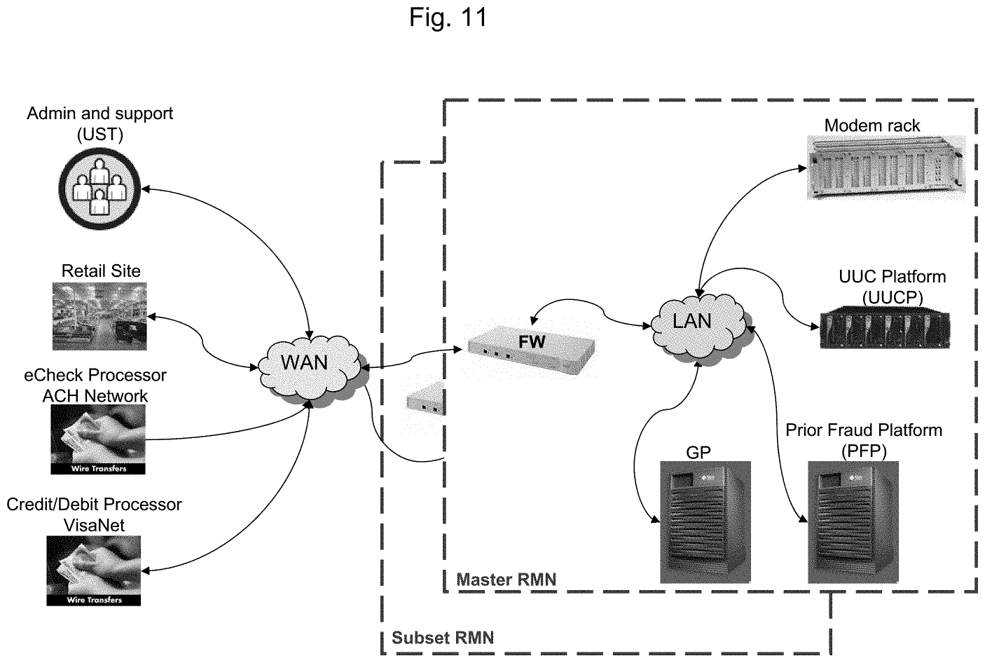

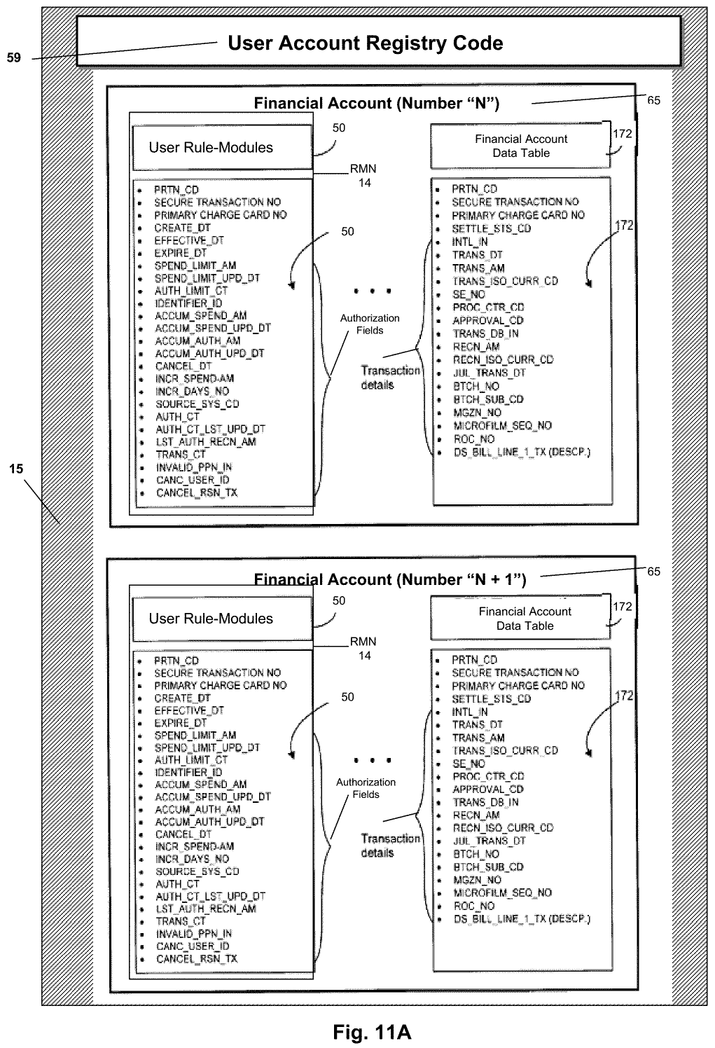

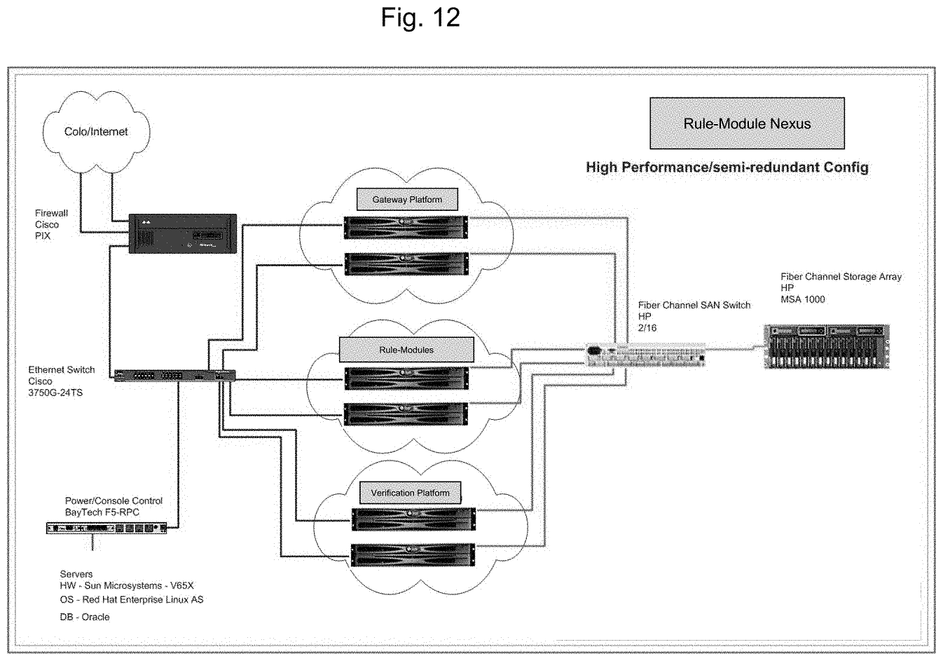

FIG. 11A illustrates two proprietary Financial Accounts 65 within a UAR 15 registered to a User of the RMN 14. The Rule-Modules 50 comprise which govern the Financial Account 65; the Account Transaction Data 172 optionally stores information relating to a particular transaction. As is known in the art, the processing mechanisms and data structure methods can be structured in a variety of ways.

In one exemplary embodiment of the invention, the UAR 15 within the RMN 14 comprises two Financial Accounts 65 comprising Rule-Modules 50 which govern, for example, a per purchase spending limit, a time of day use, geographic location, type or nature of financial transactions, a day of week use, certain merchant use and/or the like, wherein an additional verification may be required when using the NAT 62 outside of the restriction. The restrictions may be personally assigned by the User, the Account Issuer or the RMN 14. For example, in one exemplary embodiment, the account may be established such that purchases above $X (i.e., the spending limit) must be verified by the User using a special secondary Personal Verification Code (PVC) 202 which may be recognized by the RMN 14 as being unique to the User and the correlative financial transaction wherein the Financial Account 65 is selected. Where the requested purchase may be above the established per purchase spending limit, the User may be required to provide, for example, a special secondary PVC 202 such as a biometric sample. The restrictions may also be restricted by other User parameters, such as, geographic region (NAT 62 may only be used in a certain geographic region), product type (NAT 62 may only be used to purchase a certain product type), or Internet use only (NAT 62) transactions.

In yet another embodiment, settlement of an on-line financial transaction occurs on a predetermined time schedule, comprising: net-30 settlement terms; recurring monthly charges; and the like. In one embodiment, the financial amounts from an on-line transaction are deposited into an escrow account for an Internet Account Issuer or a User, instead of being directly credited to or debited from a User's Financial Account 65. This may be the case where a purchase of a product is made over the Internet 18 using an on-line auction provider such as eBay™, wherein funds may only be released upon delivery or receipt of the purchased product.

In FIG. 18, another exemplary embodiment is shown in which there is a UAR 15 comprising a plurality (e.g., at least two) proprietary Financial Accounts 65 of a User and/or at least one Account Issuer Account in the Rule-Module Nexus 14.

In one embodiment, there may be at least one electronic Master User Account Registry 15 platform comprising all of the Financial Accounts 65 in the Rule-Module Nexus and there may be at least one electronic Local or Subset User Account Registry 19 platform comprising a sub-set of the Financial Accounts 65 in the Rule-Module Nexus. In another embodiment, a UAR 15 comprising Financial Accounts 65 of the User reside within Third-Party Platforms 28, external to the Master RMN 14.

### On-Line Transmissions

There are also several embodiments of User-customized Execution Commands 52 that govern access to electronic on-line transmissions and associated data such as web sites, web site content and platforms. An electronic transmission is the on-line communication of content which is non-financial data and is not a financial transaction.

In one embodiment, an Execution Command 52 governing electronic transmissions for data access is a Global Execution Command (GEC) 55 that is unique to the User, and said GEC 55 is not invoked as a default for all Users and for all on-line transmissions of the RMN 14. Each such Execution Command 52 is optionally invoked by the User Verification Approval Code 206 serving as the Pattern Data 54. This Execution Command 52 is a software command that provides an authorized User access to any secured electronic non-financial data, such as those on third-party 28 platforms. Invoking this Execution Command 52 enables the User to simultaneously access all Internet chat or messaging forums, web sites and on-line platform content to which the User has authorization.

In another embodiment, the third-party 28 being contacted by the User for data access is also identified by the Verification Platform 12 using public/private key cryptography. Once the third-party is successfully identified by the Verification Platform 12, this invokes a Rule-Module 50 in the Nexus which is unique to this third-party and which is used to confirm to the User that the correct Third-Party Platform 28 was accessed.

In another embodiment, the Global Execution Command 55 is an Execution Command 52 that activates any of the following: an on-line or Internet-connected device, such as a wireless pager, a wireless or tethered telephone, a network computer, an exercise machine that is connected to the Internet, an electronic book; an on-line public access Internet computer, an automobile or household appliance that is connected to the Internet, an Internet-connected personal digital assistant such as a Palm Pilot™; an on-line photocopy machine; an Internet-connected digital audio player such as the Rio™. In several such instances, the executed Rule-Module 50 renders the on-line or Internet connected device operational and permits the User that has gained access using their UUCs 200-PVC 202 to conduct on-line activity to control or otherwise access the above mentioned Internet connected devices. For example, in one embodiment, an exercise machine incorporates a UIA 16 and is connected to the Internet. A User of the exercise machine provides their UUC 200-PVC 202 to the UIA 16, which is transmitted to the Verification Platform 12 for a matching determination. Upon the User being verified by the VP 12, and the exercise device is identified using its UIA-VC 204, the Rule-Module 50 executes a command allowing the User to activate the exercise device. Optionally, additional Rule-Modules 50 allow a User to save the details of their exercise activity (number of times, weight amount, date of exercise, etc.) on that exercise device as Pattern Data 54, in order to keep track of past performance and as a template for future exercise routines.

In another embodiment, an Internet-connected electronic book that incorporates a UIA 16, is activated when the Verification Platform 12 successfully identifies the User. This allows the User to download text and graphics of complete novels or films for which they have previously paid.

In another embodiment, a personal digital assistant, such as the Palm Pilot™, incorporates a UIA 16. When activated after the Verification Platform 12 has successfully identified the User, the personal digital assistant permits the User to download and take on-line academic examinations. In another embodiment, an Internet-connected digital audio player such as the Rio™, incorporates a UIA 16. When activated as a result of successfully verification of the User by the Verification Platform 12, the audio player permits the User to download music for which they have authorization. Optionally, additional Rule-Modules 50 can track how many pages of the electronic book have been displayed and can retain a bookmark for the most recently read page. Optionally, additional Rule-Modules 50 can track how many times a downloaded electronic audio track has been played.

Upon the Verification Platform's 12 successful verification of the User from their bid UUC 200 and bid PVC 202, other exemplary embodiments of Execution Commands 52 governing electronic transmission access comprise permitting the User: to access their driver's license on-line and validate to an authority their eligibility to drive a car, to purchase restricted products like alcohol or tobacco, to pick up a prescription at a pharmacy, or to access a restricted entertainment event such as an R-rated film being shown in theatres; to access their credit-rating and validate to a cashier their eligibility for check-writing privileges; to access an Internet web site and enter a real-time chat room with other people on-line.

In another exemplary embodiment of the invention, User verification further comprises a User facial photograph display, wherein upon the VP 12 outputting a positive matching determination that the User is authorized to access the rule-module database, the RMN 14 transmits the User's registered facial photograph 7 for the UTA 16 or the Transaction Terminal 2 to present via a Display 7 for a third-party present, such as a pharmacist, in real-time during the financial transaction, to visually compare the User's actual face with the User's displayed facial photograph 7, for affirming or denying that the authentic User is providing the UUC 200 and/or PVC 202.

Further embodiments of Execution Commands 52 governing electronic transmission access include entitling a User to extend an on-line User-customized session by repeating their User-customized session log-in by providing either their UUC 200-PVC 202 when periodically queried to do so by the Verification Platform 12 or Rule-Module Nexus 14, to access customized radio or television programming, wherein the User can be provided with customized programming, with or without time restrictions, that reflects predetermined preferences, such as a channel broadcasting only news on companies in which the User has an investment or a channel broadcasting only music from Broadway theater shows which the User has seen or indicated a desire to see, to access restricted portions of corporate intranet Network 18 platforms on a selective basis, based upon predetermined Pattern Data 54, such as the User's job title or company division, to access their travel reservations and validate to the admittance attendant that the User is eligible to travel, such as boarding a particular flight or a specific train, on a predetermined day, at a predetermined time, and to sit in a predetermined seat, to access on-line position “papers” of User-customized political candidates and electoral ballot initiatives, and validate to an authorized third-party that the User is eligible to vote in particular elections, such as voting for a particular candidate running from a particular User-customized district.

There are several embodiments of User-customized Execution Commands 52 governing the processing of electronic data and electronic transmissions. Such Execution Commands 52 can govern: User-customized notification preferences for such electronic transmissions as real-time medical updates, pending Internet auctions, electronic stock trades and the like; User-customized instructions for User-location designating, for example, that the User may be located by third parties via whichever UIA 16 the User is using during an indicated time period, whereby the User can automatically receive their e-mails, instant messages, phone calls, faxes, and the like in real-time at the particular UIA 16 in use by him; User-customized travel customizations such as the User's preferences for lodging accommodations, travel costs, food, travel locations, and the like.

In other exemplary embodiments, upon verifying the User's UUC 200-PVC 202 packet via the Verification Platform 12, the RMN 14 enables the User to access stored electronic non-financial data comprising accessing any of the following: word-processing files; spreadsheet files; software code; graphics files; audio files; medical records; internet web sites; on-line audio or graphical content; electronic game content; on-line chat content; on-line messaging content; on-line educational content; on-line academic examination-taking; on-line personalized medical and health content, and; server-based computer software programs and hardware drivers.

Further embodiments of User-customized Execution Commands 52 governing the processing of electronic non-financial data and electronic transmissions include: User-customized verification presentation preferences depending upon various predetermined criteria such as the verification of a particular counter-parties, the User's sending location, and the like, whereby a User's pre-selected personal identifier, such as a distinct audio or visible sample, is electronically presented to a third-party counter-party of the User's electronic transmission; invocation of User-customized Internet environment preferences, whereby a User's preferences are used to create a customized Internet web portal with the User's preferred search engines, bookmarks, and the like; User-customized data presentation preferences, whereby the priority, formatting and organization of displaying data is predetermined by the User; User-customized Internet search engines, and; User-customized intelligent data tracking and extrapolating agents.

In one embodiment of an Execution Command 52 governing the processing of an electronic transmission, the User-customized Internet search engine is customized to locate, retrieve and present electronic transmissions of the User using an intelligent tracking and extrapolating agent. In one embodiment, the User's customized Rule-Modules 50 provide instructions that even when the User is not logged onto a network, the Pattern Data 54 and Execution Commands 52 are periodically and automatically executed, added, changed or deleted based on the User's previous UTA 16 and on-line usage patterns. As a result, the User-customized search engine is automatically and progressively refined and customized to the User's evolving preferences and on-line activity patterns as tracked and interpreted by the User's own electronic, automated intelligent agent.

As an example of the above, the User's intelligent agent can direct the User's search engine to automatically conduct periodic, customized on-line data retrievals reflecting User-customized priorities for: product or service promotional offers or discounts via email or instant messaging; User-customized investment updates; User-customized medical or health information; competitive product or service prices across a broad range of on-line Account Issuers; hobby or recreational interests; interactive User-customized on-line advertisements, wherein product or service providers are permitted to provide unsolicited information to a User based upon certain User-customized criteria; on-line event calendaring, wherein a User is automatically notified of upcoming events or activities reflecting their interests.

Further, the intelligent agent can extrapolate from the User's existing preferences and on-line activity patterns to automatically and periodically recommend to the User new data that may expand or delete the User's Pattern Data 54 and Execution Commands 52 based upon the intelligent agent's algorithmic projection of what the User's on-line preferences and activities will be in the future.

In another embodiment, an Execution Command 52 functioning as an intelligent tracking and extrapolating agent centrally integrates data on the User's Internet browsing to provide User-customized recommendations on new products and services available from any number of Internet web sites or Internet Account Issuers. Examples include the Execution Commands for retrieval of new types of music, books, and investment opportunities that reflect the User's preferences, but that such recommendations are pre-selected based on the Execution Command 52 having automatically conducted competitive price-comparisons from various Third-Party Platforms 28. In another embodiment, an Execution Command 52 integrates User-customized data from a User's calendaring or scheduling software program to provide the User with customized recommendations on User-customized offering for products, services or upcoming events based on the User's pre-scheduled activities in their on-line calendar.

In another embodiment, an Execution Command 52 appends a customized, User-customized audio or visible identifier which accompanies an electronic transmission for presentation to the counter-party. This identifier is appended to the User's electronic transmission as a form of “electronic personal signature” to readily notify the counter-party that the authenticated User sent the message. This identifier may be a unique image or sound sampled from the User, or it may be a non-unique, distinct graphical or audio selected by the User to reflect their personal preferences, such as a cartoon image or a favorite sound or audio tone.

In another embodiment where greater security is required, an Execution Command 52 governs the appending of a User-unique network credential or digital certificate to an electronic transmission. If a User employing a UUC 200-PVC 202 seeks to append their digital certificate to an electronic transmission, the User stores at least one command to sign electronic documents using their private keys, which are themselves centrally stored on a Rule-Module Nexus 14 server. As such, the User's private keys are invoked as a header of the User's electronic transmission which, in combination with the electronic document itself and an MD5 calculation of the document, together form a digital signature. At a later time, an authorized counter-party can use the User's public key from the Master RMN 14 or a third-party certifier to verify the authenticity of the sender and the electronic document's contents to yield a secure, authenticated electronic transmission. In this way, Users do not have to manage their own private keys, nor do they have to retain physical possession of their digital certificates via smart cards or personal computers with resident User-customized data. In one embodiment, public keys of a particular certifying authority are initially stored in the UTA 16 at the time of construction.

In another embodiment, an Execution Command 52 governs the processing of an on-line, User-customized calendaring program or Internet calendaring web site, wherein the User's on-line scheduling calendar is automatically updated by the User-customized search engine and the User-customized intelligent search and tracking agent based upon User-customized Pattern Data 54. This could include, but would not be limited to, automatically updating the User's on-line calendar based on upcoming: User-customized entertainment events, User-customized business seminars, User-customized airline discounts to the User's preferred destinations, User-customized candidate and elections bulletins, and the like.

In another embodiment, the User pre-designates Execution Commands 52 governing the processing of electronic transmissions which filter the access and presentation of data when the User is subordinated User who is co-registrant or legal dependant of the primary User himself. Examples of such subordinated Users could be the children or the spouse of a User. Examples of such access and presentation, or viewing, filters may be restrictions predetermined by the primary User governing: subordinated User access to Internet web sites with adult or violent content; subordinated User access to on-line television or radio programming with adult or violent content; subordinated User access to the Internet 18 with restrictions covering on-line session length; subordinated User access to educational on-line resources which are automatically “pushed” to the subordinated User during a particular on-line session, as pre-determined by the primary User, in order to pro-actively circumscribe the content which a particular subordinated User is permitted to view or download.

In another embodiment, an Execution Command 52 provided to the Nexus 14 by an authorized third-party, such as a User's employer, governs the processing and prioritization of electronic transmissions to the User on an intranet Network 18. As such, the Execution Command 52 determines which electronic transmissions are automatically “pushed” to the User during a particular on-line session, as pre-determined by the authorized third-party, in order to pro-actively circumscribe the content which a particular User is permitted to view or download

Embodiments of User-customized Execution Commands 52 governing the display or presentation of electronic transmissions include controlling the organization and prioritization of on-line content such that text, audio and graphics are displayed according to a User's pre-determined preferences. This includes displaying informational updates in a certain prioritization order, wherein User-customized regional news may be presented prior to national or international news, displaying expenditure records in User-customized categories which reflect anticipated tax deduction categories, such as home improvement expenses, charitable contributions, and the like, displaying customized User-customized Internet web sites or portals, including the User's predetermined bookmarks, preferred web links, calendaring programs, email mail addressing rosters, a plurality of email accounts with their accompanying inbox messages, User-customized instant messaging “buddy” lists.

Other embodiments of User-customized Execution Commands 52 governing the display or presentation of electronic transmissions include: displaying accrued User-customized consumer rewards incentives or customized on-line advertising according to a User's prescribed priorities, such that skiing apparel is presented to the User at a time based on their calendaring program's designating their scheduled winter vacation or such that an advertisement for new coffee flavors from the User's preferred vendor is presented during the User's morning log-on session; displaying the User's customized fitness program on an Internet-connected exercise machine, whereby the User is reminded of the number of repetitions the User performed at what difficulty level during their last exercise session, and thereby also presents a recommended number of repetitions and a recommended difficulty level for the User's current session.

Other embodiments include Execution Commands 52 governing: presentation or display filters which circumscribe what text, graphic or audio content the User is permitted to view; presentation or display filters which govern which products or services a User is permitted to purchase, such as a subordinated User whose parent is a primary User, and where the subordinated User is prohibited from purchasing cigarettes, is limited in their selection of on-line Account Issuers, is limited in the amount of on-line session time the User is permitted to have in a single day, and the like.

Preferably, each verification request and each transmission request, whether successful or not, is logged in the Logging Platform (LF) 42.

In a preferred embodiment, more than one Rule-Module Nexus 14 provides fault tolerance from either natural or man-made disasters. In this embodiment, each Verification Platform 12 uses a backup power generator, redundant hardware, mirrored platforms, and other standard fault tolerant equipment known in the industry

### Execution Platform

In a preferred embodiment, an Execution Command 52 of a Rule-Module 50 causes an electronic financial transaction to be executed by the Execution Platform 38. The Execution Platform 38 may be on a platform which is located within the Master RMN 14 itself, or it may be co-located with an entity platform 28 that is external to the Master RMN 14. In the event that a designated entity platform 28 cannot be contacted for the electronic financial transaction to be completed, the financial transaction is “declined”.

In one embodiment, if the Account Issuer approves the transaction, the Execution Platform 38 returns a transaction number to the User Account Registry 15, and the User's Financial Account 65 is thereby adjusted through either a credit or debit. The transaction number is returned to the UIA 16, which lists the transaction on a daily transaction summary. The User need take no further action since financial transactions are automatically settled, at which point a calculation is made to automatically adjust the User's designated Financial Account 65.

In another embodiment, the Execution Platform 38 uses Rule-Modules 50 from the Master Rule-Module Nexus 14 which permit an Account Issuer to itself contribute financial directly to an alternative Account Issuer based upon a User's purchases. In such transactions, units of financial are electronically debited from the User Account controlled by the Account Issuer, and corresponding units of financial are electronically credited to the alternative Account Issuer's Financial Account 65. An example would be that a purchase on a User's Citibank™ Visa™ Financial Account 65 will invoke a Rule-Module 50 wherein: Citibank™ contributes 1% of the User's purchase amount from the financial transaction to the American Lung Association™ registered Financial Account™, or; Citibank™ credits 1% to the User's purchase amount from the financial transaction towards frequent flier miles in the User's Star Alliance™ Rewards Financial Account 65.

### Decryption Platform

In a preferred embodiment, all messages the Rule-Module Nexus 14 receives, with the exception of those not transmitted via a UIA 16, comprise a UIA-VC 204, a sequence number, and a Message Authentication Code (MAC). MACs, also known as cryptographic checksums, are well known in the computer industry, and are used to assure that any changes to the content of the message will be detectable by the entity receiving the financial transaction. The Decryption Platform (DP) 22 validates the message's MAC and checks the sequence number for that particular UIA 16. If the Decryption Platform 22 determines that both the MAC and the sequence number are valid, the DP 22 uses the unique secret key for that particular UIA 16 to decrypt the message. For the decryption to function properly, the Decryption Platform 22 must comprise a copy of each UIA's 16 DUKPT key table.

If the decryption operation fails, or if the MAC check fails, the message is considered an invalid message. The Decryption Platform 22 logs a warning to the logging facility (LF) 42, terminates processing for the message, and returns an error message to the originating UIA 16.

Before the Decryption Platform 22 replies to a message that includes a response key, it encrypts the response message with that response key. The Decryption Platform 22 also generates a MAC for the response and appends it to the message.

Preferably, error messages are not encrypted although the Decryption Platform 22 does include a MAC for message authentication. Such messages never include confidential information. However, most response messages include a status or response codes that can indicate whether the request succeeded or not. For example, when the Execution Platform 38 declines a financial transaction for a specific reason, it does not return an error message, it returns a normal Financial Transaction Response Message 252 with a response code set to “failed”.

### Gateway Platform (GP)

In a preferred embodiment, the Gateway Platform 26 serves as an intermediary between redundant Verification Platform 12 and redundant in-house Registry 15 platforms, routing electronic financial transactions and/or electronic transmissions from platforms on overload to platforms that have available capacity. The Gateway Platform 26 also periodically queries platforms to ensure that are operative and to alert the RMN 14 or RMN-authorized Third-Party Platform 28 administrator is any server is inoperative.

### Prior Fraud Platform (PFP)

In a preferred embodiment, the PFP 27 is a central repository for UUCs 200, PVCs 202, and other Pattern Data 54 which have had prior fraud associated with them. Every new User's UUCs 200 and PVCs 202 are checked against all PFP 27 records with the intent of reducing recidivism. In one embodiment, there is an automatic User prior fraud check step, wherein the User's bid UUCs 200 and PVCs 202 are compared against previously registered UUCs 200 and PVCs 202 in the PFP 27 wherein if a match occurs, the Rule-Module Nexus 14 and Verification Platform 12 are alerted to the fact that the User has attempted to re-register or re-access the Rule-Module Nexus 14 after having already been registered with the PFP 27.

### Firewall (FW)

In a preferred embodiment, the Firewall (FW) 40 provides a first line of defense against network viruses and computer hackers. All communication links into or out of the Verification Platform 12 and Master Rule-Module Nexus 14 server sites first pass through a secure Firewall 40 Machine.

Preferably, the firewall 40 Machine, an Internet-Local or Subset-Internet router, only handles messages destined for the Gateway Platform 26 machines.

### Intra-RMN Communications

In a preferred embodiment, UTA-equipped Transaction Terminals 2 send packets to Verification Platform 12 and Master Rule-Module Nexus 14 server sites via modem, X.25, or other communication medium. The Verification Platform 12 and Master Rule-Module Nexus 14 server sites rely on an entity to supply the modem banks required to handle the volume of calls and feed the data onto the Master RMN 14 backbone.

Preferably, for communications between Verification Platform 12 and Master Rule-Module Nexus 14 server sites, the FW 40 Machines send out double-length DES encrypted packets. The server site LAN component handles the encryption and decryption: the firewall 40 does not have the ability to decrypt the packets.

Preferably, a properly configured network sniffer acts as an intruder detector as backup for the FW 40. If an anomalous message is detected, the intruding messages are recorded in their entirety, an operator is alerted, and the Firewall 40 is physically shut down by the sniffer.

Preferably, the Firewall 40 disallows any financial transactions from the internal network to the rest of the Internet. An electronic financial transaction message requires about 400 bytes and registration packets require about 10 to 20 KB. To handle 1000 electronic financial transactions per second and 16 registration packet per second, the Firewall 40 machines are able to process about 400 KB per second.

### Logging Platform

In a preferred embodiment, the Logging Facility 42 logs all electronic financial transaction attempts, whether successful or not, to write-once media, so that a record is kept of each financial transaction and each error that has occurred during the operation of the Verification Platform 12.

### Interconnections and Communications Among the Electronic Verification Platform, Rule-Module Nexus and User Account Registry

A variety of conventional communications media and protocols may be used to connect or place the devices herein in communication. For example, the communications media may be an Internet Service Provider (ISP) configured to facilitate communications over a local loop as may be typically used in connection with standard modem communication, cable modem, dish networks, ISDN, Digital Subscriber Lines (DSL), or any wireless communication media. In addition, the Retail Subset Platform (RSP) 130 including the UTA 16 conjoined with the Transaction Terminal 2 and RMN 14 may reside on a local area Network 18 which interfaces to a remote network (not shown) for remote authorization of an intended transaction. The Retail Subset Platform 130 may communicate with the remote network via a leased line, such as a T1, D3 line, or the like. Such communications lines are described in a variety of texts, such as, “Understanding Data Communications,” by Gilbert Held, which may be incorporated herein by reference.

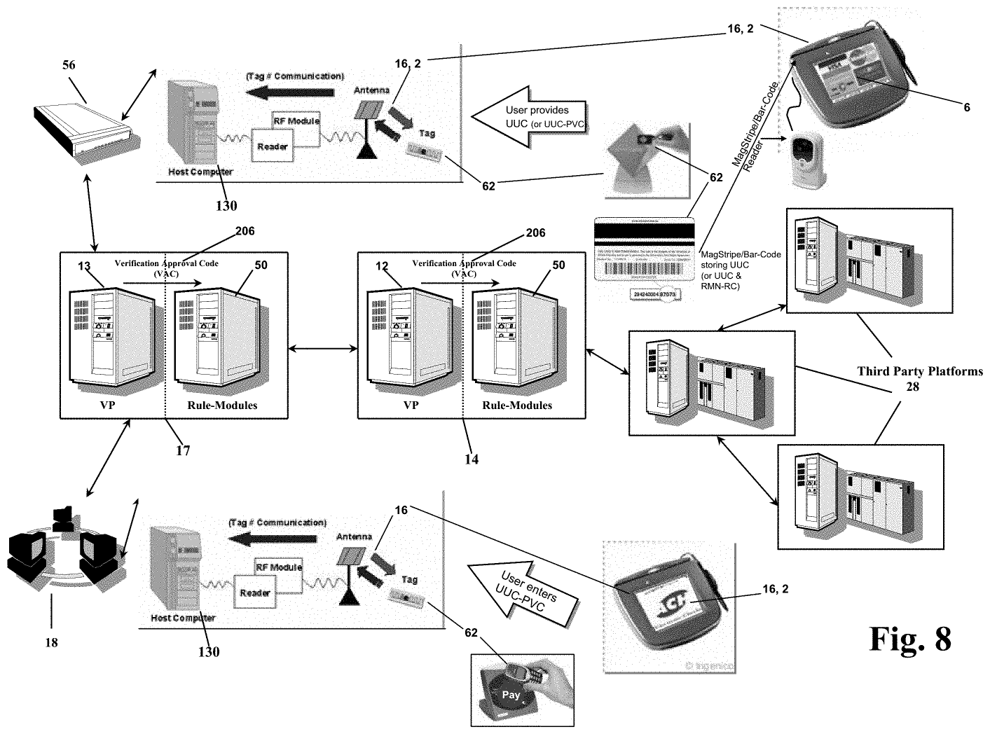

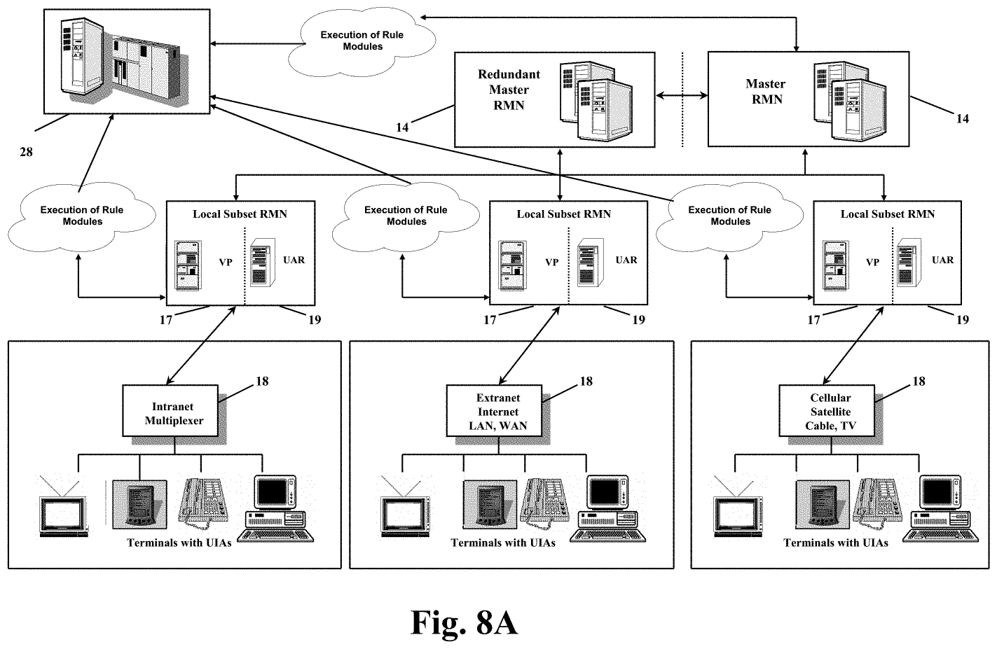

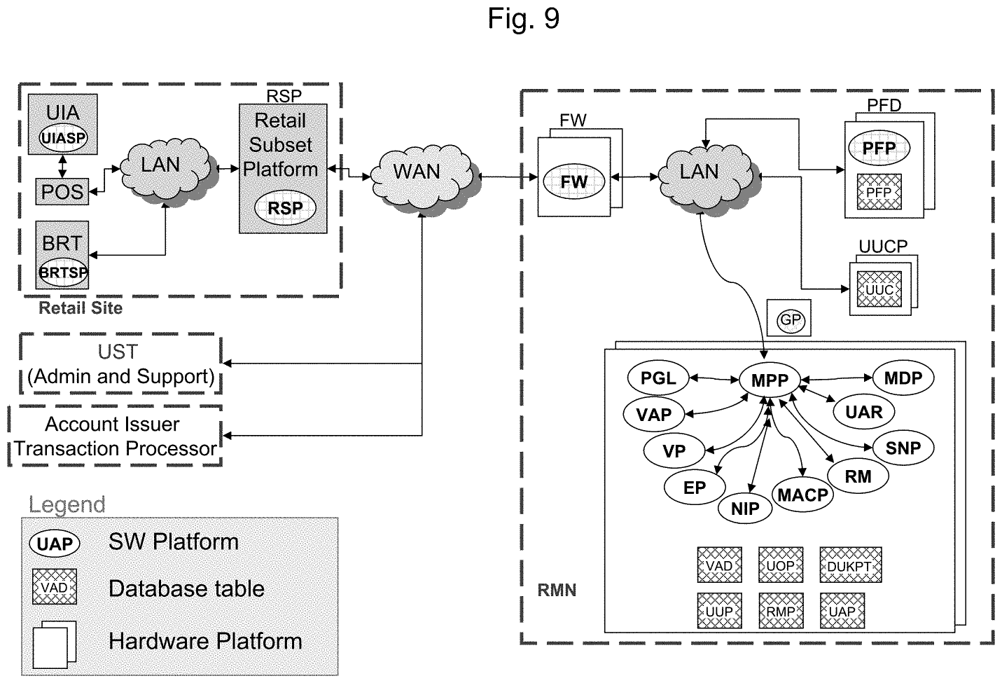

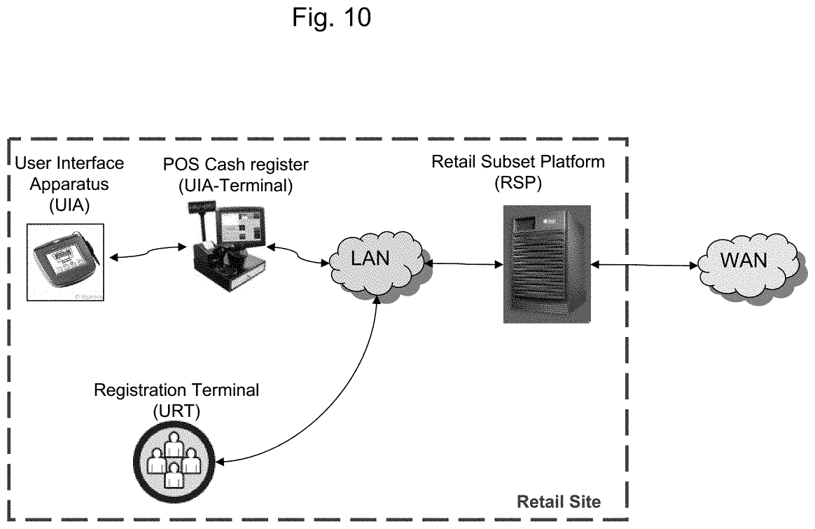

In one embodiment depicted in FIG. 8, the Verification Platform 12 platform is physically separate from, but associated and registered with, the Master Rule-Module Nexus 14. In one embodiment depicted in FIG. 8A, the User Account Registry 15 platforms are conjoined with the Verification Platform 12 within the RMN 14, although they may be housed in independent platforms or joint platforms. In an embodiment shown in FIG. 18, the Rule-Module Nexus 14 is separately located from a User Account Registry 15, which is conjoined with a Third-Party Platform 28, but associated and registered with the RMN 14. In another embodiment depicted in FIGS. 1 and 3, the Verification Platform 12 is physically integrated with the Rule-Module Nexus 14 and the User Account Registry 15, whereby the Verification Platform 12, Master Rule-Module Nexus 14 and the User Account Registry 15 are physically interconnected and integrated together within one server or platform. In these embodiments, communications among the Verification Platform 12, the Master Rule-Module Nexus 14 and the User Account Registry 15 preferably occur via many different methods and means that are well known in the art. Most depend on the particular communication networks already deployed by the organization or company that deploys the electronic financial transaction authorization system.

In one embodiment, the Verification Platform 12, the Master Rule-Module Nexus 14 and the User Account Registry 15 are connected via Ethernet 18 to a Local or Subset router, which is connected to a network operations center (NOC) via frame relay lines. Messages are sent among the Verification Platform 12, the Master Rule-Module Nexus 14 and the User Account Registry 15 using TCP/IP over this Network 18. In another embodiment, the Verification Platform 12, the Master Rule-Module Nexus 14 and the User Account Registry 15 are connected via a cellular digital packet data (CDPD) modem Network 18 to a CDPD provider, who provides TCP/IP connectivity from the Verification Platform to an intranet 18 to which at least one Master Rule-Module Nexus 14 is attached.

In yet another embodiment, a Verification Platform 12 is connected via the Internet 18, as is at least one Master Rule-Module Nexus 14 and at least one User Account Registry 15. TCP/IP is used to transmit messages from among the Verification Platform 12, the Master Rule-Module Nexus 14 and the User Account Registry 15. There are many different ways to connect the Verification Platform 12, the Master Rule-Module Nexus 14 and the User Account Registry 15 that are well understood in the industry, such as cable networks, wireless networks, telephone networks, the Internet, an intranet, a local area network (LAN), a wide area network (WAN), and an X.25 network.

The Verification Platform 12, the Master Rule-Module Nexus 14 and the User Account Registry 15 hardware platforms are preferably high-reliability platforms, well known in the art, such as those available from Sun™, Compaq™, Tandem™, IBM™ and the like. Further, the Verification Platform 12, the Master Rule-Module Nexus 14 and the User Account Registry 15 software may preferably incorporate scalable platform architecture, well known in the art, such as those available from Oracle™, Sybase™, Informix™, Red Hat™ and the like.

### Electronic Verification Platform, Rule-Module Nexus and User Account Registry: Master Platforms and Local or Subset Platforms

In certain embodiments, a Master Verification Platform 12 is responsible for storage of the entire set of UUC 200, PVCs 202, digital certificates and the like registered for use with this invention. Preferably, an electronic Master Rule-Module Nexus 14 is responsible for storage of the entire set of Pattern Data 54, Execution Commands 52, and Rule-Modules 50 registered for use with this invention. An electronic Master User Account Registry 15 is responsible for storage of the entire set of Financial Accounts 65 of a User and Financial Accounts 65 of an Account Issuer registered for use with this invention.

Each Master Verification Platform 12, Master Rule-Module Nexus 14 site is preferably made up of a number of computers and platforms connected together over a LAN (known in the industry). Multiple and redundant Master computer sites ensure reliable service in the face of disaster or serious hardware failure at any single central computer site.

In another embodiment, there is at least one Local or Subset Verification Platform 13 server which stores a subset of the entire set of UUC 200, PVCs 202, and digital certificates registered for use with this invention. In another embodiment, there is at least one Local or Subset Rule-Module Nexus 17 server which stores a subset of the entire set of Pattern Data 54, Execution Commands 52, and Rule-Modules 50 registered for use with this invention. Such Pattern Data 54 and Execution Commands 52 subsets may be circumscribed by any number of criteria including, usage location, usage frequency, usage recency, usage demographics and usage volume of electronic financial transactions. In another embodiment, there is at least one Local or Subset User Account Registry 19 server which stores a subset of the entire set of User Accounts and Account Issuer Accounts registered for use with this invention.

It is preferred that the Master platforms have a Firewall 40 machine which is the entry point of data and messages into these computers, and a Gateway Platform 26 which is a RMN coordinator and message processor.

### Use-Sensitive Configurations for Verification Platform, Rule-Module Nexus and User Account Registry

As shown in FIG. 3 and FIG. 8A, in some embodiments the invention has use-sensitive data processing capabilities, wherein at least two Verification Platforms 12, at least two Rule-Module Nexuses 14, or at least two electronic Rule-Module Nexuses 14 exist, some of which respectively store a subset of the total data registered with the RMN 14 or RMN-authorized Third-Party Platform 28.

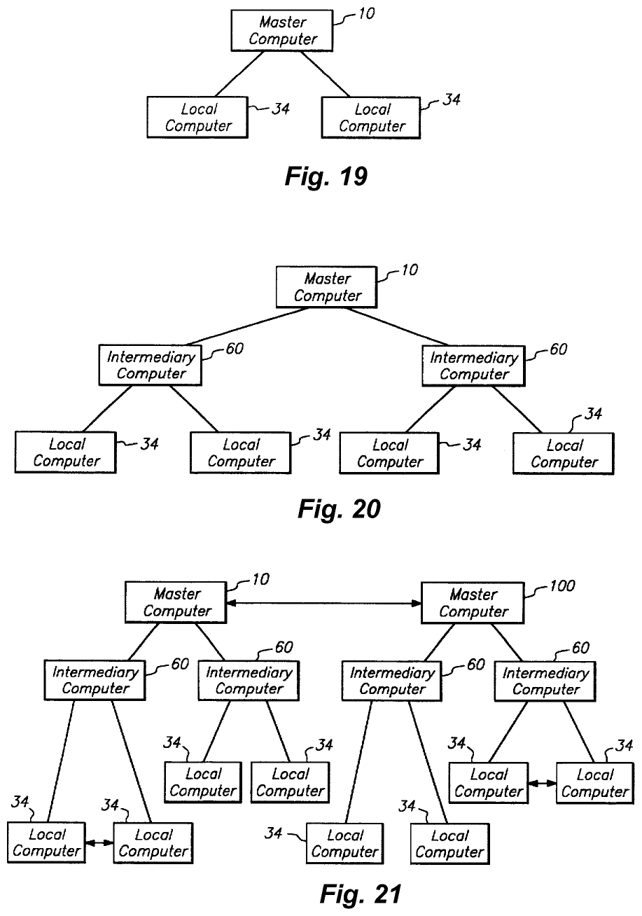

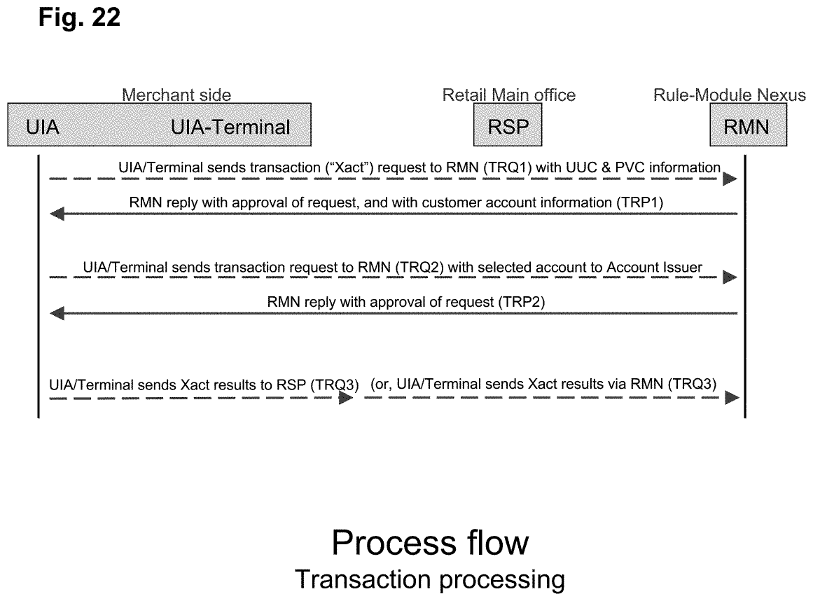

FIG. 19 through FIG. 21 show use-sensitive embodiments, with Master, Intermediary, and Local (or Subset) configurations.

One embodiment comprises at least one Master Verification Platform 12, one Master Rule-Module Nexus 14, which respectively comprise the entire set of all data registered with the RMN 14 or RMN-authorized Third-Party Platform 28. This embodiment further comprises at least two Local or Subset Verification Platforms 13, at least two Local or Subset Rule-Module Nexuses 17, that are physically apart from each other. Each Local or Subset Verification Platform 13, Local or Subset Rule-Module Nexus 17 and Local or Subset User Account Registry 19 may comprise a subset of the data contained respectively within the Master Verification Platform 12, Master Rule-Module Nexus 14. Data communications lines may allow electronic financial transactions to flow between each Local or Subset Verification Platform 13, Local or Subset Rule-Module Nexus 17 or Local or Subset User Account Registry 19, and the Master Verification Platform 12, Master Rule-Module Nexus 14 or Master User Account Registry 15.

In this embodiment, electronic financial transactions may first be sent to the Local or Subset Verification Platform 13, Local or Subset Rule-Module Nexus 17 or Local or Subset User Account Registry 19 for processing. If a party cannot be identified by the Local or Subset Verification Platform 13 or if the requisite Rule-Module 50 or Financial Account 65 is not contained, respectively, in the Local or Subset Rule-Module Nexus 17 or the Local or Subset User Account Registry 19, the electronic financial transaction is forwarded to the Master Verification Platform 12, the Master Rule-Module Nexus 14 or the Master User Account Registry 15. If the parties are identified properly by the Master Verification Platform 12 or if the requisite Rule-Module 50 or Financial Account 65 is located, respectively, in the Master Rule-Module Nexus 14 or the Master User Account Registry 15, the electronic financial transaction is processed appropriately. In addition, the User's verification information can be transmitted from the Master Verification Platform 12 to the Local or Subset Verification Platform 13, so that the next time the User will be successfully identified by the Local or Subset Verification Platform 13. This can likewise occur for the Master Rule-Module Nexus 14 and Local or Subset Rule-Module Nexuses 17, and Local or Subset Registries 17.

In another embodiment of a use-sensitive RMN 14 or RMN-authorized Third-Party Platform 28, the RMN 14 or RMN-authorized Third-Party Platform 28 further comprise a purge engine for deleting a party's User-customized information from the Local or Subset Verification Platform 13, the Local or Subset Rule-Module Nexus 17 or the Local or Subset User Account Registry 19 platforms. In order to store only records for those parties who use the RMN 14 or RMN-authorized Third-Party Platform 28 more than a prescribed frequency and prevent the overload of platforms with records from parties who use the RMN 14 or RMN-authorized Third-Party Platform 28 only occasionally, the record of a party is deleted from the Local or Subset Verification Platform 13, Local or Subset Rule-Module Nexus 17 or Local or Subset User Account Registry 19 platforms if there has been no attempt to verify the party upon expiration of a predetermined time limit.

In order to make communications between the Master RMN platforms 14 and the Local or Subset RMN platforms 17 secure, the RMN 14 or RMN-authorized Third-Party Platform 28 further comprises encryption and decryption means, wherein communications between the Master RMN platforms 14 and Local or Subset RMN platforms 17 are encrypted.

Preferably, within the Rule-Module Nexus of the use-sensitive embodiment, each Master Platform (or Master Computer) 10, each Intermediary Platform (or Intermediary Computer) 60, and each Local or Subset Platform (or Local or Subset Computer) 34, has electrical power backup and multiple redundancy in all of its critical hardware and platform systems.

### External Computers or External Entity Platforms

In one embodiment, an Execution Command 52 optionally requires the RMN 14, including the Master Rule-Module Nexus 14 and the Execution Platform 38, to communicate with at least one external or Third-Party computer or platform 28 to conduct a User's financial transaction. For example, the Execution Platform 38 may need to communicate with: a banking or credit card entity; a merchant's purchasing incentives platform for generating financial; a financial counter-party's computers to determine the correct financial counter-party account for financial disbursal. In this embodiment, at least one Local or Subset Rule-Module Nexus 17 or at least one Local or Subset User Account Registry 19 is located within an external, Third-Party platform 28.

### On-Line Network and Communications for Financial Transactions

Network transactions are characterized by verifying the User using a communications network such as the Internet, an intranet, or an extranet. The User's bid UUC 200 is submitted through the User's personal UIA 16, or through a public UIA 16 attached to an ATM or other public Terminal 2. Parties identified through a digital certificate are registered network entities, such as either the Account Issuer or the Account Issuer. The User is identified through UUCs 200-PVCs 202, while the Account Issuer or the Account Issuer, may be identified through the verification of a digital certificate issued by an authorized certifying authority.

In a preferred embodiment, the User locates the Account Issuer by locating the participating Account Issuer's place of business on the network: the web site, using the network address of the Account Issuer. The User downloads the Account Issuer's digital certificate to the UIA 16 that the User is using. The UIA 16 verifies that the digital certificate provided by the Account Issuer is a valid certificate.

In one embodiment, the UIA 16 transmits the UUC 200-PVC 202 to the Master RMN 14 for verification, along with the Account Issuer's digital certificate.

Both parties verify the Financial Accounts 65 to be involved in the transaction. In a preferred embodiment, this occurs at the Master RMN 14 using the selected Financial Account 65 included in the transaction by the User. The User's Financial Account 65 is thereby selected by the RMN 14.

In one embodiment, the UTA 16 is actually built-in and/or integrated with a personal Transaction Terminal 2 such as a home computer, or a public Transaction Terminal 2, for example an airport kiosk. In such an embodiment, the UTA-VCs 204 are not required to verify either party in a transaction.

In another embodiment, the User can be a representative of a business entity that has permission to access the business entity's financial accounts to conduct direct transactions with a financial counter-party.

From the foregoing, it will be appreciated how the objectives and features of the invention are met. First, the invention provides an improved on-line financial transaction computer system and method that eliminates the need for a User to possess and manage multiple tokens, in order to authorize a transaction.

Second, the invention provides an on-line financial transaction computer system that is capable of on-line verification of a User's unique authority to access the Rule-Module Nexus by algorithmically combining their unique User code and personal verification code.

Third, the invention does not require any portable token to store any data which may directly identify or may directly access an on-line financial account of the User.

Fourth, the invention provides a cost-effective on-line financial transaction system that is practical, convenient, and cost-effective to use and integrate with existing financial transaction systems.

Fifth, the invention provides a system of secured access to an on-line financial computer system that is highly resistant to fraudulent transaction authorization attempts by unauthorized Users.

Sixth, the invention provides an on-line financial transaction authorization system that enables a User to notify authorities that a particular access request is being coerced by a third party without giving notice to the third party of the notification.

Seventh, the invention provides an on-line financial transaction system which verifies itself to the User for added security.

Although the invention has been described with respect to a particular system and method for its use, it will be appreciated that various modifications of the apparatus and method are possible without departing from the invention, which is defined by the claims set forth below.

I claim:

1. A functional finger ring comprising:
a ring body; and
A near field communication enabled chip having circuitry comprising a data repository storing a user-specific digital code, circuitry adapted for proximal short-range contactless communication.

2. The functional finger ring of claim 1, wherein the near field communication enabled chip is conjoined to the functional finger ring and wherein the functional finger ring is adapted to communicate with an interrogation apparatus external to the functional finger ring body.

3. The functional finger ring of claim 1 comprising a battery providing power to the circuitry of the near field communication enabled chip.

4. The functional finger ring of claim 1 further comprising circuitry adapted to draw power from electromagnetic signals from the external interrogation apparatus, the power drawn used to power circuitry of the near field communication enabled chip.

5. The functional finger ring of claim 1, wherein the near field communication enabled chip is conjoined to an outer surface of the ring body.

6. The functional finger ring of claim 3 wherein the circuitry adapted to draw power from the signals from the external interrogation apparatus comprises an antenna interactive with the signals, forming a magnetic field.

7. The functional finger ring of claim 1, wherein the proximal short-range contactless communication comprises any of the following: radio frequency; infrared signal; digital signal; cellular signal; vibrational signal; and/or, audio signal.

8. A method, comprising:
establishing communication with an interrogation apparatus by a near field communication enabled chip having circuitry comprising a data repository storing a user-specific digital code, circuitry adapted for short-range contactless communication with the interrogation apparatus; and
providing a user-specific digital code to the interrogation apparatus in response to signals from the interrogation apparatus.

9. The method of claim 8 wherein power to circuitry of the near field communication enabled chip is provided by a battery connected to the chip.

10. The method of claim 8 wherein power is drawn to power the circuitry of the near field communication enabled chip from signals from the interrogation apparatus.

11. The method of claim 8, wherein a near field communication enabled chip is enclosed within the ring body.

12. The method of claim 8, wherein near field communication enabled chip is conjoined to an outer surface of the ring body.

13. The method of claim 1 wherein the power drawn from the signals of the interrogation apparatus is through an antenna forming a magnetic field while interacting with the signals of the interrogation apparatus.

14. The method of claim 8, wherein the contactless communication comprises any of the following: financial transaction data, and/or; non-financial transmissions data.

15. The method of claim 14, wherein the financial transaction data comprises a unique code of a user consisting of a computerized data string which uniquely identifies the user and which does not directly identify or directly access any specific on-line financial account of the user.

16. The method of claim 15, wherein the financial transaction data invokes authorization of any of the following: a debit from a financial account of the user, and/or; a credit to a financial account of the user.

17. The functional finger ring of claim 1, wherein the contactless communication comprises any of the following: financial transaction data, and/or; non-financial transmissions data.

18. The functional finger ring of claim 17, wherein the non-financial transmission data comprises a unique code of the user consisting of a computerized data string which uniquely identifies the user and enables venue admittance of the user.

19. The functional finger ring of claim 17, wherein the financial transaction data further comprises any of the following: redeeming a pre-paid ticket transaction for venue admittance of the user, and/or; redeeming a pre-paid membership benefit transaction for venue admittance of the user.

20. The functional finger ring of claim 17, wherein the financial transaction data invokes authorization of any of the following: a debit from a financial account of the user, and/or; a credit to a financial account of the user.

21. The functional finger ring of claim 20, wherein the financial account of the user comprises any of the following: a checking account; a credit account comprising Visa®, MasterCard® or American Express®; a pre-paid account; a private label credit account; a brokerage account; a reward incentives account; an insurance account; a savings account; a scrip incentives account; a pre-paid ticket; a membership benefits account; a services barter account; a product barter account, and/or; internet payment account.

22. The functional finger ring of claim 20, wherein the financial transaction invokes authorization for any of the following types transactions: a debit from a financial account of the user, and/or; a credit to a financial account of the user; wherein the transaction terminal device that process these transactions may be any of the following: a wireless telephone; a wireless pager; a personal computer; a merchant point of sale register; a vending machine; a venue admittance device; a personal digital assistant; an internet kiosk; a land line telephone; a television, a POS; a digital music player; a data-entering touch screen; a data-entering key pad; a visible display screen; a contactless proximity communications data-reader; a contactless proximity communications data-reader and data-writer; a data-entering touch screen; a data entering key pad; a visible display screen; an audible signal speaker; and/or, an audio receiver a biometric scanning sensor; wherein the financial account of the user comprises any of the following: a checking account; a credit account comprising Visa®, MasterCard® or American Express®; a pre-paid account; a private label credit account; a brokerage account; a reward incentives account; an insurance account; a savings account; a scrip incentives account; a pre-paid ticket; a membership benefits account; a services barter account; a product barter account, and/or; internet payment account.
